(19) United States
(12) Patent Application Publication
(10) Pub. No.: US 2026/0329898 A1
(43) Pub. Date: Oct. 22, 2026

(54) CONTEXTUAL SEMANTIC DERIVATION OF DATA RELATIONSHIPS

(71) Applicant: Itemize Corporation, Wilmington, DE (US)

(72) Inventors: James Thomas, Wilmington, DE (US); Stephen Markle, Laguna Niguel, CA (US); Christopher Ryan Courtade, Dayton, KY (US)

(73) Assignee: Itemize Corporation, Wilmington, DE (US)

(21) Appl. No.: 19/726,288

(22) Filed: Jun. 30, 2026

Related U.S. Application Data
(63) Continuation-in-part of application No. 19/435,153, filed on Dec. 29, 2025.
Application No. 19/435,153 is a continuation-in-part of application No. 19/010,696, filed on Jan. 6, 2025.
(60) Provisional application No. 63/559,369, filed on Feb. 29, 2024.

(51) Int. Cl. G06F 16/28

(52) U.S. Cl. CPC G06F 16/288

(57) ABSTRACT

Novel methods and systems derive meaning from context to automate processes that currently require significant human judgment and intervention. An autonomous, Event-driven system runs continually over time, responding to new information (including the mere passage of time) by employing contextual semantic derivation (CSD), often in parallel, to discern relationships within and across documents that are otherwise difficult to derive (DDRs). Such relationships are maintained in one or more iteratively traversed and updated knowledge graphs, providing Relationship Persistence leveraged to perform Document-Processing Tasks (Capture, Classification, Matching, Reconciliation) and Higher-Level Tasks (Interrogation, Anomaly detection and resolution, Decisioning, Compliance, Analytics). The automated performance of Workflow Tasks constitutes an Agentic Workflow. In some embodiments, Context-Derived Conditioning conditions a Workflow Task on conditions reflected in the knowledge graphs rather than static rules, and accumulated risk drives transitions among relationship states to gate operations and incorporate post-decision feedback.

### CROSS-REFERENCE TO RELATED APPLICATIONS

This application is a continuation-in-part that claims priority to U.S. utility patent application Ser. No. 19/435,153, filed Dec. 29, 2025 and entitled “Contextual Semantic Derivation of Data Relationships,” which is a continuation-in-part that claims priority to U.S. utility patent application Ser. No. 19/010,696, filed Jan. 6, 2025 and entitled “Contextual Semantic Derivation of Data Relationships,” which is a parent utility application that claims priority to U.S. provisional patent application Ser. No. 63/559,369, filed Feb. 29, 2024 and entitled “Contextual Semantic Derivation of Data Relationships,” the disclosures of which are hereby incorporated by reference as if fully set forth herein.

### BACKGROUND

### Field of Art

The present invention relates generally to the automation of personal, business and other processes, and more particularly to the automation of processes, such as those inherent in financial transactions, in which relationships among data within and across documents are difficult to discern (without human intervention) from the explicit information contained within those documents.

### Description of Related Art

Despite the dramatic impact of computerization on our personal and business lives over the past century, the myth of the “paperless office” remains just that-α myth describing a goal that may well never become reality. For a variety of reasons, paper is likely to be here to stay for the foreseeable future.

Moreover, even if “electronic documents” ever completely replace paper, even these documents often reveal an incomplete picture of the underlying “narrative” or “story” of the transactions and related processes spawning such documents. For example, such documents are far from error-free (e.g., due to data entry errors), and relationships among data within and across such documents are often not self-evident (e.g., where a missing or incorrect vendor name must be inferred from other relevant “matching” information across multiple documents).

As will become apparent, these “difficult-to-derive relationships” (or “DDR”s) are the source of many problems in which “hidden” context results in a failure to derive meaning. These problems currently are “resolved” by an overreliance on human judgment and intervention.

It is therefore not surprising that, despite the ever-increasing level of computerization and automation of certain aspects of a process, human judgment remains not only a necessary but a pervasive component of the implementation of virtually any non-trivial process. Eliminating human judgment entirely may well be a fool's errand. But, as will become evident, there currently exist many opportunities to automate processes that are currently relegated to human judgment and intervention due to the difficulty of deriving meaning from context.

While much of the following discussion relates to financial business transactions, the concepts discussed herein apply to other types of personal, business, educational, governmental and other processes, including those outside the financial realm. Virtually any process that currently involves interrelated “documents” (paper, electronic or otherwise)—in which relationships among data within and across such documents are difficult to discern from the explicit information contained within such documents-presents similar problems that are currently addressed via frequent human judgment and intervention.

For example, various non-financial scenarios involve DDRs. Consider a college admissions officer examining applicants' transcripts, test scores, personal essays and other application details, and employing human judgment to determine which applicants merit admission. Or a medical doctor examining patients' current and historical test results, examination and treatment records and other data, and similarly employing human judgment to form diagnoses of patient conditions and prognoses for the future progression of such conditions. In each of these and other financial and non-financial scenarios, human judgment is employed in part due to the difficulty of deriving relationships among data within and across documents (i.e., DDRs) despite access to the explicit information contained within such documents.

Moreover, the concept of “documents” as described herein is more expansive than the characters and words found in typical paper or electronic documents or files. It covers not only the locations of characters and words on a page and the structure of such data (e.g., in a database or spreadsheet file), but virtually any other medium, metadata or other attribute of information from which “Signal” can be distinguished from “noise” to reveal meaning.

For example, consider audio from which one's tone of voice can be discerned in addition to spoken words, permitting inferences of meaning, such as the relative importance of particular information. A phone conversation with an agitated key supplier regarding an overdue invoice might result in the escalation of that payment request (as contrasted with other similar requests). Similarly, a customer service agent might discern far more understanding of a customer's problem from a phone call than from a text chat.

Humans frequently make such inferences. But automated systems currently emphasize “lower dimensions” of information, rather than more abstract relationships among data that enable more accurate distinctions between Signal and noise to derive meaning. Not unlike the book Flatland [“Flatland: A Romance of Many Dimensions;” Edwin A. Abbott (1884)], in which physical dimensions limit one's ability to discern reality, so too can the examination of more abstract dimensions of documents reveal meaning to a far greater extent.

For example, one can think of characters and words on a page as lower dimensions of documents, with higher dimensions including structured data, audio and other media beyond text (images, video, etc.), the concept of time and ultimately any attribute of data from which Signal can be distinguished from noise. These higher dimensions reveal meaning via the relationships among data within and across documents. As will become apparent, automated techniques such as optical character recognition (OCR) focus primarily on these lower dimensions.

It is important to note that Signal can exist at an atomic level within any type of document (e.g., pixels, images, sounds, etc.) as well as at a “text character” level (e.g., the organization of characters into words, as well as the locations of characters and words on a page, in a summary text field or label, or in more detailed line items, etc.). Moreover, Signal can also exist as more abstract higher-level inferences from the explicit information contained within documents.

For example, line-item amounts in fields of a document might not add up to the amount in the total field of a related document. Or line-item descriptions of food on an invoice from a machine parts supplier may seem out of place. In short, Signal also includes inferences that an ambiguity, error or other anomaly warrants further investigation, even though such Signal does not explicitly exist within one or more documents, but is derived therefrom.

To illustrate the nature and extent of this problem of distinguishing Signal from noise for the purpose of deriving meaning from context, we can characterize the “input” to a system (human or machine) as discrete “files” (i.e., collections of information) provided to the system in virtually any order for processing over time. As noted above, an individual file may be provided in any medium or format (handwritten, electronic, text, image, audio, video, structured or unstructured data, etc.), and may contain one or more documents or other “file content” components. Each piece of file content (e.g., an unstructured text-based document) may itself contain one or more component “objects” such as pages and individual fields.

Yet, context is often hidden in the various relationships among fields and other objects, documents and other file content, and higher-level abstractions such as transactions that may encompass particular documents and fields. Any given scenario may involve multiple of these “Tiers” (hierarchical and otherwise) of entities, such as files, transactions, documents, fields, etc.

Moreover, the relationships among these Tiers may be one-to-one, one-to-many or even many-to-many. For example, a single transaction often involves multiple discrete documents, though any individual document (e.g., an invoice) may reflect aspects of multiple different transactions (e.g., multiple orders placed at different times). And an individual field of a document may be characterized at a document-level Tier (e.g., the total amount of an invoice), or at a sub-document-level Tier (e.g., a subtotal amount of a particular category of items), or even at a higher-level transaction Tier (e.g., via a “transaction ID” that correlates the document to a particular transaction, and potentially distinguishes one portion of the document from others correlated to different transactions via different transaction IDs).

As will become apparent, Tiers are but one of many different “attributes” of fields and other objects. For example, a field may have an associated label (e.g., text relating to the meaning of its corresponding field), as well as a value (e.g., a dollar amount, text description or other metric). As will be explored in greater detail below, the use of different terminology within and across documents for field labels, values and other attributes only exacerbates the problem of deriving the actual meaning of a particular field or other object.

Moreover, even apart from discrete fields within a document, other attributes of a document and its component objects also potentially provide Signal that is often missed or ignored by humans, as well as by existing automated systems. For example, the color of the text of one or more fields, or a coffee stain obscuring certain information within a document, may provide Signal that can be utilized to derive the meaning of particular fields or other objects within the document (or even across other documents).

In short, the problem of identifying Signal and distinguishing it from noise for the purpose of deriving meaning from context is exacerbated by the many relationships (including DDRs) among fields and other objects, documents and other pieces of file content, files and other information provided as input to any system (human or machine). A great deal of relevant Signal that could facilitate the derivation of meaning is often lost (e.g., via OCR) due to the difficulty of discerning context that is effectively hidden within the explicit information provided as input.

Regardless of the particular use case or scenario, the automation of processes involves a number of discrete components that are not currently addressed adequately, even in isolation, much less in an integrated fashion. For example, as noted above, the “Document Processing” component of existing automated systems often fails to derive meaning from context hidden within documents, instead relying on frequent human judgment and intervention.

Moreover, virtually all processes include a “Decisioning” component that is difficult to automate without frequent human judgment and intervention. For example, financial operations involve various aspects of transactions, including authorizations, claims, payments, reconciliations, remittances, etc. Existing automated systems typically overlay rules-based workflows, which produce heavily constrained results that frequently lead to human exception handling. Here too, hidden context within the documents spawned by such transactions currently requires significant human intervention. Such rigid rules-based workflows fail to adequately handle transitions among the various states of a process in an automated fashion with limited human exception handling.

Another key component (in addition to Document Processing and Decisioning) is the need for “Compliance” to facilitate the conformance of decisions to the internal policies and external constraints imposed on virtually any process. Here too, existing automated systems address Compliance, if at all, as another rules-based workflow constraint that inevitably leads to frequent human exception handling.

It should be noted that current overreliance on human judgment and intervention presents its own problems, such as introducing further “human” errors into the process while increasing both time and expense. For example, the ability to train and scale a large number of people to address these types of errors presents logistical, time and cost concerns, as well as security and regulatory compliance concerns. Moreover, reliability, consistency and data integrity are also often compromised by human error. Not every vendor addresses these issues to the same extent. Some may encounter customer resistance due to their lack of particular types of exception handling, or their rigidity in requiring predefined document templates or formats.

As noted above, a major reason for this resistance to automation and overreliance on human judgment and intervention with respect to Document Processing, Decisioning and Compliance (among other key process components) is the difficulty of deriving intended meaning from context (both within and across documents) in an integrated fashion. What humans provide is the ability to “discern” or “extract” context from the explicit information contained within documents to identify and address anomalies.

There is thus a need to integrate this concept of “Contextual Semantic Derivation” (referred to herein as “CSD”) into automated processes to derive meaning from the explicit information contained within documents while reducing substantially the current overreliance on human judgment and intervention (and its associated introduction of additional errors, time and expense). Such an integration would need to identify, as well as address, anomalies that constitute DDRs—i.e., data interrelationships (both within and across documents) that are difficult to discern from the explicit information contained within documents.

While systems employing various aspects of artificial intelligence (“AI”) facilitate the extraction of context from documents, much more is needed to (i) identify Signal (particularly atomic-level and line-item Signal, as well as higher-level inferences, often ignored by existing AI-based and other automated systems), (ii) discern context in the form of DDRs and other relationships among data, within and across documents, and ultimately (iii) reveal meaning from such context.

In particular, there is a need to integrate into an automated process the continual reconstruction and contextualization of transactions to drive key operations over time, such as transaction execution and other aspects of Decisioning, as well as Compliance. Virtually any use case or scenario involves basic “Tasks” that must be performed to implement that scenario. For example, even within the context of financial business transactions, a vast array of vertical use cases share similar “business process automation” problems that are currently addressed all too frequently via human judgment and intervention.

Before discussing the details of Document Processing Tasks that routinely present problems resistant to automation, it is important to note that the need to employ CSD to process documents is a persistent one that requires continual analysis—i.e., “Continual CSD.” It is insufficient to analyze individual documents as if they were independent of one another. Such an automated process must continually employ CSD over time to discern the contextual relationships (including DDRs), within and across documents, that drive key operations.

It is for this reason that there is a related need for “Relationship Persistence” to facilitate the persistent storage and use of context discerned over time. As Signal is identified and context discerned in the form of data interrelationships, such context is not static. As will be discussed in greater detail below, such context may be confirmed, contradicted or otherwise modified as new information is encountered, including the passage of time.

In short, even with respect to Document Processing alone, there is a need for Continual CSD and Relationship Persistence to derive meaning from context over time. Moreover, while Document Processing is integral to automating many Tasks, “Higher-Level Tasks” are also required to drive key operations over time, such as Decisioning and Compliance (among others).

For example, a key decision in any financial operation involves “payment” for past or future goods or services. But the current context discerned from processing a set of documents may prove insufficient to warrant payment of an invoice at a given point in time. Perhaps analysis of additional documents (not yet processed or made available to the system) is warranted. Or even simply the passage of time.

There is thus a need for some form of automated “Structural Gating” to condition key operations (e.g., payment authorization) on criteria not currently available to the system. While existing automated systems include rules-based workflows, it will become apparent that such approaches are inadequate and not feasible in any non-trivial scenario.

It should also be noted that, once decisions are made and a key operation is performed with respect to a particular transaction, additional feedback often requires further follow-up decisions regarding the same or future transactions (e.g., for “risk management” purposes). Remittances, settlements and reconciliations of post-payment issues are quite common. Perhaps a payment was late, requiring a late payment fee. Repeated late payments might warrant operational changes, such as pre-payment for transactions of a particular size. Thus, “Post-Decision Feedback” is another aspect of an automated system that is needed to reduce reliance on human judgment and intervention.

Because analysis of documents is an essential aspect of any solution to these problems, it is helpful to explore common Document-Processing Tasks that are encountered across many different financial and non-financial scenarios. For example, accounts payable (AP) and accounts receivable (AR) departments frequently struggle with the management of purchase orders (POs), invoices, checks, receipts, vendor statements, title documents and a host of other document types.

In addition to common transactions involving POs and invoices representing the sale of goods and services, other scenarios include mortgage appraisals and lending, contractor bonding, vehicle title transfers, chargebacks for disputed charges and calculation of rebates, among many others. While the specific Tasks and document types may differ across different scenarios, there remains a great deal of overlap with respect to common Tasks that present obstacles to automation (again due at least in part to the difficulty of deriving relationships among data within and across documents to “fill in the gaps” and resolve inconsistencies).

Consider the “wholesale lockbox”—a common service typically provided by banks or other financial institutions in an effort to simplify the “ingestion” of receivables by a company and facilitate its cash-flow management. In this scenario, customer payments are redirected from the company's address to a bank or other intermediary that processes the payments, extracts relevant information (e.g., customer name, payment amount, account number, etc.) and deposits the payments in the company's accounts along with reports of varying degrees of detail.

Similar “retail lockbox” services provide essentially the same functionality, but in a B2C (business-to-consumer) rather than a B2B (business-to-business) context. For example, utility companies with hundreds of thousands or millions of customers making monthly payments often rely on retail lockbox services to manage and process such payments.

Depending on the scenario, these lockbox services involve a variety of different document types, including invoices, remittance documents, envelopes, checks and vendor statements, among others. Moreover, each document includes multiple different “document components” or fields of data. The intermediary bank must process these paper and electronic documents as they arrive, despite the fact that such documents often fail to conform to predefined templates or formats.

While these lockbox services provide many advantages to companies, they are currently fraught with problems, many of which result in an overreliance on human intervention. For example, despite the proliferation of electronic payments, consumers and businesses alike still employ paper and electronic checks as a form of payment. The intermediary bank still must perform or delegate the Tasks of opening envelopes, reading, interpreting and entering data into a computer and/or relying on OCR technology to scan documents.

It is therefore not surprising that one major problem with existing lockbox services (and a vast array of other financial business transactions, as well as non-financial scenarios) is limited data accuracy regarding the “Capture” of information. Handwritten and even electronic checks frequently contain errors in names, dates, amounts, etc. Such errors are compounded by OCR technology, which performs particularly poorly with low-quality images, and even moreso by human data entry operators who must interpret what they see in a document and attempt to translate that into keystrokes (while often under immense pressure to process vast amounts of data within a limited period of time).

Another major problem lies in the inherent need to “Classify” various different document types, while also recognizing individual document fields. This process is currently a manual one, for the most part, involving human judgment regarding the relationships of data within and across documents. Failure to properly Classify documents and their component fields, and recognize relationships among them (DDRs in particular), is primarily the result of human error in failing to derive meaning from contextual clues within and across documents.

Many of these errors go uncorrected, while others are detected and corrected only as a result of human intervention. While auto-detection and correction technologies exist to a limited extent, they typically are restricted to predefined document layouts and formats, which may be too limiting for many scenarios.

As will become apparent, these Capture and Classification problems exist not only in the context of lockbox services, but across the spectrum of financial business transactions and beyond. What these scenarios share in common is that information must be Captured with sufficient accuracy, and various document types and components must be Classified as prescribed by the requirements of a particular scenario.

It should be noted that one common yet particularly difficult problem (with regard to Capture, Classification and many other Tasks) results from scenarios lacking predefined document layouts and formats. For example, both electronic files and written pages of paper often contain multiple documents that are not clearly delineated from one another. A single page of paper may contain two invoices and a purchase order stemming from three different transactions. Or a single invoice may span multiple pages. Similarly, a single electronic file may contain multiple documents across multiple document types, only some of which relate to the same transaction. The failure to accurately split, merge or otherwise “Segment” paper and electronic files to identify distinct documents and component fields is yet another reason companies are often forced to rely on human judgment and intervention, despite their desire for fully automated solutions.

In addition to Capture and Classification problems, data must also be “Matched” within and across documents. For example, payments must be Matched to their original invoices. It should be noted that this Matching problem is not limited to one-to-one relationships, such as the Matching of a single payment to its corresponding invoice.

For example, a single payment could apply to multiple invoices, or conversely a single invoice might be satisfied via multiple payments. Such many-to-many relationships are often difficult to discern from the explicit information contained within one or more documents, and therefore currently remain undetected, at least without extensive human intervention.

Such relationships also occur not only at a “document” Tier (or even a higher-level “transaction” Tier), but also at lower levels of abstraction, such as document components, fields and other objects, such as line-item data of varying detail. For example, in the context of credit card transactions, level 1 data may refer to a merchant name, billing zip code and transaction amount. Level 2 data adds fields such as sales tax amounts, tax IDs and merchant state codes, among others. Level 3 data adds even more detailed information, such as order numbers, ship to/from zip codes, item descriptions and quantity, and a host of other data fields.

The existence of numerous fields not only increases the difficulty of maintaining an acceptable level of data accuracy, but also exacerbates the Matching problem, as the potential mismatches between and among different data fields increases exponentially. For example, a merchant name on an invoice might not match the merchant name on a corresponding remittance document (or may not have been detected due to its unusual placement within a document). Item quantity mismatches might only be revealed when adding the quantities across multiple different shipments (another Task which often occurs only as a result of human judgment and intervention).

In addition to the myriad instances of “mismatches,” companies must also eventually “Reconcile” such mismatches, in part by determining whether there are “good” or “bad” reasons for the mismatch. For example, a supplier that ships items only by the dozen might ship 12 units in response to an order for 10 units (arguably the correct result in that circumstance). Or a remittance document might reflect payment for only 17 tomatoes, despite an order for 20 tomatoes, because 3 tomatoes were “rotten” upon arrival (again arguably the correct result). But if a supplier ships only 10 items in response to an order for 20 items because the supplier only has 10 items in stock, this result might be deemed a “bad” or incorrect result, requiring a future shipment of the remaining items, and perhaps even a financial penalty.

In short, Matching problems are often accompanied by related Reconciliation problems, both of which currently result in many errors, as well as increased cost due to the current need for human judgment and intervention. Moreover, it should be noted that human intervention only partly addresses these problems due to the prevalence of human error.

It is apparent that errors can result from many aspects of the overall process in almost any non-trivial use case scenario—from data Capture errors to improper Classification of document types or component fields to an endless array of Matching and Reconciliation errors. Human judgment and intervention, while reducing some of these errors, also contributes additional time, cost and human error to the problem.

Further errors result from a lack of “Verification”—another Task that currently either fails to occur, or requires extensive human judgment and intervention. For example, data within a Tax ID field may have a valid format, but may not actually contain the correct value in context. Or the value-added tax (VAT) charged by a business in a particular country may appear on the surface to be valid, but may actually be the result of applying the wrong VAT rate applicable to that country.

Moreover, the necessity for Compliance with particular laws and regulations, as well as internal organization or other scenario-specific rules, often requires a contextual understanding of such rules that cannot easily be discerned from the explicit information contained within and across available documents. For example, consider a rule that limits the cumulative value of monthly transactions. Even an automated application of that rule may require access to all relevant transactions within a particular month. But if a date is missing from a particular document, and can only be inferred from information in other documents, a lack of Compliance may well go unnoticed, or be detected and corrected, if at all, only as a result of human judgment and intervention.

Similar errors result from inaccurate “Coding” of data within document component fields, such as standard accounting codes or custom company-specific fields. On the surface, automatically detecting incorrect codes may appear to be relatively simple. But when the format of a substantively incorrect code is accurate, such detection becomes more complex and resistant to automation, as it often requires contextual clues within and across documents. Substantive errors are in essence “hidden” by accurate data formats, resulting in reliance on human judgment and intervention.

It should be noted that, as documents are Captured, Classified, Matched, Reconciled, Verified and Coded, most scenarios involve other Higher-Level Tasks (beyond basic Document Processing) that are performed with respect to transactions spawning such documents, as well as other key scenario-specific operations. For example, scenarios typically involve one or more ultimate Decisions (e.g., the approval or rejection of a loan application) as well as component interim “Actions” (e.g., the approval of expenditures exceeding a specified minimum amount). Such Decisioning Tasks are a central part of the workflow (automated or otherwise) inherent in most scenarios.

In addition, individuals within a company are often tasked with performing various “Analytics” with respect to transactions and their associated documents. Analytics Tasks are typically instigated by people formulating queries to a database that is populated manually as documents are processed. Another extremely important Higher-Level Task involves “Interrogation” or the formulation of queries that are typically submitted to the staff of AP, AR and other company departments.

These and other Higher-Level Tasks (e.g., Decisioning, Compliance, Analytics and Interrogation) also represent areas that frequently involve human judgment and intervention. The current practice of “querying databases” is inherently limiting, as it typically involves manually predetermined relationships among data, as opposed to relationships that are discerned automatically on an iterative ongoing basis as information is obtained.

While these various Document-Processing and Higher-Level Tasks are common to a wide variety of financial and other scenarios, they all present problems that are particularly resistant to automation. Raw information itself may be inaccurate. Document formats may vary greatly. More significantly, errors and other anomalies in data interrelationships (both within and across documents) are often difficult to discern (without human intervention) from the explicit information contained within documents.

With respect to Higher-Level Tasks, such as Decisioning and Compliance, there remains a need, as noted above, not only for integrated Continual CSD and Relationship Persistence, but also for Structural Gating and Post-Decision Feedback. Following is a discussion of the inadequacy of existing AI-based and other automated systems with respect to these Document-Processing and Higher-Level Tasks.

Efforts to address these problems, within and beyond the realm of financial business transactions, have been limited at best. The emergence of machine learning (ML) and other aspects of AI has been recognized as a key factor in resolving various aspects of these problems—due to AI's ability to recognize patterns, learn from past behavior and predict likely outcomes.

In the context of financial transactions, many companies tout their use of AI-based technologies to address these problems. Yet, virtually all such “solutions” are limited to isolated specific Tasks, such as fraud detection and Classification of predefined document types. These approaches do not encompass the many varied yet related Tasks present in any non-trivial scenario. And companies typically must decide when and how frequently to invoke this AI-based functionality.

One overarching problem is that many of the Tasks involved in any particular scenario are interrelated, causing an error with respect to one Task (e.g., Matching data fields across documents) to cascade into errors regarding other Tasks (e.g., authorizing a decision to pay an invoice, generating a summary report, providing responses to natural language queries, etc.). Interdependencies among various Tasks create recurring problems in determining when and how particular Tasks should be performed.

Failure to perform these various Tasks on an ongoing basis (e.g., as new information is obtained, including the mere passage of time) causes many errors to go undetected or be compounded as a result of faulty assumptions. For example, a document may remain unclassified or be improperly Classified due to missing or contradictory information, such as a missing date or a misspelled vendor name. Subsequent information from a new email or other related document could enable the original document to be Classified properly—but only if that fact is recognized in context and the Classification Task is “reinvoked.” This is yet another example of the need for Continual CSD.

Moreover, the mere passage of time may constitute an “Event” requiring that particular Tasks be repeated. For example, recognizing that an invoice has not been received for an unusually long period of time could enable the reinvocation of a Reconciliation Task which might result in a reminder email being sent to a supplier as the close of the fiscal quarter approaches. The absence of a document or other information is itself an Event that may warrant further inquiry.

It should be noted that humans routinely perform Tasks in response to various Events, including the receipt of new information, the passage of time, the absence of an expected document or other information, and other metadata or information that suggests an anomalous Event has occurred or some other Event is anticipated to occur in the near future.

Existing automated approaches rarely (if ever) anticipate upcoming Events (e.g., a payment deadline or a potential overdrawn account), much less take proactive steps to respond to such Events. To address the problems described above, it is important that any solution be capable of detecting Events of various types and taking proactive steps in response, including the performance or reinvocation of particular Tasks.

In contrast to “vertical solutions” in the field of financial business transactions, companies such as Google have developed more general, “technology-centric” approaches to these problems. For example, Google's “Document AI” technology employs AI-based technologies in an effort to “gain deeper insights from unstructured or structured document information.” While Google employs an “Enterprise Knowledge Graph” to organize information, it relies on customers to utilize its Entity Reconciliation and other APIs to populate its knowledge graph, and, even more importantly, to traverse the knowledge graph to aid in the processing of subsequent documents (given the inherent interrelationships across documents).

In other words, Google's Document AI technology does not iteratively populate its Enterprise Knowledge Graph with relationships that represent context discerned from Document Processing as information is obtained (e.g., with regard to the various interrelated Tasks involved in a particular use-case scenario). Moreover, it does not discern such context in an integrated fashion on a continual basis over time, encompassing Document-Processing Tasks (e.g., Capture, Classification, Matching, Reconciliation, Verification and Coding) as well as Higher-Level Tasks (e.g., Decisioning, Compliance, Analytics and Interrogation).

A key reason for such shortcomings is that Google's Document AI does not employ the current state of its Enterprise Knowledge Graph (e.g., by traversing the current Enterprise Knowledge Graph) to perform such Tasks on an ongoing basis, much less recognize when such Tasks should be performed or repeated. In short, it lacks CSD, much less any indication of Continual CSD.

Instead, Google's Document AI technology requires its customers to utilize Google's Entity Reconciliation, Google Knowledge Graph Search and other APIs to populate and search the Enterprise Knowledge Graph, which essentially represents relationships already present in the customers' own files. In other words, customers must determine when to invoke particular Tasks in an effort to derive meaning from context, how and when to update a knowledge graph (or other means of reflecting current relationships among data within and across documents) to reflect changes resulting from the performance of such Tasks, and when to repeat such Tasks (e.g., in response to new Events, or even in response to relationships among information within documents already processed).

Finally, it should be emphasized that rules-based approaches to these problems are insufficient and simply not feasible solutions to the problems discussed above. For example, when humans manually recognize that certain types of anomalies are common to a particular scenario (e.g., conflicts between the quantity of items in a PO and an associated invoice), programmers theoretically could implement a rule to identify and address such anomalies. But, as a practical matter, there could exist thousands or even millions of different types and variations of such anomalies. Expecting humans to pre-identify such anomalies and determine how each should be addressed would be an exercise in futility.

Current rules-based approaches handle only a small fraction of actual anomalies (or other errors or ambiguities) in any non-trivial scenario, leaving the rest to human judgment and intervention. There is thus a need for an automated system that detects and addresses such anomalies without requiring that humans identify rules in advance for implementation by programmers.

It is important to note that many of the same problems discussed above exist in scenarios involving Higher-Level Tasks in addition to Document Processing Tasks. For example, the “vertical” area of Payments and Compliance is one in which AI-based systems have arisen to address not only the automated processing of documents, but also Higher-Level Tasks such as Decisioning and Compliance.

In this area, parties engage in transactions subject to Compliance obligations (whether external or internal). Existing AI-based systems endeavor to address a key automation problem of enforcing and demonstrating Compliance—in this case adherence to payment-related obligations, in particular before payments are initiated.

For example, consider the area of ACH (Automated Clearing House) Payments in which banks and others are subject to rules imposed by a governing body (NACHA—National Automated Clearing House Association). Obligations include not only constraints on the payments that are allowed on the ACH network, but also records that must be maintained to demonstrate compliance.

Companies that originate an ACH Payment (known as Originators) request that their bank (ODFI—Originating Depository Financial Institution) submit that ACH Payment onto the ACH Network (e.g., FEDACH—Federal Reserve—or EPN—The Clearing House), which transfers the ACH Payment to the Receiver's bank (RDFI—Receiving Depository Financial Institution) where the ACH Payment is deposited into the Receiver's account.

AI-based platforms have arisen on behalf of Originators (known as “Front Door Systems”) in an effort to lower costs, accelerate cash flow, mitigate fraud, etc. These platforms include those from companies such as Stampli, Tipalti, GEP, Airbase and Coupa, among others.

Yet, they all contain significant architectural deficiencies, including those already noted above. For example, because an ODFI cannot demonstrate compliance with its NACHA obligations simply by relying on an Originator's use of these Front Door Systems, significant legal exposure remains to regulators, auditors, etc. Moreover, their lack of atomic-level CSD, as well as Continual CSD over time along with Relationship Persistence, leaves Originators with significant “holes” in their ability to meet their objectives (i.e., missing context), as well as increased costs due to frequent need for human intervention.

The inherent disconnect between the Originator and the rest of the ACH Network further limits the effectiveness of Front Door Systems. For example, without information from the rest of the ACH Network, including Receivers, Front Door Systems frequently fail to detect risk escalation (and deescalation) over time. The lack of integration (e.g., at a line-item level) with systems on the rest of the ACH Network effectively prevents accurate risk-assessment capabilities.

Similarly, without a mechanism for Structural Gating that is correlated to a meaningfully accurate assessment of risk, ACH Payments will either be under-restricted (e.g., ACH Payments will be processed when they otherwise would have been rejected had additional context been revealed) or over-restricted (e.g., ACH Payments will be unnecessarily rejected due to the lack of additional context).

AI-based platforms also exist on behalf of banks and other ODFIs (known as “Back Door Systems”) in an effort to meet the ODFI's Compliance obligations. These platforms include those from companies such as Verafin, NICE Actimize and Early Warning Systems, among others. Large ODFIs also typically manage proprietary “warehouses” (e.g., customized versions of Fiserv PEP+) to integrate with the ODFi's Back Door System.

One of the primary flaws with these Back Door Systems is that they essentially operate at an “entity” level, as opposed to an atomic or line-item level. In other words, while they have access to network information (e.g., bad actors, unusual velocity of ACH Payments, frequently modified account numbers and other higher-level suspicious “payment behavior”), they do not have access to detailed Originator documents to monitor “relationship state” over time.

Not surprisingly, they also lack atomic-level CSD, as well as Continual CSD over time and Relationship Persistence, leaving the ODFI with significant Compliance exposure (e.g., to NACHA) due to their inability to extract and act on line-level context, such as gating Payments based on an accurate risk assessment over time (beyond obvious entity and other “high-level” ACH Network risk Signals). Here too, a frequent need for human-processed exceptions also significantly increases costs.

The inability of existing AI-based systems to create a defensible Compliance process is a result of many of the same general deficiencies discussed above. Moreover, as will be demonstrated in greater detail below, the same is true across a wide variety of financial and non-financial use cases and scenarios.

In short, it should be emphasized that, while AI-based systems facilitate the extraction of context from documents, they currently fail to (i) identify line-item or atomic-level Signal, as well as higher-level inferences; (ii) discern context in the form of DDRs and other relationships among data; and ultimately (iii) reveal meaning from such context.

There is thus a need for an automated system that employs and integrates (i) CSD to discern context at a line-item or atomic Signal level, as well as Continual CSD over time within and across documents; (ii) Relationship Persistence to enable traversal of a knowledge graph of line-item level DDRs and other relationships before performing Tasks, followed by updating of that knowledge graph); (iii) Structural Gating to condition key operations on accurate risk assessments, including criteria not currently available to the system, and (iv) Post-Decision Feedback to enable further follow-up decisions regarding the same or future transactions.

Such as system would replace much of the existing overreliance on human judgment and intervention with automated means of deriving meaning from context. It would employ some or all of the following:
1 Document Processing as Events occur—e.g., as information is obtained or provided by a customer in the course of the transactions and related processes defined by the customer's particular use case scenario (whether in the realm of financial business transactions or otherwise);
2 Continual CSD during performance of Document Processing Tasks and/or Higher-Level Tasks to identify Signal and inferences therefrom, discern context in the form of DDRs and other relationships, and ultimately reveal meaning from such context;
3 Relationship Persistence to represent context in the form of derived relationships among data within and across documents (including DDRs) in one or more knowledge graphs, and iteratively traverse and update such knowledge graphs automatically on an ongoing basis;
4 Continual Responsiveness to Events (including receipt of new documents or other information, internally-generated and externally-generated natural language or other queries, passage of time, detection of an anomaly, anticipation of expected future Events, hypotheses of potential Events, etc.) by performing key operations and other Tasks, including reinvoking Tasks, based upon the current state of the knowledge graphs; and
5 Integrating all of the above to substantially reduce reliance on human judgment and intervention by performing Decisioning, Compliance and other Higher-Level Tasks (including Structural Gating and Post-Decision Feedback) in a manner that replaces rigid rules-based workflows with an architecture that handles transitions among the various states of a process in an automated fashion with limited human exception handling.

Such a system would employ a proactive holistic approach (rather than one that relies on predefined rules and isolated applications of AI-based technologies triggered by customers) to automate much of the work currently being performed by humans to derive meaning from context in the form of relationships among data within and across documents. Many such relationships, including DDRs, would be derived automatically, thereby limiting the need for human judgment and intervention with respect to such relationships.

Existing approaches have failed to represent the current state of such relationships in iteratively updated knowledge graphs, much less utilize that current state on an ongoing basis to perform Document Processing and Higher-Level Tasks over time. Doing so would greatly reduce the reliance on human staff by simulating the inferences currently requiring intervention by such human personnel.

### SUMMARY

In accordance with the present invention, various embodiments of novel methods and architectures are disclosed herein. The present invention provides a novel solution to the problems described above in the form of an autonomous Event-driven integrated system designed to run on a continual basis to implement virtually any scenario in which relationships among data within and across documents are difficult to discern (without human intervention) from the explicit information contained within those documents.

As noted above, existing overreliance on human judgment and intervention has resulted from a failure to derive meaning from context in an automated fashion. To alleviate these shortcomings, the present invention employs machine learning to identify line-item and other atomic-level Signal, within and across documents, as well as higher-level inferences therefrom. It employs this Signal to discern context in the form of DDRs and other relationships among data from which meaning is revealed over time. It leverages such meaning continually in response to Events to automate Actions, Decisions and other Higher-Level Tasks, in addition to Document Processing Tasks.

Unlike existing solutions, the present invention integrates the automated performance of various Tasks (including Document Processing Tasks and Higher-Level Tasks) that are common to virtually any given scenario. Users of the present invention need not determine when and to what extent to invoke or reinvoke particular Tasks. Moreover, the ability of the present invention to identify and address DDR-based and other anomalies is not dependent on predefined rules (which, in any event, could not feasibly be determined in advance).

The integrated system of the present invention runs autonomously on a continual Event-driven basis. As Events occur (including among others the receipt of new documents or other information, the receipt of internally-generated and externally-generated natural language or other queries, the detection of an anomaly, the absence of an expected document over time, or the anticipation or hypothesis of an expected or potential Event, as well as the passage of time), the present invention employs CSD to derive meaning from context.

It should be noted that the present invention does not simply perform CSD as it encounters a document. This is not a one-time process. Instead, it performs Continual CSD over time to discern context in the form of data relationships (including DDRs) within and among documents and portions thereof (e.g., by identifying line-item and other atomic-level Signal, as well as inferences therefrom).

For example, relationships among line-item data across various documents may not be discerned easily as a single document is processed. The present invention may extract individual item totals across multiple POs. But only during subsequent processing of other POs and perhaps an Invoice will the system discern sufficient context, for example, to reveal which POs are covered by that particular invoice, and whether the invoice total matches the sum of the relevant individual line-item totals, including tax, shipping and other fees.

Given that the system may encounter such documents in any order over time, Continual CSD enables the system to discern context on a continual basis, in some cases by reinvoking Tasks as a result of context that was previously hidden and only revealed over time as new information became available. To identify relationships (and thus context) on a continual basis, the present invention employs, and updates over time, one or more “Knowledge Graphs,” which are in turn traversed over time to facilitate processing not only of current documents, but also future processing of subsequent documents and other Events.

Such Knowledge Graphs provide Relationship Persistence by maintaining the context (including DDRs and other data relationships) over time. Prior to performing a given Task, the present invention traverses the Knowledge Graphs to provide a “current context” to facilitate its performance of that Task, after which it updates the Knowledge Graphs to confirm, replace, supplement or otherwise modify such context to facilitate processing of future Tasks over time.

The present invention automates the performance of Tasks, including Higher-Level Tasks that involve Actions and Decisions within a scenario-specific workflow (referred to herein as “Workflow Tasks”). The automated performance of one or more Workflow Tasks—as distinguished from the passive generation of a response to a prompt—is referred to herein as “Agentic Workflow.”

Agentic Workflow is not itself novel. However, the present invention employs Continual CSD and Relationship Persistence in the performance of Workflow Tasks and, in some embodiments, further employs “Context-Derived Conditioning” (i.e., a form of Structural Gating) in which the performance of a Workflow Task is conditioned upon the satisfaction of one or more conditions that are reflected in (and derived via CSD from) the current state of the one or more Knowledge Graphs. Moreover, with respect to particular Higher-Level Tasks, such as Decisioning and Compliance, the present invention employs Structural Gating and Post-Decision Feedback, as described in greater detail below.

In one embodiment, the present invention also employs Continual CSD to perform Higher-Level Tasks beyond Document Processing, such as Decisioning, Compliance, Interrogation, Analytics, Narrative generation, anomaly detection and resolution, etc. This process is somewhat similar to that employed for Document Processing Tasks, in that meaning is derived from context in the form of data interrelationships, including DDRs, already present in one or more Knowledge Graphs, as well as relationships among current data being processed.

However, with regard to Higher-Level Tasks (e.g., Decisioning and Compliance, among others), the present invention employs additional techniques to facilitate the automated performance of these Tasks while reducing substantially the need for human judgment and intervention. While virtually any non-trivial use case or scenario inherently includes a desired scenario-specific workflow, it is simply not feasible, as noted above, to employ a rules-based approach to implement that workflow. Any such approach will be fraught with numerous exceptions, requiring substantial human judgment and intervention.

Here too, the present invention employs machine learning to automate the transitions among the various states of that workflow to facilitate the continual performance of relevant Higher-Level Tasks, while still relying on Continual CSD and Relationship Persistence with respect to interim Document Processing Tasks. In one embodiment, the present invention employs Structural Gating techniques to condition key operations (e.g., interim Actions and Decisions) on accurate risk assessments that may include criteria not yet available to the system.

For example, as the present invention encounters a Decision (e.g., whether to pay an invoice), it considers various criteria by traversing the Knowledge Graphs (such as the invoice due date, prior receipt of relevant goods and services, necessary approvals, bank account balances, etc.). In some cases, the system may conclude that the invoice is not yet “ripe” for payment (e.g., too early for payment), or that additional information is required.

Rather than relying on rigid predefined rules, the present invention instead employs machine-learning techniques to determine not only the criteria necessary to implement a current Task, but also whether a transition to another state (e.g., from an “Active/Clear” state to a “Conditional/Held” state) is warranted to implement future Tasks as well as that current Task. In one embodiment, the present invention continually assesses risk to facilitate the implementation of both current and future Tasks.

Structural Gating is a key component of this architecture, as many Decisions (and other Tasks) are, at any given time, conditioned upon assessments of risk and whether relevant criteria have been satisfied. Moreover, after Decisions are made and Actions are taken, it is common in many scenarios to receive feedback that affects implementation of both current and future Tasks. Thus, in one embodiment, the present invention also employs a Post-Decision Feedback mechanism to incorporate such feedback into the Decision-making process.

For example, as noted above, a payment might be late or insufficient, thereby warranting a corrected payment, perhaps including a late payment fee. Repeated late payments might warrant operational changes, such as pre-payment for transactions of a particular size. Each of these subsequent Decisions is dependent not only upon the current state of the Knowledge Graphs, but also upon specific Post-Decision Feedback.

It should be emphasized that the present invention integrates concepts such as Continual CSD and Relationship Persistence into the implementation of both Document Processing and Higher-Level Tasks on a continual basis in response to Events. In one embodiment, both structural Gating and Post-Decision Feedback are also integrated into this architecture to further reduce the need for human judgment and intervention.

In other embodiments, Document-Processing and Higher-Level Tasks are performed in parallel via one or more models trained for specific purposes. As will be discussed in greater detail below, as each new file is processed, potentially relevant Signal is identified and provided to various other modules working in parallel.

Files are Segmented into discrete “File Content” (e.g., distinct documents) and Classified into types, while component fields and other objects and their attributes are identified and analyzed. Each of the modules responsible for performing various aspects of this functionality utilize the provided Signal in different ways. Moreover, these modules update one or more Knowledge Graphs on a continual basis, often after traversing current Knowledge Graphs to facilitate performance of their particular functionality.

Traversal of current Knowledge Graphs facilitates processing of current Tasks based upon previously identified interrelationships (e.g., among component objects within a document, and even across documents already processed). In this manner, processing of one field within a document is facilitated by prior processing of other fields within the same document, or within other previously processed documents. Moreover, parallel processing of fields and other component objects facilitates the identification and resolution of many discrepancies due to the existence of various inter-object and inter-document dependencies and interrelationships.

This proactive holistic approach automates much of the work currently performed by humans. Automatically deriving meaning from context reduces the need for human judgment and intervention.

In one embodiment, a “Scenario Controller” manages the overall logistics of this continual Event-driven process, including the scenario-specific aspects of the process, such as conditional staff approvals and other workflow Actions, particular Task definitions, document types, Event types, etc. The Scenario Controller also manages the invocation of Events and the various Tasks performed in the course of responding to Events to implement the scenario.

While some of these Tasks may still require some human judgment and intervention, the Scenario Controller manages specialized Task-specific agents (“TSAgents”) designed to employ CSD to automate the performance of Document-Processing Tasks to a significant extent. In other embodiments, the TSAgents also implement Higher-Level Tasks, including Decisioning, Compliance, Interrogation, Analytics, Narrative generation, anomaly detection and resolution, etc.

As noted above, Tasks are performed on an ongoing continual basis in response to Events. By employing Continual CSD to derive data interrelationships (including DDRs) and iteratively traverse and update one or more Knowledge Graphs, the present invention greatly reduces the reliance on human staff by simulating many of the inferences currently requiring human judgment and intervention.

In particular, as will be explained in greater detail below, the iteratively updated Knowledge Graphs contain the context necessary to enable the present invention to detect and address anomalies that would otherwise go undetected, or would require significant human judgment and intervention. Addressing such anomalies may require that certain Tasks be reinvoked over time, whether due to the presence of new information (including the mere passage of time) or simply the contextual knowledge of the existence of such anomalies.

As will be illustrated in greater detail below, multiple iterations may be required to adequately address certain anomalies. While not every anomaly can be resolved without the necessity of human judgment and intervention, the present invention significantly reduces the need for such human assistance.

As noted above, derived relationships among data both within and across documents often include DDRs, in part due to the existence of many-to-many relationships. A particular field or other document component may be related to a field in another document which may or may not be part of the same transaction. For example, a supplier name on a PO may match the supplier name on an invoice, but for a completely different transaction.

The ability of the present invention to Segment individual documents (e.g., multiple POs or other document types on a single page, as well as a single PO that spans multiple pages), as well as Classify multiple documents (and their component fields and other objects) and match them to particular transactions, is one of the many characteristics of the present invention that distinguishes it from existing systems that too often rely on human judgment and intervention in these scenarios.

As the TSAgents traverse current Knowledge Graphs to facilitate performance of these Tasks on an iterative basis over time, these derived relationships (including DDRs) are reflected in one or more iteratively updated Knowledge Graphs. As a result, the Knowledge Graphs represent, at any given point in time, the underlying relationships from which a current narrative or story behind the transactions, documents and other related information previously processed by the system can be generated. The Scenario Controller determines when to invoke particular TSAgents to perform or reinvoke certain Tasks, based in part upon the current state of the Knowledge Graphs, as well as the occurrence of one or more Events.

In one embodiment, such Events include (among others) receipt or absence of new documents and other information, passage of time, detection of an anomaly, anticipation of expected documents or other information, hypotheses of potential future conditions, updates to the Knowledge Graphs, etc. In response to such Events, the Scenario Controller triggers one or more TSAgents to perform or reinvoke certain Tasks, which results in further updates to the Knowledge Graphs. This iterative process operates on a continual basis over time, with the Knowledge Graphs frequently changing to reflect the current state of a vast array of data relationships (including both semantic and temporal ones).

It should be noted that the autonomous nature of the present invention results in the Scenario Controller triggering TSAgents in response to a wide variety of internally-generated as well as externally-generated Events, including updates to the Knowledge Graphs themselves. In other words, the present invention is continually learning and searching for new patterns based on Knowledge Graphs that are frequently being updated (e.g., due to the passage of time as well as the receipt of new documents or other information).

In one embodiment, the Scenario Controller not only anticipates future conditions (e.g., an expected invoice), but also hypothesizes potential future conditions (e.g., based on detection of a learned pattern). For example, an invoice may be received on the same day each month for the same amount, and routinely be forwarded to a particular supervisor for approval. At some point, the Scenario Controller detects this pattern and hypothesizes a more efficient solution (from its learned experience)—e.g., an “auto-approval” that enables the supervisor to approve automatically in advance all future invoices received on the same day of the month for that same amount.

In this manner, the present invention proactively generates a suggestion to the supervisor for approval of this streamlined process-just as a skilled employee might do. The autonomous nature of the present invention, operating on a continual basis over time (with a constantly changing state of data relationships reflected in the Knowledge Graphs) makes this level of proactivity possible with minimal human intervention.

In one embodiment, a “Narrative Generator” is employed by the Scenario Controller to traverse the Knowledge Graphs to facilitate the determination of the “next step” in the workflow specific to a customer's scenario (e.g., taking an Action relating to an upcoming Decision, processing additional documents, re-processing documents to complete a particular Task based on updated information in the Knowledge Graphs, traversing the Knowledge Graphs to respond to internally or externally generated natural language queries, etc.).

The Narrative Generator, in another embodiment, also generates internal hypothetical queries, such as determining whether there will be sufficient funds to pay all invoices at the end of the month, or whether transfers from other bank accounts will be necessary. Moreover, the Narrative Generator also responds to user-generated natural language queries that pose hypothetical questions. In one embodiment, the Narrative Generator “temporarily” modifies the Knowledge Graphs to analyze such hypothetical situations.

It should be noted that this process is also an iterative one in that Tasks may well be triggered by updates to the Knowledge Graphs or by other Events (e.g., receipt of new documents or other information, the passage of time, etc.). Individual TSAgents (e.g., performing Capture, Classification, Verification and other Document-Processing Tasks) may be triggered at any time as the Scenario Controller monitors the occurrence of Events (including updates to the Knowledge Graphs) to determine, for example, whether recently obtained information (even a newly derived relationship among components of documents previously processed) warrants the current performance of a Task involving further processing of documents, a workflow-specific Action or Decision, or a response to a natural language user query, among other Tasks.

In one embodiment, files (as well as discrete documents) are processed by the system in an asynchronous manner. For example, system users may provide a “document package” to the system for batch processing of documents, both structured and unstructured. A document package may contain one or more documents in virtually any format (handwritten or printed paper, emails, spreadsheets and database files, streaming audio, video or other media files, etc.).

Users may also provide individual documents (or document packages or files) to the system over time, for example as the information is obtained (such as an email or invoice recently received). Users need not separate individual documents, pages or even document types, as the system performs the Task of capturing and classifying such documents (in one embodiment by a TSAgent designed for that particular Task, including Segmenting individual documents or other file content).

TSAgents employ CSD as necessary to Capture and Classify documents and document types, as well as identify individual document components, such as data fields and other objects at various levels of abstraction (as well as other Document-Processing Tasks and Higher-Level Tasks). In the course of performing such Tasks, TSAgents discern context from documents in the form of relationships (among documents, entities and other document components) that are maintained in the iteratively updated set of Knowledge Graphs.

It should be noted that such relationships may not all be derived as each document is processed. Instead, the TSAgents derive certain relationships over time in response to the occurrence of Events, including detecting the absence of documents or other information expected in the future. The present invention detects over time not only the receipt of new information, but also anomalous Events, including the absence of documents and other information. It also anticipates the occurrence of expected Events and hypothesizes the occurrence of potential Events, and responds proactively by invoking one or more TSAgents.

For example, the system may identify an invoice, but not be able to match that invoice to any particular purchase order until subsequent information is obtained in the course of processing future documents that provide sufficient context to enable the system to make such a determination. The absence of such expected information is reflected in the Knowledge Graphs.

As the scenario progresses, the Scenario Controller encounters new information that involves not only further processing of documents, but also Decisions and component Actions that arise in the course of implementing the particular scenario workflow. Moreover, users may request that the system perform various Analytics on the current state of the scenario, as reflected in the Knowledge Graphs.

In one embodiment, users provide natural language queries to the system, thereby enabling automation of many of the Tasks routinely performed by humans, such as AP and AR staff members. Unlike highly constrained database queries, these natural language interrogations are not merely translated into standard SQL and other database queries. Instead, as is illustrated below, these queries involve the system's traversal of the Knowledge Graphs, including the many relationships among data not easily discerned or feasibly stored in a traditional database.

The application of Continual CSD by particular TSAgents discerns context over time represented by relationships stored in the Knowledge Graphs. For example, despite missing or contradictory information stored in the explicit text of particular documents (such as the payment amounts of particular transactions), TSAgents derive the actual information from the context provided by other documents (such as summary reports) and respond to a user's natural language query, often without error or equivocation.

As noted above, the embodiments of the novel methods and systems of the present invention, while described herein with respect to financial transactions, are equally applicable to personal, business, educational, governmental and other processes, including those outside the financial realm. Moreover, the descriptions of paper and electronic documents and files herein encompass a definition of “documents” well beyond individual characters and words, including their locations on a page or in a file, the structure of data and other higher dimensions of documents. In short, documents include any metadata or attribute of information from which signal can be distinguished from noise to reveal meaning.

Finally, the present invention provides an enhanced manner of training neural networks and other machine-learning models beyond the traditional uses of numerous training samples. To facilitate real-time modified training of models, the present invention, rather than generating synthetic data, utilizes a “Validation Engine” (consisting of multiple trained models) on real-time data when confidence levels (also interchangeably referred to herein as confidence values) are insufficient to merit conclusions, and retrains its existing models based upon the output of the Validation Engine. In this manner, existing models are retrained in real time based upon actual customer data without the additional time and expense required to generate additional training samples or synthetic data.

Many additional examples of the automation of Tasks currently left to human judgment and intervention will be apparent from the description of the various Figures below.

### BRIEF DESCRIPTION OF DRAWINGS

FIG. 1 is a system-level block diagram of one embodiment of key modules of the system of the present invention, emphasizing performance of Document-Processing and Higher-Level Tasks;

FIG. 2 is a dynamic process-level state/flow diagram of one embodiment of the functionality performed by key modules of the present invention;

FIG. 3 is a dynamic flow diagram of one embodiment of the real-time validation engine and self-learning functionality performed by key modules of the present invention to retrain models from actual processed data;

FIG. 4 is a screenshot of one embodiment of an interactive session of the present invention in which an AP clerk submits a recent invoice to the present invention for processing.

FIG. 5 is a dynamic flow process-level state/flow diagram of an embodiment of the functionality performed by key modules of the present invention, with a more specific focus on the parallel processing nature of the present invention and the simultaneous use of signal by various modules during the processing of a file.

FIG. 6 is a system-level block diagram of one embodiment of key modules of the system of the present invention, emphasizing state management of Higher-Level Tasks.

FIG. 7 is a state diagram illustrating one embodiment of key states and transitions implementing state management of Higher-Level Tasks with respect to a vast array of scenario-specific workflows.

### DETAILED DESCRIPTION

Embodiments of the present invention described below include novel architectures and methods for automating the derivation of meaning from the context “hidden” within and across documents to reveal a more complete picture of the underlying narrative of the transactions and related processes spawning such documents. As noted above, while these embodiments focus primarily on scenarios involving financial business transactions, the underlying principles are equally applicable to personal, business, educational, governmental and other processes, including those outside the financial realm.

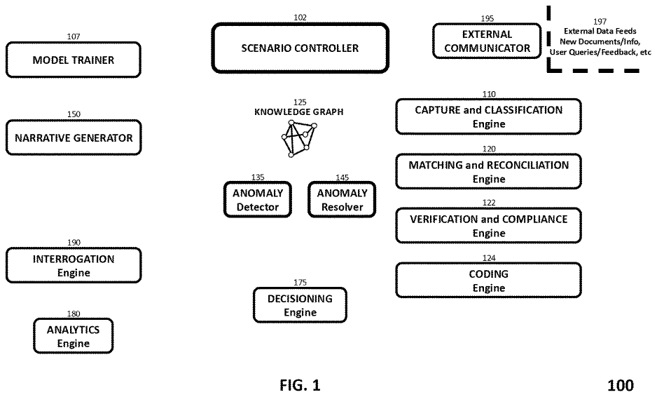

Turning to FIG. 1, key components of one embodiment of the present invention are illustrated in system diagram 100. While not illustrated explicitly in FIG. 1, components of system 100 are implemented as software modules embodied in physical non-transitory computer-accessible storage media (i.e., memory) from which they are invoked for execution by one or more CPUs or other physical processing units on standard computer hardware, such as interconnected computer servers, desktops, laptops and other similar devices. Also not shown are other standard physical computer components (including memory, displays, I/O devices, communication and networking devices, etc.) and external networks (e.g., the Internet) with which system 100 communicates.

It should be noted that the functionality of the modules of system 100 can be implemented in combinations of software and hardware in accordance with standard engineering tradeoffs. Moreover, such functionality can be merged together, split apart and otherwise reallocated into subsets or supersets of the modules illustrated in system diagram 100. Similarly, the Tasks performed by one or more such modules can differ from those illustrated and described herein without departing from the spirit of the present invention.

In one embodiment, each user scenario (personal, business, financial, non-financial or otherwise) defines its own specific Tasks as well as document types, relevant fields and other components, and Events to which system 100 will respond. Moreover, as noted above, documents of each particular document type may include structured and/or unstructured information, text, audio, video and other media—i.e., virtually any medium, metadata or other attribute of information from which Signal can be distinguished from noise to reveal meaning. In other embodiments, system 100 defines general scenario implementations which customers accept and/or customize to a desired extent.

As alluded to above, Scenario Controller 102 manages the workflow defined by the scenario. In one embodiment, this workflow includes various approvals, payments, verifications and other Decisions and component Actions performed by particular personnel as part of a process resulting in one or more desired outcomes.

As a general matter, Scenario Controller 102 also manages the overall logistics of the continual Event-driven process, including the identification and invocation of Events and the triggering of various Tasks performed in the course of responding to such Events to implement the scenario. As will be discussed in greater detail below, Scenario Controller 102 identifies and monitors the occurrence of Events and, in response, invokes specialized TSAgents that employ CSD to automate the performance of various Document-Processing and Higher-Level Tasks.

Scenario Controller 102 determines when and to what extent to invoke particular TSAgents to perform these Tasks based in part upon the current state of Knowledge Graph 125, as well as the occurrence of one or more Events. In one embodiment, Knowledge Graph 125 is implemented as a single entity representing relationships (including DDRs) derived by one or more TSAgents. In other embodiments, Knowledge Graph 125 is implemented as multiple distinct but related entities, each referred to herein collectively as Knowledge Graph 125.

As noted above, Knowledge Graph 125 is frequently updated as various Tasks are performed to reflect the current state of a vast array of data relationships (including both semantic and temporal ones) both within and across documents. As will be discussed in greater detail below, these relationships, including those derived by TSAgents via the use of CSD, often represent DDRs (typically across multiple relationships) that reflect errors and other anomalies which are difficult to discern without human judgment and intervention. The current state of Knowledge Graph 125 enables Scenario Controller 102 and other modules of system 100 (including their TSAgents) to traverse the current state of Knowledge Graph 125 to determine how best to perform their Tasks on a continual basis over time.

In one embodiment, Knowledge Graph 125 updates are implemented via standard Knowledge Graph Language (KGL) change requests. In other embodiments, a host of other graphing and query languages alternatives are employed, such as Resource Description Frameworks (RDF), Web Ontology Language (OWL), SPARQL, Cypher, GraphWL, Gremlin, etc. The choice of centralized v. decentralized models, graph storage options, NLP and semantic enrichment alternatives, and various hybrid implementations of the above involve design and engineering tradeoffs that can be accommodated without departing from the spirit of the present invention.

In another embodiment, Knowledge Graph 125 employs semantic, temporal and activation weights respectively to facilitate interpretations of and responses to natural-language queries, Actions accounting for the relevance of time and biases relating to recently activated nodes. Moreover, the use of “Retrieval Agents” and “Hypothesis Agents,” which employ the semantic, temporal and activation weights, facilitates responses to hypothetical as well as actual Events (e.g., to assess the effect on monthly budgets of doubling current orders for a particular product). Here too, the choice of how to implement particular weighting schemes as well as Retrieval and Hypothesis Agents is the result of design and engineering tradeoffs that can be accommodated without departing from the spirit of the present invention.

Scenario Controller 102 also communicates with “external” persons, entities, systems and other devices 197 via External Communicator 195. In one embodiment, the Internet (not shown) is employed to facilitate this communication, enabling Scenario Controller 102 to communicate bidirectionally with users of system 100 and third-party systems (e.g., to obtain new documents, third-party data feeds and other information for processing, as well as to receive and respond to user queries and Analytics requests, among other purposes).

Other components of system 100 illustrated in FIG. 1 relate to the particular Tasks performed with respect to a given scenario. While many of these components are common to many different scenarios, certain Tasks may be added, revised or eliminated without departing from the spirit of the present invention. In the illustrated embodiment, each of these Tasks involves, at least in part, the performance of CSD to derive meaning in the form of relationships among data within and across documents.

In the course of facilitating transactions and other processes that result in the generation and/or processing of related documents, Scenario Controller 102 relies on various document-processing TSAgents, which in this embodiment are specific to the various Tasks defined by the scenario. One such TSAgent is Capture and Classification Engine 110, which performs data capture Tasks, as well as document Classification (e.g., among relevant data types) and identification of particular document components, such as various fields of data.

While some of the functionality performed by Capture and Classification Engine 110 is relatively straightforward, there are many instances in which information may be missing, incorrect and contradictory with respect to similar information found within and across documents. As noted above, handwritten errors (often compounded by OCR errors) as well as data entry errors, are quite common. Moreover, the lack of standard document templates often exacerbates this problem.

In this embodiment, Capture and Classification Engine 110 employs CSD in an effort to derive meaning from context, which may involve analysis of other documents in a document package, or analysis of future documents at a later time, to complete its Task. By deriving relationships among data, both within and across documents, and storing derived relationships in Knowledge Graph 125, Capture and Classification Engine 110 lays the groundwork for analyzing DDRs and identifying and addressing DDR-related errors and other anomalies.

While it employs various AI-based techniques to perform its Task, a significant aspect of Capture and Classification Engine 110 is its use of Continual CSD to derive many-to-many and other relationships from the context available not only in the current document or documents it is processing at any given time (and information reflected in Knowledge Graph 125 from previously processed documents), but also from future information that may “fill in the blanks” at a later time and enable it to complete its Task.

For example, a Capture error regarding a vendor name in an invoice may not be recognized initially, or may be Captured incorrectly. But, during a subsequent iteration, Capture and Classification Engine 110 may be reinvoked with an updated Knowledge Graph 125 containing a matching PO with an accurately Captured vendor name. The additional context provided by other fields (e.g., within the invoice, as well as within a matching PO or other documents) enables Capture and Classification Engine 110 to identify and correct the initial vendor name Capture error in the invoice.

In one embodiment, the inability to Capture a vendor name with sufficient confidence is stored in Knowledge Graph 125, thus facilitating the subsequent correction. Even if an incorrect vendor name was Captured with sufficient confidence and stored in Knowledge Graph 125 (e.g., due to a human handwritten or data entry error), Capture and Classification Engine 110 may still be able to correct the error due to the existence in Knowledge Graph 125 of the additional context provided by other fields within and across multiple previously processed documents.

In this manner, Capture and Classification Engine 110 iteratively performs both Capture and Classification functionality as it encounters each document, traversing and later updating Knowledge Graph 125 accordingly with the relationships it is able to discern at any given point in time. As noted above, the absence of predefined document templates in many scenarios presents a particularly difficult Classification problem—i.e., recognizing delineations among distinct documents. Here too, multiple iterations may be required to correctly Segment documents for Classification.

For example, consider a written page including two handwritten invoices, each containing a significant number of errors in field values and layout. Such errors may prevent Capture and Classification Engine 110 from properly Capturing and Segmenting the page initially, concluding that only a single invoice is present on the page, or perhaps that there is insufficient confidence to make a determination, in either case updating Knowledge Graph 125 accordingly.

Upon subsequent iterations with an updated Knowledge Graph 125, Capture and Classification Engine 110 has access to sufficient context to determine that two invoices are present on the page, and to identify corresponding fields and field values more accurately. For example, in the interim, Capture and Classification Engine 110 may have encountered two matching POs, enabling relevant fields in the two invoices to be captured more accurately and matched to their respective POs.

In a similar manner, Matching and Reconciliation Engine 120 performs the Matching and Reconciliation Tasks alluded to previously. As noted above, the existence of numerous different data fields increases exponentially the number of potential Mismatches. Whether or not Capture and Classification errors have been identified and/or corrected, Mismatches among data fields (both within and across documents) may well remain.

For example, a payment remittance document may or may not clearly indicate how a specified payment should be allocated among one or more invoices. As noted above, many-to-many relationships are often present—e.g., in which a single payment is intended to be Matched to multiple invoices, or a single invoice may be satisfied with multiple payments.

It should be noted that Matching and Reconciliation Engine 120 may not be able to extract all of these relationships initially. The amount specified on a payment remittance document may not correspond to the amount of any invoice (or invoices) previously encountered-α tentative Mismatch that, in one embodiment, is reflected in Knowledge Graph 125. Upon subsequent iterations, an updated Knowledge Graph 125 may provide Matching and Reconciliation Engine 120 with sufficient context to conclude that the payment was intended to be allocated to one or more invoices, or to a portion of a single invoice.

If, for example, the amount specified on the payment remittance document equals the sum of the amounts on two relevant invoices for which the payment was intended, no further Reconciliation may be necessary (except perhaps automatically notifying relevant human personnel). If, however, a Mismatch remains, then Matching and Reconciliation Engine 120 eventually may have sufficient context to determine that the amount specified on the payment remittance document (or on one or both invoices) was in error, in which case a corrective Action may be necessary.

In one embodiment, certain corrective Actions are completely resolved automatically (such as correcting an inaccurate payment amount) while others are addressed by notifying relevant personnel (e.g., an AP clerk) automatically that a corrective payment or refund is warranted. Whether or not humans are ultimately involved in performing follow-on corrective Actions, Matching and Reconciliation Engine 120 automatically identifies Mismatches and Reconciles them.

As noted above, Reconciling Mismatches often involves determining contextually whether there exist “good” or “bad” reasons or justifications for one or more Mismatches. For example, if a company has a “good” reason for paying a supplier a lower amount than was specified on a Matching invoice (e.g., due to the receipt of some defective units of a product), then Reconciliation may involve a simple corrective Action such as a subsequent notification of the reasons for the prior lower payment. But if the lower payment amount was due to a “bad” reason (e.g., the failure of the company to realize that the correct number of units arrived in two different shipments), then Reconciliation may involve a subsequent payment by the company for the difference.

Apart from Capture and Classification Engine 110 and Matching and Reconciliation Engine 120, additional Document-Processing TSAgents include Verification and Compliance Engine 122 and Coding Engine 124. As discussed above, Verification and Compliance Engine 122 employs Continual CSD to derive meaning within and across documents to validate discrepancies at various levels of abstraction (e.g., confirming that the value of a Tax ID is correct, despite it being in the correct format, or that component subtotals in certain documents add up to the total specified in another document).

In this embodiment, it also performs Compliance Tasks, such as ensuring Compliance with various legal and regulatory requirements. Here too, Continual CSD may be necessary to derive meaning from the context provided by multiple documents. Absent sufficient information to determine Compliance at any given time, Verification and Compliance Engine 122 updates Knowledge Graph 125, if only to reflect the future information required to complete its Task.

Similarly, Coding Engine 124 employs CSD to determine how to fill in (or correct) data fields relating to standard accounting codes or custom company-specific codes. Both Verification and Compliance Engine 122 and Coding Engine 124 may require further processing at a future time to complete their respective Tasks. Both similarly update Knowledge Graph 125 to reflect the information currently obtained, as well as, in one embodiment, missing information that may require human intervention or simply additional processing at a future time.

As noted above, detecting incorrect Codes may appear to be relatively simple on the surface. But when the format of a substantively incorrect Code is accurate, detection of such “hidden” errors becomes more complex, as it often requires contextual clues within and across documents (including external data sources and devices 197). Once again, subsequent iterations may be required before such context is unearthed and reflected in Knowledge Graph 125 in the form of new and modified relationships.

By employing Continual CSD to derive relationships, and traversing and updating Knowledge Graph 125 accordingly, the above-described Document Processing TSAgents eventually obtain sufficient context (e.g., during subsequent iterations) to detect and reconcile many Mismatches. In short, they derive meaning from context (including DDRs) to uncover the mystery behind one or more actual or potential errors or other anomalies, and respond by suggesting and/or implementing corrective Actions automatically.

It should be emphasized that, in one embodiment, Document-Processing TSAgents (and others discussed herein) are capable of employing Continual CSD to derive meaning from context by relying on machine-learning models trained to address a variety of situations common to a particular scenario. Such models are therefore capable of addressing a variety of issues (such as Capture, Classification, Matching, Reconciliation, Verification, Compliance and Coding, among others) that they have not specifically encountered before.

For example, Mismatches between the quantity of items in a PO and an invoice may be common to many scenarios. But distinguishing between an error in the invoice (e.g., a Capture or data entry error) and an incorrect assumption that the invoice corresponded to the PO (e.g., due to the fact that the actual corresponding invoice has yet to be processed by system 100) can be quite difficult, even for human clerks. As noted above, it is simply not feasible to devise rules in advance to address adequately these and a myriad of other related situations.

Yet, by training models on documents embodying similar situations, such models learn to make these difficult distinctions over time, even when presented with a specific situation never before encountered. Moreover, in the example above, even if Matching and Reconciliation Engine 120 initially made an incorrect assumption that the current invoice matches the PO (e.g., due to other similar field values between the PO and invoice), system 100 is capable of recognizing and addressing this mistake during subsequent iterations, in many cases due in large part to iteratively modified Knowledge Graph 125.

In other words, once the corresponding invoice was processed, Matching and Reconciliation Engine 120 updates Knowledge Graph 125 to reflect the newly derived relationships (both within the current invoice and across other previously processed documents and their component fields). These relationships include new relationships between the PO and the actual corresponding invoice, as well as modified relationships, such as the severing of relationships between the PO and the previously processed (non-corresponding) invoice.

In other embodiments, discussed in greater detail below, certain errors and other anomalies may not be detected by any of the Document-Processing TSAgents. In such cases, they may well be detected by a higher-level Anomaly Detector 135 and subsequently addressed by Anomaly Resolver 145.

In one embodiment, models are trained on sets of documents that reflect a particular type of anomaly. For example, “quantity mismatches” are a relatively common type of anomaly that occurs in a myriad of different ways. In simple cases, the quantity of items in a single PO should match the quantity of items reflected in a single invoice. In more complex cases, the cumulative quantity of items across multiple POs should match the quantity of items in a single invoice, or the quantity of items in a single PO should match the cumulative quantity of items across multiple invoices.

Anomalies may include various different data entry or Capture errors in the quantities specified in any of these documents, as well as errors in other fields that result in a mis-correlation of documents to the same transaction. In any event, models are trained to recognize patterns and detect various different “classes” of common anomaly types.

Moreover, because Knowledge Graph 125 is iteratively updated to reflect new and modified relationships among data across documents, Anomaly Detector 135 not only detects the presence of a particular type of anomaly (e.g., when presented with a specific set of documents that it has never previously encountered), it also identifies relevant metadata, such as the specific relationships involved.

For example, Anomaly Detector 135 may detect a quantity Mismatch among documents relating to a particular transaction, and may also (e.g., by traversing relationships in current Knowledge Graph 125) detect a specific Mismatch between a many-to-one quantity relationship between multiple POs and a single invoice, all relating to the transaction. It then updates Knowledge Graph 125 to reflect the existence of this anomaly specific to that many-to-one quantity relationship (and any other affected relationships) and notifies Scenario Controller 102 of this new Event.

Note that, in this example, the anomaly has yet to be resolved. For example, the Mismatch may be due to a data entry or Capture error in one of the POs or in the invoice itself. In one embodiment, the resolution of that anomaly is left to Anomaly Resolver 145 during subsequent iterations of system 100. In a manner similar to that of training Anomaly Detector 135, Anomaly Resolver 145 is trained on samples of sets of documents reflecting common anomaly resolutions.

For example, one common resolution may involve a correction to the quantity field of the invoice. Training of Anomaly Resolver 145 may well include many sample document sets in which that invoice quantity field is corrected. Similarly, other common resolutions may involve a correction to the quantity field in one of the POs.

In one embodiment, Anomaly Resolver 145 directs Scenario Controller 102 to reinvoke relevant TSAgents, such as Capture and Classification Engine 110 or Matching and Reconciliation Engine 120 to determine if such changes are warranted based on recent updates to Knowledge Graph 125. As a result, TSAgents may make appropriate corrections to relevant fields and reflect such corrections in updates to Knowledge Graph 125. Anomaly Resolver 145 then detects (during a subsequent iteration) that the anomaly has been resolved in a particular manner (e.g., by correcting the quantity field of the invoice), which it reflects in a further update to Knowledge Graph 125 for use by system 100 (which may, for example, notify users that this particular anomaly that was previously detected had been corrected).

In other embodiments, Anomaly Resolver 145 engages in hypothetical corrections (e.g., to different fields of the POs and invoice) before determining which correction (or combination of corrections) is warranted—i.e., which resolution of the anomaly is more likely. This process involves a similar process of reinvoking TSAgents, though with Knowledge Graph 125 reflecting the hypothetical nature of the relationship modifications.

In other situations, reinvocation of TSAgents may be unnecessary. For example, an anomaly may be resolved after a subsequent document is provided to system 100. Or it may be resolved by notifying human staff to contact a vendor for a correction (e.g., as opposed to correcting a Capture error automatically). In any event, as will be illustrated in various scenarios discussed in greater detail below, Anomaly Detector 135 and Anomaly Resolver 145 work together to detect and resolve anomalies on a continual basis over the course of one or more iterations of system 100.

At various points in time, Scenario Controller 102 employs Narrative Generator 150 to traverse the current state of Knowledge Graph 125 to perform particular Tasks. In one embodiment, at the end of each iteration, Narrative Generator 150 traverses Knowledge Graph 125 to generate a summary or “narrative story” of the state of the relevant transactions at that point in time. This narrative is iteratively regenerated over time as more and more information is processed by system 100.

In one embodiment, Narrative Generator 150 employs a large language model (LLM) to implement its narrative generation capabilities. In other embodiments, standard LLMs are enhanced with the ability to traverse Knowledge Graph 125 and utilize the derived relationships (including DDRs) as a substitute for “prompts” from which it generates its summary narrative.

After a few documents have been processed, the narrative may reflect only a few transactions—e.g., one PO to a first supplier on a particular date and time, followed by two other POs to a second supplier. Over time, as more documents are processed, the narrative expands to reflect the additional documents and other information system 100 has processed. This may include a summary of multiple transactions and the associated documents and entities involved, as well as items sent or received at particular dates and times.

Given the knowledge of the scenario's workflow by Scenario Controller 102, the narrative may also include decisions and component actions implemented by various personnel. Payments may have been received and statements or invoices may have been sent, along with interim authorizations by specified parties.

For example, the workflow may require approval of an invoice for payment based on the satisfaction of certain conditions reflected in recently updated Knowledge Graph 125 (such as receipt of the invoice and receipt of each item ordered on the relevant POs). Prior to those conditions being satisfied, the narrative may simply indicate that authorization for the payment is awaiting completion of those specific conditions.

Once Scenario Controller 102 determines that the conditions are satisfied (based on the state of the current narrative reflected in Knowledge Graph 125, as updated by Narrative Generator 150), Scenario Controller 102 generates an email to the relevant personnel requesting approval. In other embodiments, the specified workflow may permit the generation of an automated approval.

In one embodiment, upon determining that relevant workflow conditions are satisfied, Scenario Controller 102 invokes Decisioning Engine 175 to make “ultimate” Decisions (e.g., implementing an approved invoice payment, approving a loan, etc.) as well as various interim Actions along the way (e.g., interim approvals, notifications, etc.), as specified in the particular scenario's workflow.

In some embodiments, Decisioning Engine 175 also employs CSD to derive relationships (including DDRs) from the current state of Knowledge Graph 125. For example, a Decision or interim Action may depend upon making inferences not clearly determined by the scenario's workflow. Should an invoice be paid when some of the items were defective, or delivered late? Should a loan be approved despite the borrower's having made a few late payments in the past?

These subjective Decisions may necessitate human intervention or may be addressed by automated suggestions from Decisioning Engine 175 based upon its learned “experience” of handling similar situations during its training. While some of these inferences may qualify as anomalies detected by Anomaly Detector 135, others may be made by Decisioning Engine 175 (or perhaps both modules). Because the outcome is not strictly rules-based, different models may result in different outcomes based in large part upon their training.

In addition to the modules of system 100 that handle the iterative processing of documents and other information (including each scenarios specified workflow), other modules respond to Events generated by direct user interaction. For example, in one embodiment, Analytics Engine 180 processes natural language Analytics-oriented requests based upon the current state of Knowledge Graph 125.

Because users are not simply querying a database, far fewer restrictions exist on the nature and format of users requests. In one embodiment, LLMs enable Analytics Engine 180 to process natural language requests and answer unstructured free-form queries, such as calculating the average delivery time of various suppliers during particular months of the year for products Matching specified conditions. Analytics Engine 180 derives such information based upon specified constraints included in users' requests in part by traversing the current state of Knowledge Graph 125.

In other embodiments, Analytics Engine 180 also employs CSD to discern certain relationships (including DDRs) from Knowledge Graph 125. For example, certain products may be delivered late for various reasons. If most such late deliveries were caused by the company ordering the products, should suppliers be “penalized” in the form of higher late-delivery percentages?

Some of these subjective judgment calls are, in some embodiments, made automatically by Analytics Engine 180, while in others they are addressed via Narrative Generator 150, which summarizes and explain multiple different late-delivery percentages accompanied by explanations of typical reasons for certain types of late deliveries. The training of Analytics Engine 180 dictates in large part the “behavior” of Analytics Engine 180.

Similarly, users submit natural language queries to system 100 via Interrogation Engine 190. LLMs facilitate the interpretation of such queries and the formulation of responses by Interrogation Engine 190. Moreover, standard LLMs are enhanced to enable Interrogation Engine 190 to traverse Knowledge Graph 125 and utilize DDRs and other derived relationships to analyze queries and facilitate intelligent responses.

It should be noted that users of system 100 may include a myriad of affiliated individuals, companies and others. Users might be executives of a company, clerks in AR or AP departments, other employees in sales, marketing or other departments, well as third party affiliated companies and individuals.

For example, an AP clerk may ask whether the company has sufficient funds in a particular bank account to pay invoices due at the end of the month, or whether a transfer of funds from another account is warranted. While such a request might appear quite simple on the surface, traversal of Knowledge Graph 125 by Interrogation Engine 190 might reveal significant factors, such as the fact that certain invoices have yet to be approved or that others should have been received by now. Additional Actions may therefore be necessary.

Factors such as these may have taken the AP clerk a relatively long time to discern from the company's internal databases. Instead, system 100 (in particular Interrogation Engine 190) provides a virtually instantaneous response, along with additional information and/or proactive suggestions for further Actions. Moreover, Interrogation Engine 190 provides the opportunity for interactive conversations, including follow-up questions to clarify certain details and unearth additional relevant factors (i.e., stemming from DDRs and other relationships contained within Knowledge Graph 125).

Moreover, in one embodiment, Interrogation Engine 190 proactively generates conversational queries to users (e.g., asking whether an item should be included in a system-generated report, or whether an outstanding invoice should be escalated for prompt payment), as well as internally-generated system queries (e.g., a request for the balance of a bank account, which can be implemented without human interaction). In both cases, Interrogation Engine 190 obtains additional information to be processed by system 100 (i.e., as an alternative source of information as compared to processing new documents). Details of these and other user interactions with system 100 are discussed in greater detail below in the context of specific sample scenarios.

In other embodiments, Interrogation Engine 190 works together with Analytics Engine 180, Decisioning Engine 175 and other modules of system 100 to enable interactive conversations with users regarding general queries as well as those relating specifically to particular Analytics requests, Decisions and other aspects of the current scenario. In this manner, users interact with the virtual equivalent of an extremely knowledgeable and efficient human clerk.

Finally, Model Trainer 107 is employed by system 100 to provide an automated “self-learning” mechanism that modifies trained models in real time from live document data (not synthetic data) processed by system 100. It is important to distinguish this form of training from one which employs automatically generated “synthetic” training samples.

In one embodiment, when a “primary” trained model (processing actual live data) yields insufficient confidence levels to merit a result, Model Trainer 107 invokes multiple other models to process the same actual live data. It then employs a “voting” mechanism to determine the “winning” result among those generated by the other models—e.g., by selecting the result that garnered the highest confidence levels.

While different embodiments employ different voting algorithms to select the winner (e.g., majority vote, highest actual, average or median confidence level, etc.), the selected result will be utilized by system 100 to complete its current process (as if the original confidence level generated by the primary model was sufficient) and update Knowledge Graph 125. In other embodiments, Model Trainer 107 is employed not only with respect to Document-Processing Tasks performed by TSAgents, but also with respect to Higher-Level Tasks (Decisioning, Compliance, Analytics, interrogation, etc.) performed by TSAgents and other modules of system 100.

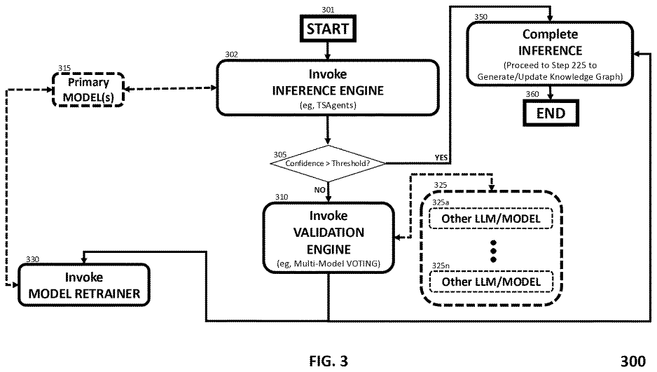

In addition to performing this voting functionality, Model Trainer 107 implements real-time self-learning by automatically retraining the primary model to reflect the ultimately selected result. As will be explained in greater detail with respect to FIG. 3 below, Model Trainer 107, in one embodiment, generates a template (filled with data reflecting one or more selected “winning” results) from which it retrains the primary model. It should be emphasized that this template mirrors the actual live data that was processed (e.g., by a TSAgent), as opposed to artificially-generated synthetic training samples.

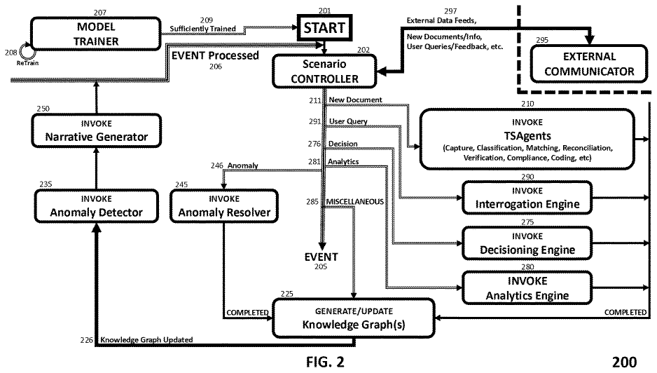

Turning to FIG. 2, diagram 200 illustrates one embodiment of a dynamic view of the functionality performed by the key modules of system 200 described above. In particular, process-level state/flow diagram 200 illustrates how Scenario Controller 202 responds to Events on a continual iterative basis over time, automatically invoking (or reinvoking) TSAgents and other modules to perform various Tasks at the appropriate time.

As will become apparent below, Scenario Controller 202 determines which Tasks are appropriate at any given time based not only on the scenario-specific workflow, but on the current state of Knowledge Graph 225, which reflects the various relationships among data (within and across documents and transactions) that system 200 has derived thus far.

For example, depending on the Event(s) being processed, Scenario Controller 202 will invoke or reinvoke particular TSAgents to process current documents and other data, detect and/or resolve anomalies and perform other higher-level functionality described in greater detail below. Upon performing these various Tasks, system 200 updates Knowledge Graph 225 to provide the various modules of system 200 with current information during the remainder of the present iteration, as well as during subsequent iterations.

Before system 200 “goes live” (see Start 201), Model Trainer 207 trains the various models (whether implemented as neural networks or other forms of supervised machine learning, or otherwise) in a manner well known in the art. Model Trainer 207 performs standard supervised training with various different types of training samples, as well as subsequent real-time “self-learning” retraining 208 (while system 200 is live), as alluded to above and described in greater detail below with respect to FIG. 3.

Once models are sufficiently trained 209, Scenario Controller 202 continually processes Events 205 on an iterative basis over time. As noted above, in one embodiment, various types of Events 205 include (among others) receipt or absence of new documents or other information, internally-generated and externally-generated natural language or other queries, passage of time, detection or resolution of anomalies, anticipation of expected future documents or other information, hypotheses of potential future conditions, updates to Knowledge Graphs, etc.

Many Events 205 arrive via External Communicator 295, which, in one embodiment, facilitates two-way communication of data 297 with the outside world (users, third-party systems, etc.). For example, such data 297 will often be in the form of new documents provided by users of system 200 for processing, initially by Scenario Controller 202. As noted above, documents are far more expansive than the characters and words found in typical paper or electronic documents or files. They include not only the locations of characters and words on a page and the structure of such data (e.g., in a database or spreadsheet file), but virtually any other medium, metadata or other attribute of information from which signal can be distinguished from noise to reveal meaning.

Upon detecting a New Document Event 211, Scenario Controller 202 invokes one or more Document-Processing TSAgents 210 to process that document. Such processing includes invocation of various such TSAgents 210 discussed above with respect to FIG. 1, including Capture and Classification Engine 110, Matching and Reconciliation Engine 120, Verification and Compliance Engine 122, Coding Engine 124, and others in other embodiments.

In one embodiment, the operation of system 200 is an asynchronous Event-driven process. For example, while Capture and Classification Engine 110 is processing the new document (in response to New Document Event 211), another Event 205 might arrive, such as a User Query Event 291. In that case, Scenario Controller 202 invokes Interrogation Engine 290 to interpret and address (e.g., respond to) the user query while Capture and Classification Engine 110 is simultaneously processing the new document in parallel.

In this manner, system 200 responds to multiple Events asynchronously over time, achieving significant improvements in efficiency. When system 200 detects interdependencies which prevent certain functionality from being performed simultaneously, it delays the processing of functionality until other dependent functionality is completed. For example, if Interrogation Engine 290 could not respond to a user query until a relevant document currently being processed by Capture and Classification Engine 110 had been Classified, then the operation of Interrogation Engine 290 would be suspended until such Classification was completed, even if that did not occur until a subsequent iteration of system 200.

It should therefore be noted that, in one embodiment, the processing of even a single document by TSAgents 210 might require one or more iterations of system 200 to complete. For example, more information may be required to resolve different aspects of processing a new document (Capture, Classification, Matching, etc.). Perhaps the value of a particular field of a document cannot be captured with sufficient confidence. In that case, once the processing of the new document has been otherwise completed, the TSAgents 210 will update Knowledge Graph 225 with the current results of that processing, including the uncertain nature of that particular field.

Moreover, subsequent documents or other information may require a reinvocation of one or more TSAgents 210 over time that may modify the prior results of processing that document. For example, upon processing a new document, Capture and Classification Engine 110 may determine that it actually contains two documents (e.g., two invoices).

In one embodiment, even after Classifying the two invoices and Capturing each of their component field values, it simply updates Knowledge Graph 225 and completes the current iteration. In other embodiments, additional TSAgents are invoked during the current iteration (e.g., Matching and Reconciliation Engine 120), which may be unable to Match either invoice to any corresponding PO(s) because such documents have yet to be processed by system 200. In any event, during any given iteration, once the TSAgents 210 have been invoked or reinvoked by Scenario Controller 202 and completed their processing, each will update Knowledge Graph 225 with newly derived or modified relationships or other changes.

In this manner, the order in which documents are presented to system 200 does not materially impact the nature of their processing. Even if a document cannot be “completely” processed at a given point in time due to a dependency on subsequent documents or other information being provided in the future, system 200 has the capability of reinvoking relevant TSAgents 210 to resolve such dependencies when it later discerns such information.

In one embodiment, system 200 also notifies relevant personnel of certain dependencies and, in some cases, requests specific information in an effort to resolve them. Such information may be provided by users of system 200 in the form of new documents or mere responses to such requests (via text, audio or other medium) which themselves effectively constitute “new documents.”

As alluded to above, in addition to New Document Events 211, Scenario Controller 202 also detects and processes other Events 205. For example, upon receiving a query from a user of system 200 (e.g., via External Communicator 295), Scenario Controller 202 detects the User Query Event 291 and invokes Interrogation Engine 290 to interpret and address that user query.

As noted above, in one embodiment, Interrogation Engine 290 employs trained LLM models to interpret user queries, with the additional capability of traversing the current state of Knowledge Graph 225 and interpreting them in the context of various relationships, including DDRs. Moreover, it also utilizes such context to determine how best to address user queries.

For example, once appropriately interpreted, a user query might directly or indirectly request not only the retrieval of certain information (such as invoices matching specified criteria), but also the performance of certain actions, such as correcting a specific data field value, reconciling data across multiple documents, etc. In such cases, Interrogation Engine 290 formulates responses to the user query and updates Knowledge Graph 225 accordingly. As a result, Scenario Controller 202 may invoke or reinvoke other Document-Processing TSAgents 210 (or other modules) during the current or future iterations of system 200.

As noted above, in one embodiment, user queries involve two-way interactive conversations between system 200 and its users. Such conversations often occur across multiple iterations of system 200, and result in the performance of a myriad of different actions, which Scenario Controller 202 implements by invoking or reinvoking Document-Processing TSAgents 210 as well as other higher-level modules of system 200.

As system 200 processes documents and performs various other actions over time, Scenario Controller 202 utilizes the current state of Knowledge Graph 225 to invoke (as well as detect) certain Events 205. For example, in one embodiment, Scenario Controller 202 integrates the scenario-specific workflow into Knowledge Graph 225. In other embodiments, this workflow is maintained separately.

In either case, Scenario Controller 202 utilizes this current “state” of system 200 to determine when the scenario-specific workflow dictates that particular decisions are warranted—i.e., that specified interim actions have been completed and other conditions have been satisfied. For example, the scenario-specific workflow may require the approval of particular personnel before an invoice can be paid or a car loan can be approved.

Once all such conditions have been satisfied, Scenario Controller 202 generates a Decision Event 276 and invokes Decisioning Engine 275. At that point, in one embodiment, Decisioning Engine 275 implements the Decision by causing specified Actions to occur in accordance with the scenario-specific workflow and the current state of Knowledge Graph 225.

For example, in a relatively straightforward case, it may generate a Miscellaneous Event 285 (and update Knowledge Graph 225 accordingly) that will cause Scenario Controller 202, on a subsequent iteration, to notify specified personnel that a car loan had been approved, and perhaps even generate the approval notice to be sent to the applicant. In other embodiments, certain Tasks are implemented by human staff, while others are performed automatically in response to system-generated Events 205, by various other modules of system 200.

As noted above, in some embodiments, Decisioning Engine 275 employs CSD to discern relationships (including DDRs) from the current state of Knowledge Graph 225, which may cause certain Actions to be taken in connection with the Decision. For example, even after approving a car loan, system 200 may initiate a subsequent stage of the scenario-specific workflow, in which loan documents must be signed, automatic loan payments must be set up with the applicant's bank, etc. Moreover, as noted above, certain subjective Decisions may be delegated to human staff, or may be addressed via automated suggestions initiated by Decisioning Engine 175 based upon its learned experience of handling similar situations during its training.

Scenario Controller 202 also initiates Analytics Events 281 in response to analytics requests from users of system 200. Although Analytics requests from users are, in essence, a subset of user queries, Scenario Controller 202 invokes Analytics Engine 280, a module that is specifically trained to implement Analytics-related requests.

For example, in addition to interpreting natural-language prompts and traversing Knowledge Graph 225 (e.g., via modified LLM-based models), Analytics Engine 280 is trained to perform various Analytics-based functions, such as applying a myriad of statistical functions with specified constraints to data relationships derived from Knowledge Graph 225. In one embodiment, employing CSD enables Analytics Engine 280 to make inferences beyond those typically discernible from traditional databases.

For example, as noted above, data relating to various late deliveries may be available in Knowledge Graph 225. But whether particular late deliveries were justified requires a much more complex analysis, including inferences enabled by the training of Analytics Engine 280 with respect to various similar situations. In another example, Analytics Engine 280 could discern that a particular supplier tends to make mistakes in item quantities regarding particular products, and suggest that another supplier be employed for future orders of those products.

In essence, Analytics Engine 280 “behaves” (based on its training) in a manner that enables it to implement a myriad of Analytics-based user requests specifically tailored to the data of which it is aware (embodied in the current state of Knowledge Graph 225). Moreover, it provides natural-language responses explaining the results of such requests, included detailed factual support data (names, dates, entities and various other relevant metadata) that system 200 has processed thus far.

Note that all of this functionality is performed asynchronously on an Event-driven basis by system 200 while it is simultaneously handling the processing of documents and implementing various other higher-level functions. As a result, users experience an integrated system 200 that employs different trained models as needed to perform such functions.

In other embodiments, various other Miscellaneous Events 285 are initiated by Scenario Controller 202, and handled in a similar manner by other general-purpose or specifically trained models. To the extent the handling of such Miscellaneous Events 285 results in the generation of new or modified relationships, such changes are reflected in updates to Knowledge Graph 225 for use during subsequent iterations of system 200.

As described above, a particularly unusual and effective function of system 200 involves detecting and addressing (and in some cases resolving) anomalies. In one embodiment, during each iteration, after completing a specific Event-driven document-processing or other higher-level function in response to one or more Events 205, and updating Knowledge Graph 225 (reflected by a Knowledge Graph Updated Event 226), system 200 invokes Anomaly Detector 235 to traverse the current Knowledge Graph 225 in search of anomalies.

In one embodiment, when an anomaly is detected by Anomaly Detector 235, it updates Knowledge Graph 225 with the details and other relevant metadata relating to the anomaly. In other embodiments, it provides such metadata directly to Scenario Controller 202. In either case, on the next iteration of system 200, Scenario Controller 202 issues an Anomaly Event 246 and invokes Anomaly Resolver 245 to address the anomaly.

In the embodiment illustrated in FIG. 2, Anomaly Detector 235 is employed toward the end of each iteration of system 200 (when Knowledge Graph 225 has been updated and issues a Knowledge Graph Updated Event 226). This enables system 200 to detect anomalies based on all currently known data, with the resolution of any detected anomalies occurring during subsequent iterations of system 200.

As noted above, Anomaly Detector 235 includes one or more models trained on sets of documents reflecting various different types of anomalies. For example, in one embodiment, such anomaly types include pricing anomalies (e.g., pricing errors, overpricing, unauthorized discounts, etc.), quantity anomalies (e.g., unauthorized orders based on item quantities, mismatches between POs and invoices, etc.), vendor fraud, contractual deviations, discrepancies in invoicing and payments, approval discrepancies, violations of laws or internal company rules, procurement delays (missed deadlines, poor supplier performance, etc.), unexpected changes in market conditions and supply chains, etc. In other embodiments, various other anomaly types are included in the training of Anomaly Detector 235 models.

As noted above, such training includes scenarios in which anomalies include DDRs both within and across documents. By analyzing such complex inter-document relationships reflected in Knowledge Graph 225, Anomaly Detector 235 detects discrepancies across documents that It has never encountered before—i.e., based on its training on similar discrepancy scenarios, which enables it to learn to recognize similar patterns within various classes of common anomaly types.

Moreover, by traversing relationships reflected within Knowledge Graph 225, Anomaly Detector 235 not only detects the presence of a particular type of anomaly, but also identifies relevant metadata regarding specific relationships (e.g., many-to-many relationships between an invoice and multiple POs, correlating to a mismatch among quantity items). It then updates Knowledge Graph 225 to reflect the anomaly and such relevant metadata (or, in other embodiments, provides such information directly to Scenario Controller 202) for use in resolving detected anomalies during subsequent iterations of system 200.

During a subsequent iteration of system 200, Scenario Controller 202 issues an Anomaly Event 246 and invokes Anomaly Resolver 245 to address the anomaly (based on its training with respect to common resolutions of various different types of anomalies). As noted above, Anomaly Resolver 245 resolves certain anomalies simply and automatically without human intervention (e.g., correcting a faulty error in a data field, whether due to a Capture or data entry error), while other anomalies require a more complex resolution.

For example, as noted above, certain anomalies require the issuance of another Event 205 relating to the anomaly, such as directing Scenario Controller 202 to reinvoke relevant TSAgents (such as Capture and Classification Engine 110 or Matching and Reconciliation Engine 120) to determine if such corrections or other changes are warranted based on recent updates to Knowledge Graph 225. In other cases, Anomaly Resolver 245 initiates hypothetical resolutions to determine which resolution is most warranted.

In any event, upon resolving actual anomalies, Anomaly Resolver 245 directs Scenario Controller 202 to notify relevant users of system 200 (in accordance with the scenario-specific workflow) how the anomaly was resolved. In still other cases, Anomaly Resolver 245 suggests one or more potential courses of action to relevant users of system 200, and leaves it to them to further implement the resolution of such anomalies.

As noted above, Anomaly Detector 235 and Anomaly Resolver 245 effectively work together to detect and resolve anomalies on a continual basis over the course of one or more iterations of system 200. Document-Processing TSAgents 210 and other modules of system 200 are also employed when warranted to facilitate both the detection and resolution of anomalies. Various specific scenarios illustrating some of the myriad of different circumstances in which anomalies are detected and resolved by system 200 are discussed in greater detail below.

In one embodiment, prior to completion of each iteration of system 200, Narrative Generator 250 is invoked following the completion of Anomaly Detector 235, whether or not an anomaly has been detected. In the vast majority of iterations, no anomaly will have been detected. Nevertheless, Narrative Generator 250 is employed primarily to summarize in a natural language format (for use both internally by system 200 and externally by relevant users) the narrative story of the state of the relevant transactions processed by system 200 up to that point in time.

It should be noted that this narrative story will be refined (i.e., iteratively regenerated) continually over time as system 200 processes additional information. Ultimately, it will include a summary of multiple transactions, including relevant aspects of their associated documents and entities, as well as items sent or received on particular dates and times, payments made, Decisions and component Actions performed, interim authorizations, etc.

As noted above, summaries may reflect that certain Decisions or component Actions are awaiting authorization or satisfaction of other specified conditions, or that expected documents have yet to be processed by system 200. In one embodiment, configurations of system 200 will determine the level of detail incorporated in such narrative summaries.

The narrative story generated by Narrative Generator 250 at the end of each iteration of system 200 is employed by Scenario Controller 202 in many instances to provide updates, responses and other feedback to users of system 200. In other instances, Scenario Controller 202 utilizes the narrative story (in addition to the current state of Knowledge Graph 202 and the scenario-specific workflow) for the purpose of determining which Events 205 to initiate and which Actions to perform during its current iteration.

The operation of Narrative Generator 250 as well as the above-described modules of system 200 will be better understood in the context of specific scenarios discussed in greater detail below. Before exploring such specific scenarios, the dynamic operation of the real-time validation engine and self-learning process illustrated in flowchart 300 of FIG. 3 will be discussed.

Flowchart 300 of FIG. 3 provides an illustration of this dynamic real-time validation and self-learning process. It should be noted that this process occurs whenever the primary trained models employed by system 200 (Document-Processing TSAgents 210 as well as other higher-level modules, including other TSAgents) at “inference time” generate results exhibiting confidence levels below predefined (or dynamically-generated) thresholds.

In other words, the key purpose of the process illustrated in flowchart 300 is twofold. One key objective is to complete the real-time functionality corresponding to the current inferences. In one embodiment, this functionality includes processing documents, interpreting and responding to user queries and Analytics requests, initiating Decisions or component Actions dictated by the scenario-specific workflow, detecting and resolving anomalies, etc.

Another key objective of the process illustrated in flowchart 300 is to automatically enhance the training of such primary inference models in real time based upon actual data being processed (as opposed to synthetically generating training samples). In other words, this “self training” is performed in real time without materially delaying the operation of system 200, unlike the significant delay that would result from standard retraining of models with synthetic or other training samples.

As a result, system 200 completes its current processing functionality, despite insufficient confidence levels in its primary models to merit generation of a conclusion. Moreover, it enhances the training of such primary models, based upon the actual data currently being processed (which resulted in insufficient confidence levels), thereby enabling such primary models to be retrained in real time for use during subsequent iterations of system 200.

Starting at step 301 when the primary models are invoked at inference time (in step 302), such models typically generate results that exceed predefined thresholds (in step 305), enabling such primary models to complete their designated functions (in step 350) and update Knowledge Graph 225 accordingly. In such cases, no real-time validation or self learning is necessary, and the process ends at step 360.

For example, as illustrated in the context of a New Document Event 211 in FIG. 2, TSAgents 210 perform various Document-Processing Tasks (Capture, Classification, Matching, Reconciliation, Verification, Compliance, Coding, etc.) successfully before updating Knowledge Graph 225). In other words, the Capture and Classification process performed by Capture and Classification Engine 110 yields conclusions regarding document types, component field values, etc.

But, in the event that any such conclusion (e.g., the Classification of the current document into a document type, or the value of a particular captured component field) cannot be reached, due to an insufficient confidence level of the primary Capture and Classification Engine 110 model (i.e., a confidence level below a predefined threshold), then the process could not be completed in the normal fashion.

In other words, if Capture and Classification Engine 110 is unsure as to which type of document it is processing, or what is the captured amount of an invoice (because none of the available choices can be selected with sufficient confidence), then one alternative is to reflect that lack of certainty in Knowledge Graph 225 and continue to a subsequent iteration of system 200. The same could be true of other Document-Processing TSAgents 210.

But, in one embodiment, instead of waiting for additional documents or other information provided during subsequent iterations of system 200, Validation Engine 310 of Model Trainer 207 is invoked in real time. In this embodiment, Validation Engine 310 employs a multi-model voting system that processes the same data provided, for example, to the primary model of Capture and Classification Engine 110, but using multiple other models trained to perform similar Capture and Classification functionality.

Validation Engine 310 selects a conclusion based, for example, upon the “majority vote” of these other models 325 (including LLM or other models 325a-325n). In other embodiments, different algorithms are employed to determine the “winner” of the vote. In still other embodiments, the winner is determined by delegating the resolution to human personnel, or voting among less expensive alternative models 325.

In any case, the result is the same. In other words, the winning result (e.g., document type is “invoice” or the value of the “amount” field of the invoice is $100, etc.) is selected and included in updated Knowledge Graph 225 as if that result had been generated by the primary model of Capture and Classification Engine 110. In other embodiments, Model Trainer 207 is employed not only with respect to Document-Processing Tasks performed by TSAgents 210, but also with respect to Higher-Level Tasks (Decisioning, Compliance, Analytics, Interrogation, anomaly detection and resolution, etc.).

Having selected the winning result, that result is employed by the module (e.g., Capture and Classification Engine 110) to complete its inference (at step 350). Having achieved only one of the key objectives of this process, Model Retrainer 330 (of Model Trainer 207) is also invoked to update the primary model in an effort to avoid similar problems during future iterations.

In other words, by utilizing the actual data that generated insufficient confidence levels as a basis for retraining this primary model, this retrained primary model is more likely to yield a conclusion with sufficient confidence when presented with data exhibiting similar issues during future iterations of system 200.

In one embodiment, Model Retrainer 330 utilizes the actual data to generate a “training document template” in the form of a JSON file with automated annotations including a document type, labeled field values and identifiers reflecting the location of bounding boxes for each component field. It then employs this training document template to retrain the primary models 315 for use during subsequent iterations of system 200.

In this manner, Model Trainer 207 achieves its dual objectives of completing the real-time functionality corresponding to current inferences of primary models (despite initial failures to reach conclusions with sufficient confidence) and automatically retraining such primary models based upon the actual data they just processed in an effort to avoid similar issues during subsequent iterations of system 200. Moreover, it achieves these dual objectives substantially in real time without materially delaying the operation of system 200.

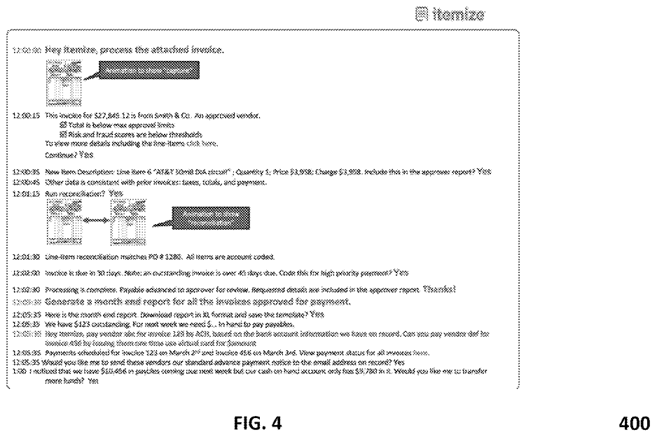

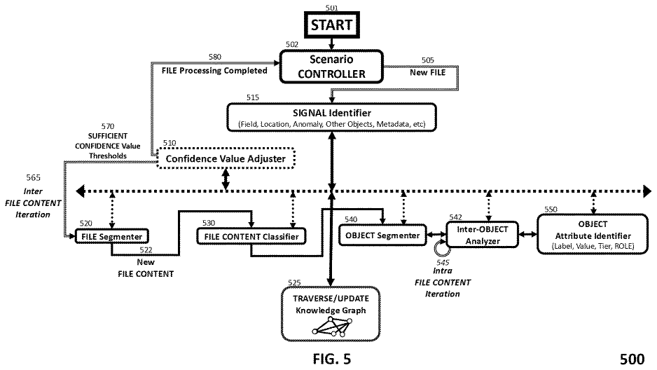

Before exploring specific scenarios to illustrate the static components and dynamic operations of key modules of system 200 (including an interactive user scenario, illustrated in screenshot 400 of FIG. 4), a more detailed discussion of the simultaneous use of Signal by such modules (illustrated in diagram 500 of FIG. 5) will be helpful to appreciate the parallel-processing nature of the present invention.

Dynamic process-level state/flow diagram 500 of FIG. 5 provides a more specific illustration of the manner in which system 200 processes files over time. In particular, while it continually identifies Signal within the current file, it provides that Signal to various key modules that perform specific Tasks simultaneously. These Tasks include Segmenting the file into individual documents, fields and other component objects, as well as identifying various component attributes, such as the “role” or meaning of individual fields. In this manner, various Tasks are performed in parallel, including traversing and updating Knowledge Graph 525 to facilitate the performance of such Tasks.

Starting at step 501, Scenario Controller 502 manages the overall logistics of this continual Event-driven process, as discussed above with reference to FIGS. 1 and 2. While this includes (based in part upon the current state of Knowledge Graph 525) identifying and invoking Events, as well as determining when and to what extent to trigger TSAgent Document Processing and Higher-Level Tasks, FIG. 5 illustrates in greater detail the internal operation of system 500 while processing a discrete file 505.

As noted above, file 505 includes virtually any collection of information, from a portion of a single page of a document to a collection of documents, regardless of medium (handwritten, electronic, text, image, audio, video, structured or unstructured data, etc.—even a zip file or other collection of files). Upon receiving file 505, Scenario Controller 502 relies on Signal Identifier 515 to implement the many aspects of its functionality.

While Scenario Controller 502 has access to the scenario-specific workflow, as well as the current state of Knowledge Graph 525, which inform its decision to invoke a particular Event or Task, it employs Signal Identifier 515 on a continual basis to identify and provide Signal to various key modules that will respond to such Events and implement such Tasks. For example, upon detecting the format of a zip file, that information (Signal) may be ignored by other modules, but utilized by File Segmenter 520 to extract a set of multiple files. If one of those files is determined to be a document, and further Classified as a PO, Signal Identifier 515 continually processes that PO for additional Signal (e.g., a reference to a particular Transaction ID field matching a similar field in a different previously processed PO).

In other words, what FIG. 5 illustrates is that multiple different modules are operating in parallel on a continual basis using Knowledge Graph 525 as the glue that holds them together. While various TSAgents (not all shown in FIG. 5) are performing Document-Processing (Capture and Classification, Matching and Reconciliation, Verification and Compliance, Coding, etc.) and Higher-Level Tasks (Decisioning, Compliance, interrogation, Analytics, etc.), Signal Identifier 515 is continually searching for Signal (e.g., traversing Knowledge Graph 525 as it is updated by other modules) and providing that Signal to other modules to facilitate their performance of their Tasks. In this manner, these modules operate simultaneously (in parallel), gradually identifying and extracting more (otherwise hidden) context from which meaning is derived.

It should be noted that Signal Identifier 515 is not limited to discrete documents, fields or other objects, but also identifies signal across various Tiers (i.e., across fields and other objects, documents, transactions, etc.). For example, Signal Identifier 515 may identify the relative location of different fields on a page or a similar string of characters (phrase, date format, etc.) found in other documents or transactions, a stain obscuring a particular portion of a page, or a myriad of other artifacts that may facilitate another module's analysis of a document and performance of its particular Task.

While Signal Identifier 515 may not be able to discern the potential relevance of any particular Signal, it provides such Signal (e.g., via updates to Knowledge Graph 525) to other modules that may find such Signal relevant to the performance of its own particular Tasks (e.g., Classifying a document, identifying an anomaly, Matching and Reconciling one or more discrepancies, determining the role of an individual field, etc.). In other words, these various modules operate on the same or different portions of a file simultaneously, and each selectively utilizes relevant Signal to traverse and update Knowledge Graph 525 for their mutual benefit.

For example, one module may be Classifying a document, while another module is analyzing individual fields within one page of that document, and yet another module is determining the role of a particular field (perhaps on another page of that document). As a result, system 500 determines, iteratively over time, the roles of the relevant fields across documents and files, and also makes relevant Decisions and performs other related Tasks, all in accordance with the scenario-specific workflow.

While each of these modules performs its respective Task (based in part upon the current state of Knowledge Graph 525, which it later updates), Confidence Value Adjuster 510 continually adjusts “confidence values” (aka confidence levels) with respect to each inference-time Decision of system 500. Such Decisions run the gamut from file segmentation (e.g., where does one document end and another begin) to document Classification (e.g., PO, Invoice, ASN, etc.) to field or other object Segmentation (e.g., is a string of characters a single product description, or multiple fields including a product description, color and type) to various field attributes (label, value, Tier, semantic role, etc.).

Ultimately, system 500 reaches “final” Decisions on these issues, which are reflected in Knowledge Graph 525, and used by other modules. For example, Interrogation Engine 290, in order to respond to a User Query 291 (e.g., asking for the sum of the invoices due this month from a particular group of vendors) relies on Knowledge Graph 525 to include the relevant invoice totals, which may themselves be calculated from other fields. Similarly, Decisioning Engine 275 employs Knowledge Graph 525 to determine whether sufficient prerequisite conditions have been met to make a Decision, such as paying a particular invoice.

In one embodiment, each component item is subject to a predefined threshold confidence value 570 (e.g., 90% confidence), with specific thresholds varying across different types of information in accordance with the scenario-specific workflow. During the course of processing files (including component file content, documents, fields and other objects, and their various attributes), these confidence values change frequently, as individual modules endeavor to derive meaning from context based on Signal identified by Signal Identifier 515.

In one respect, no Decision is ever truly “final” in that it may be altered by future processing of various modules. But, in this embodiment, thresholds are employed to indicate that any particular Decision is “sufficiently final” to be utilized by other modules of system 500. Once these thresholds are reached with respect to all Decisions within the current file, the processing of that file is deemed completed 580 so that Scenario Controller 502 can initiate processing of the next file.

In another embodiment, multiple files are processed simultaneously even though confidence value thresholds have not yet been met. In either event, system 500 documents these levels of uncertainty in Knowledge Graph 525, so that other modules may take this into account before relying on them.

It should be noted that, during the processing of a file, Confidence Value Adjuster 510 reflects the gradual increase in certainty (despite interim “ups and downs”) that naturally occurs as Signal is processed by the various modules of system 500. In essence, the various attributes of fields and other objects are gradually being derived, in many cases without the need for human intervention. Even when certain confidence values remain below predefined thresholds, indicating that such intervention may be warranted, Confidence Value Adjuster 510 facilitates the identification of such circumstances, enabling Scenario Controller 502 to seek such human intervention from appropriate personnel (based on Knowledge Graph 525 and the scenario-specific workflow).

Once processing of the current file is initiated, it will generally be the case that sufficient predefined threshold confidence values 570 have not been reached, and that processing continues. One of the first steps of this process, characterized in FIG. 5 as Inter-File Content Iteration 565, involves File Segmenter 520.

In one embodiment, File Segmenter 520 is responsible for continually Segmenting the current file into its component pieces of file content. For example, upon determining where “document 1 ends and document 2 begins,” it will continue to Segment the current file into other discrete documents until sufficient predefined threshold confidence values 570 have been reached for all such Segmentations of the current file. But, it should be noted that File Segmenter 520 may revisit this Segmentation of documents 1 and 2 (e.g., due to a low confidence value and other updates to Knowledge Graph 525) until such time that a predefined threshold with respect to this particular Segmentation of documents 1 and 2 is reached.

While most of our discussion relates to collections of financial documents, files can of course contain other components, such as spreadsheets, databases, HTML web pages, or other types of structured documents including context from which meaning can be derived. Moreover, consider an audio file containing a one-hour comedy skit including component Segments on various different topics, or a video file of an NBA basketball game including four quarters, and many individual plays made by various players from two different teams, with a running score throughout the game. Regardless of the scenario, the overall Task of identifying Signal and deriving meaning from context remains the same.

Returning to scenarios involving financial documents, File Segmenter 520 continually Segments the current file into individual pieces of file content 522 (i.e., discrete documents) for Classification by File Content Classifier 530. As noted above, File Segmenter 520 traverses Knowledge Graph 525 to provide the context of prior processing by system 500, such as previously processed documents and their relationships among suppliers, vendors, products, etc.

Moreover, as alluded to above, while File Segmenter 520 is identifying discrete documents, an updated Knowledge Graph 525 (e.g., resulting from downstream processing of some of those documents) may facilitate the Task of File Segmenter 520 in determining where its most recent document ends and the next document begins. For example, it may see 5 pages of what appears to be an incomplete document with no title or other obvious heading. But Knowledge Graph 525 reveals that the prior document references many of the items in the 5 pages, and refers to these items as “Appendix A” to that prior document. In other words, it provides the context that, along with other information, enables File Segmenter 520 to determine that these 5 pages belong to that prior document (as Appendix A), and that the next document begins after these 5 pages.

As will be illustrated below, each of the modules of system 500 benefits from the simultaneous processing of different aspects of a file (or even across files) by virtue of their traversal and updating of Knowledge Graph 525. As File Segmenter 520 continually Segments the current file and provides each new piece of file content 522 (e.g., a document) to File Content Classifier 530 for file Classification, File Content Classifier 530 implements a similar process to Classify each document into one of a set of predefined file types. File Content Classifier 530 also traverses current Knowledge Graph 525 to facilitate its Task, benefitting from prior processing of documents (e.g., identifying similar collections of fields and their attributes for given document types).

Having Segmented and Classified a discrete document, other modules of system 500 proceed to identify document components (e.g., fields and other objects). Note that File Segmenter 520 continues to Segment the current file being processed (e.g., into multiple discrete documents) while the components of each such document are being processed.

Object Segmenter 540 segments each document (or other piece of file content) into discrete fields or other component objects. It processes each such document (whether in the form of a single or multiple-page image, structured text, or otherwise), and identifies discrete fields or other objects based on location within the document, proximity to other fields or objects, character format and content, etc.

It should be noted that, in one embodiment, the Task of Object Segmenter 540 is not to determine individual attributes of a field (e.g., identifying whether it is a field label or field value, as well as its semantic role or meaning), but simply to Segment one field from another. In some cases, this Task initially may be difficult (e.g., when a string of characters appears to be a single uniform field, but is actually composed of multiple fields concatenated together). In such cases, Object Segmenter 540 works together with other modules in an iterative fashion.

For example, consider a simple string identifying both a product ID and its color concatenated together. Object Segmenter 540 may initially conclude that the string represents a single field, representing this tentative conclusion in Knowledge Graph 525 with an associated confidence value. As the document is further analyzed by other modules (discussed below), the semantic distinctions between “product ID” and “product color” fields may become evident, and also be represented in Knowledge Graph 525. Upon being reinvoked (e.g., due to an update to Knowledge Graph 525), Object Segmenter 540 now Segments this string of characters into two distinct fields.

In other instances, Object Segmenter 540 may determine that a particular Signal (e.g., a discoloration due to a coffee stain) does not actually represent a discrete field or other object, a detail that is also represented in Knowledge Graph 525. If the coffee stain actually obscures one or more other fields, such “hidden” fields may be discernible by other modules. For example, certain characters of an obscured field (or certain portions of multiple obscured fields) may be more recognizable than others. Subsequent semantic analyses of these fields, including their proximity to one another, may facilitate identification of their attributes. Moreover, a subsequent reinvocation of Object Segmenter 540 may even facilitate their identification as multiple discrete fields (despite the difficulty of doing so initially due to their being obscured by the coffee stain).

As Object Segmenter 540 identifies discrete fields or other objects, and updates Knowledge Graph 525 accordingly), Inter-Object Analyzer 542 further analyzes the relationships between and among these discrete fields and other objects. We characterize this process as Intra-File Content Iteration 545, as it reflects the analysis within a particular document or other piece of file content. It should be noted, however, that the analysis within a piece of file content (e.g., fields on a single page of a document) may well benefit from analyses of other portions of that document, or even from other documents or files. This is enabled in part by the traversal and updating of Knowledge Graph 525, and the reinvocation of particular Tasks (e.g., when individual confidence values remain below predefined thresholds).

For example, consider a current document whose fields are difficult to discern due to handwritten text and stains that obscure portions of fields. Without the benefit of Knowledge Graph 525, Object Segmenter 540 might encounter difficulty even in deciding whether an obscured area of the document or a fragment of text is a single field or multiple fields. Moreover, Inter-Object Analyzer 542 might face similar difficulties in identifying field attributes. Is the fragment “Amount . . . ” an “Amount Due” field label or an “Amount Billed” label. Yet, with the benefit of Knowledge Graph 525, similarly structured pages may well reveal the likely organization and meanings of these fields with much greater confidence. In short, even when the current analysis is focused on a particular document or page of a document, past analyses of other documents (or even other files) may well facilitate this current analysis.

Moreover, while Object Segmenter 540 focuses on identifying individual fields or other objects, Inter-Object Analyzer 542 may reveal information (represented in Knowledge Graph 525) that modifies an initial conclusion of Object Segmenter 540 regarding the Segmentation of the fields or other objects within a current document or other piece of file content. In this manner, these processes operate in parallel, with continual reinvocations as warranted (e.g., based on confidence values remaining below predefined thresholds).

Similarly, Object Attribute Identifier 550 also works in parallel with other modules of system 500 to identify specific attributes of a field. For example, Inter-Object Analyzer 542 may determine that a particular field label (“Item Descriptions”) acts essentially as a column header beneath which are rows of specific descriptions of individual items. This conclusion may be reinforced by proximate column headers (e.g., “Product ID”) beneath which are rows of characters that appear to be product identifiers. In this regard, Object Attribute Identifier 550 will associate in Knowledge Graph 525 the “Item Descriptions” field label with each row of values (i.e., specific item descriptions).

In one embodiment, Object Attribute Identifier 550 also assigns other attributes, such as the Tier of the label and value fields. For example, they may be categorized as “field level” Tiers, as opposed to “document level” (e.g., invoice total) or “transaction level” (e.g., based on a “transaction ID” field) Tiers.

Moreover, the semantic role or meaning of a field may be represented in Knowledge Graph 525 to account for the various different terminology employed by companies in describing fields. For example, the label “Item Descriptions” may appear on various POs or Invoices, while other similar documents (e.g., from a different vendor) may use the term “Product Descriptions,” “Items,” “Descriptions” or even “Details of Goods.”

It is of great importance that differing terminology ultimately be normalized in Knowledge Graph 525 to facilitate identification of similar relationships. As these various modules of system 500 populate Knowledge Graph 525 with relationships among particular entities (e.g., fields and other objects) and associated confidence values, Inter-Object Analyzer 542 and Object Attribute Identifier 550 effectively work together to perform this normalization. At one point in time, differing terminology may be represented as different relationships. But, over time, the similarity of these relationships, coupled with relative confidence values, results in an equilibrium in which a normalized term (or role) for a particular field will be employed in Knowledge Graph 525 for multiple similar relationships, despite the use of differing terminology across various fields, documents, transactions and files.

As alluded to above, Confidence Value Adjuster 510 frequently modifies various confidence values (e.g., associated with individual fields, documents and their attributes) based on the results of processing by individual modules of system 500. These confidence values, relative to predefined thresholds, are employed by these modules to determine when such modules are reinvoked (e.g., to reprocess a field, document or portion thereof due to a change in circumstances, such an update to Knowledge Graph 525).

In one embodiment, once all such confidence values have reached their associated predefined thresholds 570 for a particular document or other piece of file content, File Segmenter 520 stops Segmenting the current document and proceeds to resegment the current file with respect to the “subsequent” documents. In another embodiment, File Segmenter 520 Segments the current file continually, and only stops when the confidence values with respect to all documents in the file have reached their respective predefined thresholds.

In either event, once all confidence values have reached their respective predefined thresholds 570 for all documents in the current file, the processing of that file is deemed complete 580, and Scenario Controller 502 processes the next available file 505, invoking Signal Identifier 515 to begin identifying various types of Signal within that new file 505. In another embodiment, this processing of multiple files is also performed in parallel (without waiting for the processing of the prior file to be complete).

The degree of parallelism employed with respect to the processing of files, documents, fields and other objects is a result of design and engineering tradeoffs that do not represent a departure from the spirit of the present invention. As emphasized above, the traversal and updating of Knowledge Graph 525 by the various modules of system 500 enables a significant degree of parallelism and reinvocation of such modules when warranted.

Finally, it should be noted that, while FIG. 5 does not explicitly illustrate all of the TSAgents 210 and other Document-Processing and higher-level modules shown in FIG. 2, these modules are employed in various embodiments to implement particular scenario-specific workflows. The particular Tasks performed by such modules may differ, but the principle remains the same, including the traversal of Knowledge Graph 525, the use of Signal and Continual CSD to derive meaning from context, and finally the updating of Knowledge Graph 525 to reflect DDRs and other relationships for the benefit of other modules.

As noted above, a Workflow Task refers to a Higher-Level Task that involves Actions and Decisions within a scenario-specific workflow, including without limitation authorizations, approvals, payments, loan and claim adjudications, compliance determinations, and the component interim Actions upon which such Decisions depend. As also noted above, Agentic Workflow refers to the automated performance of one or more Workflow Tasks—as distinguished from the passive generation of a response to a prompt (e.g., by an LLM-based chatbot).

Automated systems have performed Workflow Tasks in various ways, including through predefined, rules-based workflows in which Actions and Decisions are governed by static, predetermined criteria. The present invention, however, is directed to the performance of Workflow Tasks through Continual CSD and Relationship Persistence.

In some embodiments discussed above, Context-Derived Conditioning is employed to condition the performance of a particular Workflow Task upon one or more conditions that are reflected in (and derived via CSD from) the current state of the Knowledge Graphs. In such embodiments, the present invention traverses the Knowledge Graphs to determine whether the conditions applicable to a Workflow Task are satisfied, and performs the Workflow Task only when such conditions are satisfied.

For example, as noted above, a Workflow Task may require approval of an invoice for payment based upon the satisfaction of certain conditions reflected in recently updated Knowledge Graph 125, whereupon, upon obtaining that approval, the system invokes Decisioning Engine 175 to effect the payment. The payment may be made only upon a determination that applicable criteria—such as approval limits and risk and fraud assessments reflected in the Knowledge Graph—are satisfied. Because the applicable conditions are determined by reference to context the system has derived and maintained over time, rather than based solely on static predetermined rules, Context-Derived Conditioning differs significantly from conventional rules-based gating.

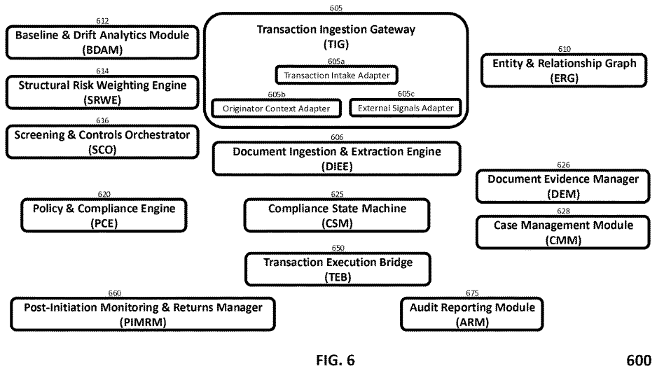

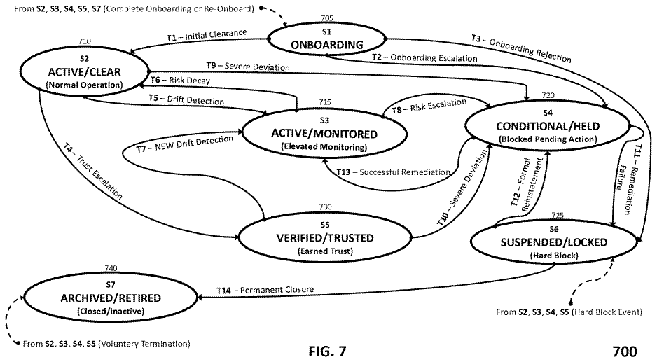

In other embodiments, with respect to particular Higher-Level Tasks such as Decisioning and Compliance, Structural Gating and Post-Decision Feedback are employed, as described in greater detail below with respect to FIGS. 6 and 7. While Context-Derived Conditioning can be considered a form of Structural Gating, it does not necessarily require conditioning Workflow Tasks upon an accumulated relationship state maintained by a compliance-based state machine and other architectural components discussed below with respect to FIGS. 6 and 7.

It should be emphasized that Continual CSD, Relationship Persistence and Context-Derived Conditioning are each independent concepts that can exist independently of one another and of the particular embodiments described herein. The embodiments of FIGS. 6 and 7—including the Entity & Relationship Graph, the Compliance State Machine, the Structural Risk Weighting Engine, the Post-Initiation Monitoring & Returns Manager, and the relationship states and transitions described therein—represent particular implementations in which the foregoing concepts are applied to certain Higher-Level Tasks such as Decisioning and Compliance, and in which additional capabilities (including Structural Gating and Post-Decision Feedback) are integrated. Nothing in these embodiments is required to employ Continual CSD, Relationship Persistence or Context-Derived Conditioning, each of which may be employed with respect to any Task in the context of any scenario-specific workflow.

Turning to block diagram 600 of FIG. 6, we now describe an embodiment of the present invention focused on certain Higher-Level Tasks, such as Decisioning and Compliance, that facilitate automated implementations of scenario-specific workflows in a state-based manner. Such an approach avoids much of the reliance on human judgment and intervention that is endemic to rules-based and other current approaches, as it enables risk management over time by integrating Document-Processing Tasks (including Continual CSD and Relationship Persistence) into scenario-specific workflow process.

As noted above, key operations such as Decisioning and Compliance require not only the derivation of meaning from context within and across documents (i.e., CSD), but also Structural Gating to condition such operations on criteria not currently available to the system, and Post-Decision Feedback to incorporate the outcomes of prior operations into the assessment of future ones. System 600 integrates these capabilities into a unified architecture that manages the progression of scenario-specific workflows over time—employing compliant Decisioning and risk management to determine when transitions among relationship states (clear, monitored, conditional, trusted, etc.) are warranted.

In one embodiment, system 600 operates in conjunction with the modules described above with respect to FIGS. 1 through 5. For example, the Document-Processing Tasks performed by TSAgents 210 (Capture, Classification, Matching, Reconciliation, Verification, Coding, etc.) continue to be performed in the manner described above, with the iteratively updated Knowledge Graph providing the Relationship Persistence that enables system 600 to assess risk and enforce compliance on a continual basis.

It should be noted that the modules of system 600 are not limited to any particular type of transaction or scenario. While the following description illustrates their operation in the context of financial payment transactions (such as ACH payments originated by a bank on behalf of its customers), the same architecture applies to other scenarios, including healthcare claims and reimbursements, insurance payments, and operational processes such as the management of returned correspondence—i.e., any scenario in which an obligated party must enforce and demonstrate adherence to compliance obligations with respect to relationships over time.

In virtually any scenario, the obligated party faces a common problem: the difficulty of enforcing and demonstrating adherence to payment-related and other compliance obligations, particularly before Decisions and other key operations are initiated. Existing approaches-whether rules-based workflows, post-hoc monitoring systems, or isolated screening tools-fail to address this problem adequately, as they do not integrate Continual CSD and Relationship Persistence with Structural Gating and Post-Decision Feedback in a manner that facilitates compliant Decisioning while managing risk to determine when transitions among relationship states are warranted.

The modules of system 600 address this problem by implementing a pipeline that ingests transactions and supporting documents, maintains persistent Knowledge Graphs (including relationships among line-item and other atomic-level Signal), assesses risk on a continual basis, enforces compliance gating as a structural precondition to key operations, collects and validates documentary evidence as a state-progression mechanism, monitors outcomes and feeds them back into future risk assessments, and produces a contemporaneous compliance record as a byproduct of the process itself.

As with the modules described in FIGS. 1 through 5, the functionality of the modules of system 600 can be merged together, split apart and otherwise reallocated into subsets or supersets of the modules illustrated in block diagram 600. Similarly, the Tasks performed by one or more such modules can differ from those illustrated and described herein without departing from the spirit of the present invention.

Transaction Ingestion Gateway 605 (“TIG”) serves as the entry point of system 600, managing both inbound and outbound communication between the system and external parties and other systems. In one embodiment, TIG 605 receives inbound transaction instructions (e.g., payment requests, claims submissions, correspondence for processing) from initiating parties and produces a fully contextualized transaction object for downstream processing by other modules of system 600.

TIG 605 also handles outbound communication, including evidence requests, status notifications, rejection notices, and other correspondence generated by downstream modules. In this manner, TIG 605 serves as an isolation boundary-external parties and systems do not interact directly with the compliance pipeline, and internal modules do not reach back to external parties and systems except through TIG 605.

In one embodiment, TIG 605 includes three sub-adapters that together assemble the contextual information necessary for downstream processing:

Transaction Intake Adapter 605a (“TIA”) receives raw transaction instructions in whatever format they are submitted. For example, in the context of ACH payments, TIA 605a receives Nacha-formatted batch files; in the context of healthcare claims, it receives HL7 FHIR messages or X12 837 claim submissions (among others); in the context of returned correspondence, it receives scanned returned envelopes, address verification responses, or other documents in connection with failed deliveries.

In one embodiment, TIA 605a parses and normalizes each submission into a canonical internal format, validates structural integrity, and decomposes batch submissions into individual instructions for independent routing through the pipeline. TIA 605a does not evaluate compliance risk or make gating decisions; rather, it ensures that each transaction instruction is structurally sound and properly formatted for downstream analysis.

It should be noted that the variety of formats and submission methods accommodated by TIA 605a is a function of the scenario-specific configuration, and does not require architectural changes to the pipeline. The same TIA 605a processes financial payment instructions, healthcare claims, returned mail notifications, and other transaction types by employing scenario-specific parsing logic while producing a common canonical output.

Originator Context Adapter 605b (“OCA”) enriches each transaction instruction with the obligated party's own knowledge about the initiating party. This includes, for example, account status, entitlements, limits, risk tier, historical transaction patterns, profile data, and prior compliance dispositions maintained in Entity & Relationship Graph 610 (i.e., the Knowledge Graphs of prior embodiments).

It should be noted that the data assembled by OCA 605b is the obligated party's internal data—not data provided by the initiating party with the transaction. For example, in a financial payment scenario, OCA 605b retrieves the bank's own customer profile and transaction history for the originator; in a healthcare scenario, it retrieves the payer's own records regarding the submitting provider; in a returned mail scenario, it retrieves the institution's own records regarding the entity whose correspondence was returned, including prior return history and address verification attempts.

This distinction is significant because it ensures that the compliance pipeline operates on the obligated party's independent assessment of the relationship, rather than relying on information supplied by the initiating party—a structural safeguard against the misattribution of compliance responsibility discussed above.

External Signals Adapter 605c (“ESA”) interfaces with external data sources to obtain Signal relevant to the compliance assessment. Such sources may include, for example, sanctions and watchlist databases (e.g., OFAC/SDN lists), regulatory advisories (e.g., FinCEN advisories), beneficial ownership registries, account validation services, third-party risk intelligence feeds, address verification services, provider exclusion lists (e.g., OIG exclusion lists in the healthcare context), national provider registries, and similar external data sources relevant to the particular scenario.

In one embodiment, ESA 605c fetches and normalizes data from these external sources; it does not interpret or score such data. Interpretation and scoring are performed by downstream modules (e.g., Screening & Controls Orchestrator 616 and Structural Risk Weighting Engine 614, described below).

Document Ingestion & Extraction Engine 606 (“DIEE”) receives supporting documents associated with transactions or relationships and extracts structured information therefrom, including line-item-level detail and other atomic Signal. Such documents may include, depending on the scenario, invoices, contracts, work orders, claims, prior authorizations, medical records, shipping documents, tax forms, returned correspondence, address change notifications, and other document types relevant to the particular scenario. As will be discussed in greater detail below, documents may be provided to the system for a variety of reasons, including system requests for supporting documentation.

In one embodiment, DIEE 606 employs the Continual CSD techniques described above with respect to FIGS. 1 through 5—including the Capture, Classification, and Signal Identifier functionality performed by TSAgents 210—to extract structured data at multiple levels of abstraction. This includes document-level data (e.g., document type, date, total amount), as well as transaction-level and sub-document and line-item-level data (e.g., individual amounts, codes, quantities, descriptions, property or project references, counterparty identifiers, jurisdictional indicators, signatures, and other field-level attributes).

In one embodiment, DIEE 606 normalizes extracted data into a common schema and links each document and its component fields to relevant transaction instructions, as well as other data relationships maintained in Entity & Relationship Graph 610. In this manner, DIEE 606 populates Entity & Relationship Graph 610 with the line-item-level detail necessary for downstream modules to perform Continual CSD over time—enabling, for example, the detection of commodity profile shifts, document characteristic drift, and cross-document inconsistencies that would not be apparent from document-level or transaction-level data alone.

It should be noted that DIEE 606 extracts the narrative story of the documents it processes over time, but does not determine whether particular documents or transactions are sufficient to address internal or external compliance obligations. Such determinations are made by Document Evidence Manager 626 and Policy & Compliance Engine 620, described below.

Entity & Relationship Graph 610 (“ERG”) provides the Relationship Persistence that is central to the operation of system 600. In one embodiment, ERG 610 is an implementation of the Knowledge Graphs described above with respect to FIGS. 1 through 5, extended to support the multi-level relationship modeling required for Higher-Level Tasks such as Decisioning and Compliance.

For example, ERG 610 models entities (e.g., initiating parties, counterparties, accounts, intermediaries, providers, facilities) as nodes, and relationships among entities as edges, with full transaction histories, documents, line-item data, risk weights, compliance states, state transitions, evidence packages, screening results, settlement outcomes, case dispositions, and other attributes accumulated over time.

In one embodiment, ERG 610 is a multi-level graph that extends beyond header-level relationships (e.g., originator to vendor, or payer to provider) into the transaction, document, line-item and other atomic Signal layers. For example, higher-level relationships comprise entity nodes (e.g., the originating company, the counterparty, the obligated institution, etc.). Lower-level relationships comprise relationship edges among entities (e.g., the originator-counterparty relationship), document nodes linked to relationships (e.g., each invoice, purchase order, contract, claim, work order, or returned envelope associated with particular relationships) and line-item nodes linked to documents (e.g., individual field labels and values within a document, including associated description, quantity, unit price, category, codes, and other reference data), among others.

This multi-level structure enables line-item anomaly detection as a graph problem. For example, a shift in the commodity profile of a vendor relationship—from specific itemized entries to vague lump-sum descriptions—may be detectable only through accumulated line-item history. Cross-document consistency verification (e.g., matching purchase order line items against invoice line items) similarly requires such detail. More granular and defensible risk weight computation is possible when baseline measurement operates at multiple levels (e.g., payment-level, document-level, and line-item-level drift)

ERG 610 is traversed and updated by virtually every module of system 600. Such Relationship Persistence It is what makes the system's analysis cumulative over time, rather than transactional—i.e., each new transaction, document, or other Event is analyzed in the context of everything the system has previously processed regarding various relationships.

In one embodiment, ERG 610 also supports re-onboarding of relationships with full prior history. When a previously terminated or archived relationship re-enters the system (as described in greater detail below with respect to FIG. 7), ERG 610 makes full prior history available to all other modules, so that the relationship is treated as a returning one—not as a new one. Baseline & Drift Analytics Module 612 has the prior baseline. Structural Risk Weighting Engine 614 has the prior risk trajectory. Post-Initiation Monitoring & Returns Manager 660 has the prior settlement or outcome history. Finally, Document Evidence Manager 626 has prior evidence packages. In this manner, re-onboarding is a refresh, not a reset.

Baseline & Drift Analytics Module 612 (“BDAM”) measures deviation from established behavioral baselines with respect to various relationships. In one embodiment, BDAM 612 maintains baselines across multiple dimensions, including, for example, transaction amounts and frequency, document characteristics (types, formats, level of itemization), line-item commodity profiles, counterparty attribute stability, and other behavioral indicators relevant to the particular scenario.

BDAM 612 produces multi-dimensional deviation profiles—not single aggregate scores. This distinction is significant because it preserves the specificity of the deviation. For example, a relationship may exhibit stable transaction amounts but dramatic drift in document characteristics (e.g., shifting from itemized invoices to lump-sum statements), or stable document characteristics but elevated transaction frequency. By representing each dimension of deviation independently, BDAM 612 provides downstream modules (e.g., Structural Risk Weighting Engine 614 and Policy & Compliance Engine 620) with the granularity necessary to make risk-proportionate gating decisions.

In one embodiment, BDAM 612 operates in two modes. During onboarding (or re-onboarding) of a relationship, it operates in baseline-establishment mode, constructing initial behavioral baselines from the first transactions, documents, and line-item data associated with the relationship. During the active lifecycle of the relationship, it operates in deviation-detection mode, measuring each new transaction, document, or line-item data point against the established baseline and producing deviation profiles that are stored in ERG 610 and consumed by other modules.

BDAM 612 also updates baselines over time as relationships legitimately evolve. For example, a vendor that gradually increases its volume of business with an originator over years will exhibit a gradual increase in transaction amounts that, if the baseline remained static, would eventually trigger deviation detection even though the increase is legitimate. By allowing baselines to evolve (subject to the rate of change and consistency of the evolution), BDAM 612 avoids “false-positive” deviation detection and the operational friction it would cause.

In the context of returned correspondence, for example, BDAM 612 might maintain baselines for return frequency per entity, types of return reasons (e.g., addressee unknown vs. insufficient address vs. no such number), and geographic distribution of returns. A sudden cluster of returned mail for entities sharing a common address, or a spike in returns for a particular entity, would register as deviations from baseline.

Structural Risk Weighting Engine 614 (“SRWE”) assigns and maintains a composite risk weight for each relationship. In one embodiment, SRWE 614 consumes deviation profiles from BDAM 612, external signals from ESA 605c, screening results from Screening & Controls Orchestrator 616, outcome history from Post-Initiation Monitoring & Returns Manager 660, and existing risk trajectory data from ERG 610.

The risk weight produced by SRWE 614 is persistent—it attaches to the relationship, not to any individual transaction—and cumulative—a series of small deviations compounds over time, even if no single deviation would independently trigger a gating decision. This cumulative property is central to the system's ability to detect gradual risk accumulation that would be invisible to systems that evaluate transactions independently.

In one embodiment, SRWE 614 also produces human-readable risk reason codes that accompany the composite risk weight. These reason codes enable downstream modules—in particular, Case Management Module 628 and Audit Reporting Module 675—to present the basis for risk assessments in a manner that is understandable to compliance analysts and examiners.

SRWE 614 also supports time-based risk weight decay. In one embodiment, sustained clean operation (i.e., the absence of deviations and the accumulation of clean outcomes over time) causes the risk weight to decrease monotonically toward a trust threshold. This mechanism supports the concept of earned trust, described in greater detail below with respect to FIG. 7, in which a relationship that has demonstrated sustained compliance over time may earn reduced gating friction in the future. The time-based nature of this decay is architecturally significant—trust is not earned by the occurrence of a single favorable event, but by the sustained absence of unfavorable events over a meaningful period of time.

Screening & Controls Orchestrator 616 (“SCO”) orchestrates entity-level as well as transaction-level compliance screens, among others. Such screens may include, depending on the scenario, sanctions and watchlist screening, anti-money-laundering rule triggers, velocity and exposure checks, account validation, provider eligibility verification, address verification, and other scenario-specific screening operations.

In one embodiment, SCO 616 executes screening at two stages of the pipeline: at intake (to identify obvious blocks early, such as a sanctions match that should prevent any further processing) and at pre-release (to catch changes that may have occurred during any remediation or hold period—e.g., a new sanctions designation that appeared while evidence was being collected).

SCO 616 produces screening results that are consumed by Policy & Compliance Engine 620 and Compliance State Machine 625. SCO 616 does not itself make gating decisions; rather, it provides the screening inputs that inform such decisions. This separation of screening from gating is architecturally significant because it ensures that screening results are always evaluated in the context of the relationship's accumulated compliance state, rather than in isolation.

Policy & Compliance Engine 620 (“PCE”) encodes the compliance obligations applicable to the obligated party into executable gating logic. Such obligations may include, depending on the scenario, regulatory requirements, industry operating rules (e.g., Nacha operating rules for ACH payments), contractual obligations, internal policies, and institutional risk appetite thresholds.

In one embodiment, PCE 620 evaluates the current state of a relationship (as reflected in ERG 610, including risk weight from SRWE 614, screening results from SCO 616, and evidence status from Document Evidence Manager 626) and produces structured precondition sets—i.e., the specific conditions that must be satisfied before a transaction can proceed or a state transition can occur. Such preconditions may include, for example, required evidence (e.g., itemized invoices, updated W-9 forms, address verification), required screenings (e.g., re-screening against current sanctions lists), required approvals (e.g., analyst sign-off), cooling-off periods, and amount caps.

PCE 620 is configurable, for example, per obligated party, per initiating party tier, per transaction type, and per risk band. In this manner, different relationships may be subject to different compliance requirements based on their accumulated state, without requiring different system architectures.

It should be noted that PCE 620 defines preconditions but does not enforce them. Enforcement is the responsibility of Compliance State Machine 625 (described below). This separation of policy definition from enforcement is architecturally significant because it allows policies to be modified, extended, or reconfigured without altering the enforcement mechanism- and vice versa.

In one embodiment, PCE 620 also evaluates trust-promotion criteria (e.g., periodically) for relationships in good standing. As noted above with respect to SRWE 614, sustained clean operation causes risk weight to decay over time. PCE 620 checks whether a relationship's risk weight has decayed below a trust threshold for a sufficient duration, and if so, signals Compliance State Machine 625 that a trust escalation transition is warranted.

Compliance State Machine 625 (“CSM”) maintains and enforces the compliance state of relationships and transaction instructions processed by system 600. CSM 625 is the system's gatekeeper—it enforces the architectural invariant that no transaction reaches Transaction Execution Bridge 650 unless all preconditions defined by PCE 620 are satisfied.

In one embodiment, CSM 625 manages the progression of each relationship through a set of compliance states, as described in greater detail below with respect to FIG. 7. These states represent the system's current assessment of the relationship's compliance posture—from initial onboarding through active operation, monitoring, conditional holds, earned trust, suspension, and archival. CSM 625 evaluates transition criteria (defined by PCE 620) and executes state transitions when those criteria are met.

CSM 625 also signals other modules upon state transitions. For example, when a relationship transitions to a state requiring evidence collection, CSM 625 signals Document Evidence Manager 626 to initiate an evidence request cycle. When a relationship transitions to a state requiring analyst review, CSM 625 signals Case Management Module 628 to assemble a case file.

In one embodiment, CSM 625 supports both synchronous and asynchronous evaluation. Synchronous evaluation is triggered by the arrival of a new transaction instruction through TIG 605—i.e., the system evaluates the relationship's compliance state in the context of the incoming transaction. Asynchronous evaluation is triggered by signals from Post-Initiation Monitoring & Returns Manager 660—i.e., a settlement outcome, return, or other post-execution event triggers re-evaluation of the relationship's compliance state without waiting for a new inbound transaction.

Both pathways converge on the same ERG 610, SRWE 614, PCE 620, and CSM 625 processing, but they have different entry points and triggering mechanisms. This dual-pathway architecture is what enables system 600 to respond to post-execution outcomes in near-real-time, rather than waiting for the next inbound transaction to trigger compliance evaluation.

CSM 625 logs state transitions immutably for Audit Reporting Module 675. Each log entry includes the prior state, the new state, the transition criteria that were evaluated, the specific data inputs that satisfied (or failed to satisfy) those criteria, and the timestamp of the transition. In this manner, CSM 625 produces the contemporaneous compliance record that the obligated party needs to demonstrate adherence to its obligations. In other embodiments, certain intra-state activities are logged as well, even if they don't result in a state transition. For example, a request for additional documentation might be logged, even if the result of reviewing such documentation did not warrant a state transition.

Document Evidence Manager 626 (“DEM”) manages the evidence lifecycle that is central to the document-driven evidence loop described above. In one embodiment, DEM 626 generates structured evidence requests (specifying which documentation is needed and why), issues those requests via TIG 605, tracks completeness of responses, validates whether extracted data (provided by DIEE 606) addresses the specific compliance concerns that triggered the evidence requests, maintains the state of the evidence package as a stateful object, enforces expiration windows, and provides completed evidence packages for Case Management Module 628 (analyst review) and Audit Reporting Module 675 (audit).

In one embodiment, DEM 626 maintains each evidence package through a lifecycle of states, including (for example) Not Required, Requested, Partially Received, Received, Parsed, Validated, Rejected/Insufficient, and Expired. The progression through these states is itself a form of Structural Gating—the relationship's compliance state literally cannot progress (via CSM 625) until the evidence package reaches a terminal state (Validated, Rejected/Insufficient, or Expired), and each terminal state triggers a different downstream transition.

It should be noted that, in this embodiment, DEM 626 is distinct from DIEE 606. DIEE 606 extracts data from documents, and determines (in context) “what the documents say.” DEM 626, on the other hand, manages the evidentiary process, and determines whether “the requested evidence was received,” and whether it “addresses the compliance concerns.” This separation facilitates the independence of the document extraction and evidence validation processes, each employing Continual CSD for its respective purpose.

In one embodiment, DEM 626 validates sufficiency at the line-item level. For example, if the compliance concern involves commodity profile drift (detected by BDAM 612), DEM 626 validates not merely that an invoice has been received, but that the invoice includes line-item detail sufficient to explain the drift—e.g., itemized descriptions, quantities, and unit prices that are consistent with the legitimate business relationship. This line-item-level validation is a direct application of Continual CSD to the evidence lifecycle.

Case Management Module 628 (“CMM”) is where human judgment enters the pipeline when automated processing is insufficient. In one embodiment, CMM 628 assembles case files from data provided by ERG 610, BDAM 612, SRWE 614, DEM 626, SCO 616, and PIMRM 660, presenting compliance analysts with a comprehensive view of the relationship's history, current state, specific compliance concerns, evidence status, and risk assessment. CMM 628 assigns cases to analysts based on risk tier and expertise, enforces service-level agreements, supports maker-checker workflows (e.g., requiring a second analyst to approve certain dispositions), records analyst disposition and rationale, and manages escalation paths.

In one embodiment, CMM 628 also handles automated workflow logic around human review, including auto-assignment of cases based on configurable criteria, auto-escalation when service-level timelines are at risk, and auto-closure of cases where the underlying compliance concern has been resolved by other modules (e.g., validated evidence from DEM 626 or resolved screening from SCO 616).

It should be noted that CMM 628 is not a substitute for the automated gating performed by CSM 625 and PCE 620. Rather, it is the mechanism through which system 600 accommodates the inevitable cases in which automated analysis is insufficient and human expertise is required—while ensuring that such cases are presented to analysts with the full context assembled by the automated pipeline, rather than requiring analysts to reconstruct that context manually.

Transaction Execution Bridge 650 (“TEB”) provides the interface between system 600 and external execution rails. Depending on the scenario, such execution rails may include ACH operators, claims clearinghouses, payment networks, correspondence distribution systems, or other external systems through which cleared transactions or operations are executed.

In one embodiment, TEB 650 accepts only CSM-cleared transaction instructions—i.e., instructions for which Compliance State Machine 625 has confirmed that all preconditions defined by PCE 620 have been satisfied. TEB 650 builds and submits execution files in the format required by the relevant execution rail, records execution confirmation, and enforces the final architectural boundary of the compliance pipeline.

This architectural constraint—that TEB 650 will not accept or process any transaction instruction that has not been cleared by CSM 625—serves as a key enforcement mechanism of Structural Gating. It is not a procedural discipline that can be overridden or bypassed; it is an architectural invariant of the system.

In one embodiment, TEB 650 is adaptable to multiple execution rails while the upstream pipeline remains rail-agnostic. The same pipeline that processes and gates a financial payment through ACH can process and gate a healthcare claim through an X12 clearinghouse, or a correspondence re-delivery through a postal processing system, with only TEB 650 requiring scenario-specific adaptation.

Post-Initiation Monitoring & Returns Manager 660 (“PIMRM”) closes the feedback loop that is central to Post-Decision Feedback. In one embodiment, PIMRM 660 monitors for returns, rejections, notices of change, denials, reversals, settlement exceptions, delivery failures, and other outcomes that occur after a transaction or operation has been executed through TEB 650.

PIMRM 660 processes these outcomes and feeds them back into the system: it updates ERG 610 with the outcome data, feeds outcome history to SRWE 614 for risk weight recalculation, and feeds it to BDAM 612 for baseline recalibration. Clean outcomes (e.g., successful settlement and successful delivery) contribute to risk weight decay over time, while adverse outcomes (e.g., returns, rejections and delivery failures) contribute to risk weight elevation.

In one embodiment, PIMRM 660 can trigger asynchronous state transitions via CSM 625 without waiting for a new inbound transaction. For example, a return arriving days after settlement triggers re-evaluation of the relationship's compliance state through the pipeline PIMRM 660→ERG 610→SRWE 614→PCE 620→CSM 625, which operates independently of the main transaction processing pipeline.

This asynchronous capability is significant for several reasons. It enables the system to respond to adverse outcomes promptly—a return that arrives on Tuesday affects the gating decision for a new transaction arriving on Wednesday. Moreover, it enables trust escalation—clean settlement history accumulated over time, as reported by PIMRM 660, is the primary evidence that a relationship has earned reduced gating friction. Without PIMRM 660, the system would have no mechanism for recognizing sustained clean operation, and trust escalation (as described below with respect to FIG. 7) would not be possible.

In the context of returned correspondence, for example, PIMRM 660 monitors whether re-sent correspondence was successfully delivered, whether address updates resulted in corrected deliveries, and whether entities with returned mail histories exhibit patterns (e.g., repeated returns suggesting address instability or potential fraud). These outcomes feed back into SRWE 614 and CSM 625 in the same manner as settlement outcomes in a financial payment scenario.

Audit Reporting Module 675 (“ARM”) serves as the system's institutional memory. In one embodiment, ARM 675 maintains a complete, immutable, time-ordered record of every event across all modules of system 600. This record is indexed by transaction, by relationship, and by evidence package, enabling retrieval of compliance history along any of these dimensions.

ARM 675 generates examination-ready artifacts, including decision audit trails (showing the sequence of gating decisions for a particular transaction), evidence chains (showing the evidence request, response, extraction, and validation lifecycle for a particular compliance concern), policy version histories (showing which version of which policy was in effect when a particular gating decision was made), gating rate statistics (showing systemic patterns across relationships), and relationship lifecycle summaries (showing the complete compliance history of a particular relationship from onboarding through current state).

It should be noted that the records maintained by ARM 675 are created contemporaneously with the events they record—not reconstructed after the fact. Each module of system 600 writes to ARM 675 as it performs its function, so that the compliance record is a byproduct of the compliance process, not a separate reporting exercise.

This contemporaneous nature is architecturally significant because it addresses a key deficiency of existing approaches, in which the obligated party must reconstruct compliance narratives from scattered alert logs, case notes, and transaction records across disconnected systems. ARM 675 produces the unified, relationship-level compliance record that the obligated party needs to demonstrate adherence to its obligations during examination or audit.

Having described the static components of system 600, the dynamic operation of these modules—i.e., the manner in which they manage the progression of relationships through compliance-relevant states over time—will now be described with reference to FIG. 7.

Turning to state diagram 700 of FIG. 7, the dynamic operation of the modules described above with respect to FIG. 6 is illustrated in terms of the compliance states through which a relationship progresses over time, and the transitions among those states.

As noted above, system 600 manages the progression of scenario-specific workflows over time, employing compliant Decisioning and risk management throughout a workflow to determine when transitions among relationship states are warranted. It should be emphasized that this process differs significantly from a rule-based workflow in which Actions and other Decisions are determined in accordance with predefined algorithms. By employing Continual CSD, Relationship Persistence, Structural Gating and Post-Decision Feedback, system 600 facilitates a process that contextualizes such Actions and Decisions over time (including requests for additional documentation as warranted).

State diagram 700 illustrates this progression for relationships managed by system 600, showing, in this embodiment, seven states (S1 through S7) and a set of named transitions that govern how a relationship moves among those states.

It should be noted that state diagram 700 is not limited to any particular type of transaction or scenario. The same states and transitions apply whether the system is managing financial payment relationships (such as ACH payments originated by a bank on behalf of its customers), healthcare claim relationships (such as claims submitted by a provider to an insurer), or operational processes (such as the management of returned correspondence for a large institution). The scenario-specific differences are expressed through the policies encoded in Policy & Compliance Engine 620, the screening operations orchestrated by Screening & Controls Orchestrator 616, and the evidence requirements managed by Document Evidence Manager 626—not through different states or transitions. Nevertheless, the states and transitions illustrated in state diagram 700 may be divided, combined and otherwise modified without departing from the spirit of the present invention.

In each state, the modules of system 600 continue to perform their respective functions. Entity & Relationship Graph 610 is traversed by other modules to facilitate the performance of their Tasks, and is updated to accumulate contextual relationship history. Baseline & Drift Analytics Module 612 measures deviation from established baselines. Structural Risk Weighting Engine 614 maintains and updates composite risk weights. And Audit Reporting Module 675 records Events contemporaneously. What differs across states is the compliance posture—i.e., the degree of scrutiny applied, the preconditions required before transactions can proceed, and the types of interventions triggered when deviation is detected.

### Compliance States

S1—Onboarding (705). State S1 represents the initial encounter between the system and a relationship (e.g., among two entities), as well as any subsequent re-onboarding of a previously known relationship. In one embodiment, when a new relationship enters the system, Transaction Ingestion Gateway 605 receives the initial transaction instruction or relationship registration, and Originator Context Adapter 605b assembles the obligated party's internal data regarding the initiating party. External Signals Adapter 605c fetches initial external signals (e.g., sanctions lists, provider registries, address verification data, etc.), and Screening & Controls Orchestrator 616 performs initial compliance screening.

During S1, Document Ingestion & Extraction Engine 606 processes any supporting documents submitted with the initial transaction, extracting line-item-level detail and populating Entity & Relationship Graph 610 with the initial relationship structure. Baseline & Drift Analytics Module 612 operates in baseline-establishment mode, constructing the initial behavioral baselines from whatever transaction, document, and line-item data are available. Structural Risk Weighting Engine 614 computes an initial risk weight for the relationship based on the data available at this stage.

It should be noted that S1 is architecturally identical for initial onboarding and re-onboarding, but the data available to the modules differs significantly. During initial onboarding, ERG 610 contains no prior history for the relationship, so BDAM 612 must construct baselines from scratch and SRWE 614 has no prior risk trajectory to consult. During re-onboarding (e.g., when a previously archived relationship re-enters the system via a transition discussed below), ERG 610 provides full prior history, so BDAM 612 refreshes rather than creates baselines. SRWE 614 has the prior risk trajectory, Post-Initiation Monitoring & Returns Manager 660 has prior outcome history, and Document Evidence Manager 626 has prior evidence packages. In this manner, re-onboarding is a refresh, not a reset.

State S1 is transient—the relationship does not remain in S1 indefinitely. Upon completion of onboarding processing, Compliance State Machine 625 evaluates the results and transitions the relationship to one of three states: S2 (Active/Clear) via transition T1 if screening is clear, the initial risk weight is below the gating threshold, and sufficient baseline data has been established; S4 (Conditional/Held) via transition T2 if onboarding reveals insufficient documentation, elevated initial risk, or line-item anomalies requiring further investigation before proceeding; or S6 (Suspended/Locked) via transition T3 if screening produces a hard block (e.g., a sanctions match, a prohibited jurisdiction, or an absolute regulatory bar).

S2—Active/Clear (Normal Operation) (710). State S2 represents a relationship in good standing. In one embodiment, every transaction instruction associated with a relationship in state S2 is still evaluated by the full pipeline-Transaction Ingestion Gateway 605 contextualizes it, Document Ingestion & Extraction Engine 606 extracts supporting document data, Baseline & Drift Analytics Module 612 measures it against established baselines, Structural Risk Weighting Engine 614 updates the risk weight, and Policy & Compliance Engine 620 evaluates preconditions. However, because the relationship is in good standing (i.e., the risk weight is below the gating threshold and no preconditions are unsatisfied), PCE 620 does not impose gating holds, and Compliance State Machine 625 allows the transaction to proceed to Transaction Execution Bridge 650 for execution.

It should be noted that S2 is not a state of inattention. The system's full analytical pipeline continues to operate on every transaction. The distinction between S2 and more restrictive states (such as S3 or S4) is not whether the system is analyzing—it always is—but whether the analysis produces gating consequences. In S2, the analysis continues to accumulate data in ERG 610, refine baselines in BDAM 612, and update risk weights in SRWE 614, but it does not hold or block transactions.

Post-Initiation Monitoring & Returns Manager 660 continues to monitor settlement outcomes for transactions executed from S2. Clean settlements contribute to risk weight decay in SRWE 614, which over time may qualify the relationship for trust escalation to S5 via transition T4. Adverse outcomes (e.g., returns, rejections, etc.) contribute to risk weight elevation, which may trigger a transition to S3 (Monitored) via transition T5 or, in cases of severe multi-dimensional deviation, directly to S4 (Conditional/Held) via transition T9.

In this embodiment, State S2 is the only state from which a relationship can earn trust escalation to S5 (Verified/Trusted). This architectural constraint is significant: a relationship that has been gated, monitored, or remediated cannot bypass S2 on its way to S5. It must first demonstrate sustained clean operation in S2 over a meaningful period of time (or satisfaction of other conditions) before trust escalation is possible.

S3—Active/Monitored (715). State S3 is an intermediate state representing a relationship that has exhibited first-threshold deviation from its established baselines but is not yet subject to gating holds. In one embodiment, Baseline & Drift Analytics Module 612 detects deviation—e.g., an increase in transaction frequency, a shift in document characteristics (e.g., from itemized invoices to lump-sum statements), or a change in the commodity profile at the line-item level—and the resulting deviation profile, when processed by Structural Risk Weighting Engine 614, produces a risk weight that exceeds the monitoring threshold but remains below the gating threshold.

In S3, transactions continue to proceed. Compliance State Machine 625 does not impose gating holds. However, the compliance posture changes in several respects. Enhanced logging is activated in Audit Reporting Module 675, producing more detailed records of the deviation detected and the system's ongoing assessment. Policy & Compliance Engine 620 may flag the relationship for periodic review by Case Management Module 628. Document Evidence Manager 626 may initiate proactive evidence requests—e.g., requesting itemized invoices rather than waiting for a compliance concern to trigger such a request.

State S3 can resolve in several ways. If the deviation resolves over time (e.g., subsequent transactions and documents return to baseline consistency, and clean settlement outcomes accumulate via Post-Initiation Monitoring & Returns Manager 660), the risk weight decays through SRWE 614, and CSM 625 transitions the relationship back to S2 (Active/Clear) via transition T6. If the deviation continues or compounds, the risk weight may eventually cross the gating threshold, at which point CSM 625 transitions the relationship to S4 (Conditional/Held) via transition T8.

It should be noted that S3 cannot transition directly to S5 (Verified/Trusted). A relationship that has exhibited deviation must first return to S2 and demonstrate sustained clean operation before trust escalation is possible. This constraint ensures that trust is earned through sustained absence of deviation, not through a single corrective action.

S4—Conditional/Held (Blocked Pending Action) (720). State S4 represents a relationship for which Compliance State Machine 625 has imposed a gating hold. In one embodiment, no transaction instruction associated with a relationship in state S4 can proceed to Transaction Execution Bridge 650 until all preconditions defined by Policy & Compliance Engine 620 are satisfied.

In one embodiment, the preconditions that must be satisfied in S4 are specific and structured, not generic. PCE 620 produces a precondition set based on the particular compliance concerns that triggered the transition into S4. For example, if the transition was triggered by commodity profile drift (detected by BDAM 612 and weighted by SRWE 614), the precondition set may require itemized invoices covering the period of drift, validated at the line-item level by Document Evidence Manager 626. If the transition was triggered by a screening concern (identified by Screening & Controls Orchestrator 616), the precondition set may require updated screening results and analyst review via Case Management Module 628.

Document Evidence Manager 626 is particularly active in S4. DEM 626 generates structured evidence request checklists specifying exactly which documentation is needed and why. It issues requests through Transaction Ingestion Gateway 605, tracks receipt and completeness of responses, and validates whether extracted data (provided by Document Ingestion & Extraction Engine 606) addresses the specific compliance concerns. The evidence package maintained by DEM 626 progresses through its own lifecycle of states (Requested, Partially Received, Received, Parsed, Validated, Rejected/Insufficient, Expired), and the relationship's compliance state cannot progress until the evidence package reaches a terminal state.

Case Management Module 628 assembles case files for analyst review in S4, drawing on data from ERG 610, BDAM 612, SRWE 614, DEM 626, and SCO 616 to present the analyst with a comprehensive view of the relationship's history, current concerns, and evidence status. Analyst disposition is recorded and fed back to CSM 625.

State S4 resolves through one of two transitions. If remediation succeeds—i.e., evidence is validated, risk is reduced, and/or analyst review is favorable—CSM 625 transitions the relationship to S3 (Monitored) via transition T13. It should be noted that successful remediation does not return the relationship to S2 (Active/Clear) directly; instead, it returns to S3, where enhanced monitoring continues and the relationship demonstrates sustained clean operation to earn its way back to S2 via transition T6. If remediation fails—i.e., evidence is rejected, insufficient, or expired, or the analyst denies the case—CSM 625 transitions the relationship to S6 (Suspended/Locked) via transition T11.

S5—Verified/Trusted (Earned Trust) (730). State S5 represents a relationship that has earned reduced gating friction through sustained clean operation over time. In one embodiment, trust escalation to S5 is the result of time-based risk weight decay in Structural Risk Weighting Engine 614, confirmed by periodic trust-promotion criteria evaluation in Policy & Compliance Engine 620, and executed by Compliance State Machine 625 via transition T4.

It should be noted that, in one embodiment, transition T4 (Trust Escalation) is time-based, not event-based. Trust is not earned by the occurrence of a single favorable event (e.g., a clean audit, a successful remediation). It is earned by the sustained absence of unfavorable events over a meaningful period of time—many clean transactions processed, many clean settlement outcomes reported by Post-Initiation Monitoring & Returns Manager 660, no deviation detected by BDAM 612, and consistent risk weight decay in SRWE 614. This time-based mechanism ensures that trust reflects genuine sustained compliance, not a momentary snapshot. In other embodiments, trust is earned in a conditions-based manner apart from time (e.g., successfully clearing a threshold number of clean transactions without detection of any significant deviation or risk decay).

In S5, the system's analytical pipeline continues to operate fully, but PCE 620 applies reduced preconditions—for example, higher amount thresholds before gating, less frequent evidence requests, or streamlined screening. The specific reductions are configurable per policy and scenario. Compliance State Machine 625 performs periodic reviews of trusted relationships via a self-loop (transition T8), ensuring that trust remains warranted in light of current data. Audit Reporting Module 675 records the trust escalation and all subsequent reduced-friction decisions, so that the basis for earned trust is available for examination.

State S5 is subject to several important architectural constraints in this embodiment. First, S5 can only be entered from S2 (Active/Clear) via transition T4. There is no direct path from S3 (Monitored), S4 (Conditional/Held), or any other state to S5. A relationship that has been gated, monitored, or remediated must first return to S2 and demonstrate sustained clean operation before trust escalation is possible. Second, trust is revocable: if new deviation is detected (by BDAM 612 and SRWE 614), CSM 625 transitions the relationship to S3 (Monitored) via transition T7, temporarily revoking earned trust. In cases of severe multi-dimensional deviation, CSM 625 transitions the relationship directly to S4 (Conditional/Held) via transition T10, bypassing the monitoring state entirely.

S6—Suspended/Locked (Hard Block) (725). State S6 is the most restrictive state in state diagram 700. In one embodiment, all transaction instructions associated with a relationship in state S6 are blocked—no transaction can proceed to Transaction Execution Bridge 650 under any circumstances while the relationship remains in S6.

A relationship enters S6 through one of three pathways: transition T3 (Onboarding Rejection) from S1, indicating a hard screening hit during initial or re-onboarding; transition T11 (Remediation Failure) from S4, indicating that the relationship failed to satisfy the preconditions imposed during a gating hold; or the grouped Hard Block Event transition from any active state (S2, S3, S4, or S5), indicating a sanctions match or other absolute regulatory bar discovered at any point during the relationship's lifecycle. In the case of a Hard Block Event, Screening & Controls Orchestrator 616 identifies the hard block condition, and Compliance State Machine 625 transitions the relationship to S6 immediately, overriding any prior trust status or compliance posture.

State S6 can resolve through one of two transitions. If the suspension condition is resolved (e.g., a sanctions match is determined to be a false positive, or the regulatory bar is lifted), the relationship may undergo Formal Reinstatement via transition T12. This transition requires formal review, typically involving analyst approval through Case Management Module 628, updated screening by Screening & Controls Orchestrator 616, and explicit authorization recorded in Audit Reporting Module 675. Critically, transition T12 returns the relationship to S4 (Conditional/Held), not to S2 (Active/Clear)—the reinstated relationship must earn its way back through the state machine by satisfying the preconditions in S4, demonstrating clean operation in S3, and eventually returning to S2. If the relationship is determined to be permanently closed (e.g., confirmed fraud, a regulatory directive to terminate, or a business decision), CSM 625 transitions it to S7 (Archived/Retired) via transition T14.

It should be noted that, in this embodiment, a relationship in S6 cannot directly re-onboard. Unlike relationships in other states, which may re-enter S1 via the grouped Re-Onboarding transition, a suspended relationship must first be reinstated to S4 via T12 before any re-onboarding can occur. This constraint ensures that the conditions that led to suspension are formally resolved before the relationship can re-enter the active lifecycle.

S7—Archived/Retired (Closed/Inactive) (740). State S7 represents a relationship that is dormant. In one embodiment, a relationship enters S7 through the grouped Voluntary Termination transition from any active state (S2, S3, S4, or S5), triggered by inactivity timeout or formal termination notice, or through transition T14 (Permanent Closure) from S6.

It should be noted that S7 is not a terminal state. Entity & Relationship Graph 610 retains full relationship history for archived relationships, including all transaction data, document data, line-item data, risk weight history, compliance state transitions, evidence packages, screening results, settlement outcomes, and case dispositions accumulated during the relationship's active lifecycle. This history remains available for examination and audit retrieval through Audit Reporting Module 675.

A relationship in S7 can re-enter the active lifecycle via the grouped Re-Onboarding transition to S1, as described below. Because ERG 610 retains full prior history, the re-onboarding process has access to the complete relationship record, enabling all modules to treat the relationship as a returning one rather than a new one.

Having described the dynamic functionality of each of the states (S1-S7) in state diagram 700 (including various transitions among those states, it is also helpful to explore this dynamic functionality from the perspective of each individual transition.

### Named Transitions

T1—Initial Clearance (S1→S2). Transition T1 represents the successful completion of onboarding. In one embodiment, Compliance State Machine 625 implements transition T1 when the following conditions are satisfied: Screening & Controls Orchestrator 616 reports no hard or soft screening hits; Baseline & Drift Analytics Module 612 has established initial behavioral baselines from available transaction, document, and line-item data; Structural Risk Weighting Engine 614 has computed an initial risk weight that falls below the gating threshold defined by Policy & Compliance Engine 620; and any initial documentation requirements have been satisfied as confirmed by Document Evidence Manager 626. Upon implementation of T1, the relationship enters S2 (Active/Clear) and transactions may proceed to Transaction Execution Bridge 650 for execution. Audit Reporting Module 675 records the transition and all supporting data.

T2—Onboarding Escalation (S1→S4). Transition T2 represents an onboarding that cannot be completed without further action. In one embodiment, CSM 625 executes transition T2 when onboarding processing reveals insufficient documentation (as determined by DEM 626), elevated initial risk weight (as computed by SRWE 614), or line-item anomalies in the initial documents (as detected by BDAM 612 operating on data extracted by DIEE 606). The relationship enters S4 (Conditional/Held), and PCE 620 produces the specific precondition set that must be satisfied before the relationship can proceed. No transactions associated with this relationship can be executed while the relationship remains in S4.

T3—Onboarding Rejection (S1→S6). Transition T3 represents a hard block during onboarding. In one embodiment, CSM 625 executes transition T3 when SCO 616 identifies an absolute bar—for example, a match against a sanctions list (e.g., OFAC/SDN), a prohibited jurisdiction designation, or another regulatory prohibition that precludes the relationship from proceeding under any circumstances. The relationship enters S6 (Suspended/Locked) and all transactions are blocked. ARM 675 records the rejection, including the specific screening result and the policy basis for the block.

T4—Trust Escalation (S2→S5). Transition T4 represents the promotion of a relationship to earned trust status. In one embodiment, this is the only pathway into S5 (Verified/Trusted), and it is available only from S2 (Active/Clear).

Transition T4, as noted above, is time-based, not event-based. It is triggered not by a specific event (e.g., a successful audit or a favorable review), but by the sustained absence of adverse events over a meaningful period of time. In one embodiment, the mechanism operates as follows: Post-Initiation Monitoring & Returns Manager 660 reports clean settlement outcomes over time, which contribute to risk weight decay in Structural Risk Weighting Engine 614. Baseline & Drift Analytics Module 612 reports no deviation from established baselines. As the risk weight decays below a trust threshold and remains there for a sufficient duration of time, Policy & Compliance Engine 620—which periodically evaluates trust-promotion criteria for relationships in S2—signals CSM 625 that T4 is warranted. CSM 625 then implements the transition, and ARM 675 records the basis for trust escalation, including the duration of clean operation, the risk weight trajectory, and the specific trust-promotion criteria satisfied.

T5—Drift Detection (S2→S3). Transition T5 is triggered when BDAM 612 detects first-threshold deviation in a relationship that was previously in good standing. The deviation may manifest in any of the dimensions tracked by BDAM 612—transaction volume or frequency, document characteristics, line-item commodity profiles, or relationship attribute stability. SRWE 614 processes the deviation profile and produces a risk weight that exceeds the monitoring threshold but remains below the gating threshold. CSM 625 transitions the relationship to S3 (Monitored), where enhanced logging and potential proactive evidence requests begin. Transition T5 can also be initiated asynchronously by PIMRM 660—e.g., when adverse settlement outcomes cause SRWE 614 to elevate the risk weight above the monitoring threshold.

T6—Risk Decay (S3→S2). Transition T6 is triggered when the deviation that caused a relationship to enter S3 resolves over time. In one embodiment, subsequent transactions and documents return to baseline consistency (as measured by BDAM 612), clean settlement outcomes accumulate (as reported by PIMRM 660), and the risk weight decays below the monitoring threshold (as computed by SRWE 614). PCE 620 confirms that no preconditions remain unsatisfied, and CSM 625 transitions the relationship back to S2 (Active/Clear). This transition represents the system's ability to recognize recovery—not every deviation leads to escalation; some resolve naturally as the relationship returns to its established pattern.

T7—New Drift Detection (S5→S3). Transition T7 is triggered when BDAM 612 detects new deviation in a relationship that had previously earned trust status. In one embodiment, earned trust does not immunize a relationship against future scrutiny—the system continues to operate its full analytical pipeline in S5. When new deviation is detected and SRWE 614 elevates the risk weight above the monitoring threshold, CSM 625 transitions the relationship to S3 (Monitored), temporarily revoking earned trust. The relationship must then demonstrate clean operation to return to S2 via T6, and subsequently earn trust again via T4, before reduced gating friction is restored.

T8—Risk Escalation (S3→S4). Transition T8 is triggered when deviation detected in S3 continues or compounds rather than resolving. In one embodiment, BDAM 612 reports ongoing or worsening deviation, SRWE 614 elevates the risk weight above the gating threshold, and CSM 625 transitions the relationship to S4 (Conditional/Held). PCE 620 produces the specific precondition set that must be satisfied before transactions can proceed. This transition represents the escalation from enhanced monitoring to active gating—the system has observed sustained deviation and is now structurally preventing transactions from proceeding until the compliance concern is addressed.

T9—Severe Deviation (S2→S4). Transition T9 is triggered when BDAM 612 detects multi-dimensional deviation severe enough to bypass the monitoring state entirely. In one embodiment, when a relationship in S2 exhibits simultaneous deviation across multiple dimensions (e.g., a sudden large increase in transaction amounts combined with a shift to lump-sum invoicing and the appearance of unfamiliar relationship attributes), the resulting risk weight from SRWE 614 exceeds the gating threshold directly, and CSM 625 transitions the relationship from S2 to S4 without passing through S3. This pathway ensures that severe deviations trigger immediate gating rather than gradual escalation.

T10—Severe Deviation (S5→S4). Transition T10 is the trusted-relationship analog of transition T9. In one embodiment, when a relationship in S5 exhibits multi-dimensional deviation severe enough to bypass the monitoring state, CSM 625 transitions the relationship directly from S5 (Verified/Trusted) to S4 (Conditional/Held). Earned trust does not insulate a relationship from immediate gating when severe deviation is detected. The relationship must then remediate from S4, pass through S3, return to S2, and re-earn trust over time before reaching S5 again.

T11—Remediation Failure (S4→S6). Transition T11 is triggered when the remediation process in S4 fails. In one embodiment, failure occurs when Document Evidence Manager 626 reports that the evidence package has reached a terminal state of Rejected/Insufficient (i.e., the evidence submitted did not address the compliance concern) or Expired (i.e., no sufficient evidence was submitted within the required timeframe), or when an analyst reviewing the case through Case Management Module 628 denies the case. CSM 625 transitions the relationship to S6 (Suspended/Locked), and all transactions are blocked. ARM 675 records the failure, including the specific evidence deficiency or analyst rationale that triggered the transition.

T12—Formal Reinstatement (S6→S4). Transition T12 represents the re-entry pathway for a suspended relationship. In one embodiment, T12 requires that the condition that led to suspension has been resolved—for example, a sanctions match has been determined to be a false positive, a regulatory bar has been lifted, or new information has been received that addresses the compliance concern. Screening & Controls Orchestrator 616 performs updated screening, and Case Management Module 628 conducts a formal reinstatement review requiring analyst approval. CSM 625 executes the transition only upon explicit authorization, recorded by ARM 675.

It should be noted that T12 returns the relationship to S4 (Conditional/Held), not to S2 (Active/Clear). This is an architectural decision: a reinstated relationship must earn its way back through the state machine. It must satisfy the preconditions imposed in S4, demonstrate clean operation in S3 (via T13 and then T6), and return to S2 before normal operation resumes. This constraint ensures that reinstatement is the beginning of a re-verification process, not the end of it.

T13—Successful Remediation (S4→S3). Transition T13 is triggered when the remediation process in S4 succeeds. In one embodiment, DEM 626 reports that the evidence package has reached a terminal state of Validated (i.e., the evidence submitted addresses the compliance concern at the line-item level), SRWE 614 has recalculated the risk weight reflecting the new evidence, and any required analyst review through CMM 628 has resulted in a favorable disposition. PCE 620 confirms that all preconditions have been satisfied, and CSM 625 transitions the relationship to S3 (Monitored).

It should be noted that successful remediation transitions to S3 (Monitored), not to S2 (Active/Clear). The relationship has demonstrated that it can satisfy compliance requirements when gated, but it has not yet demonstrated sustained clean operation in the absence of gating. Enhanced monitoring in S3 continues until the relationship demonstrates consistent return to baseline (via BDAM 612 and PIMRM 660), at which point it may transition to S2 via T6. This staged return ensures that remediation is not treated as a one-time fix, but as the beginning of a recovery period.

T14—Permanent Closure (S6→S7). Transition T14 is triggered when a suspended relationship is determined to be permanently closed. In one embodiment, this determination is made through Case Management Module 628 based on confirmed fraud, a regulatory directive to terminate the relationship, or a business decision by the obligated party. CSM 625 transitions the relationship to S7 (Archived/Retired). All history is retained in ERG 610 and remains available through ARM 675 for examination and audit purposes.

### Grouped Transitions

In addition to the named transitions described above, state diagram 700 includes three grouped transitions, each of which represents a set of transitions from multiple source states to a common target state. These are illustrated as dashed arcs in FIG. 7.

T-RO—Re-Onboarding (S2, S3, S4, S5, S7→S1). The Re-Onboarding transition returns a relationship to S1 (Onboarding) from any of states S2, S3, S4, S5, or S7. In one embodiment, this transition is triggered by events such as annual re-verification requirements, a need to complete interrupted onboarding, or the reactivation of a dormant relationship from S7.

It should be noted that S6 (Suspended/Locked) is excluded from the Re-Onboarding transition. A suspended relationship cannot re-onboard until it has first been reinstated to S4 via transition T12. This constraint ensures that the conditions that led to suspension are formally addressed before the relationship can re-enter the onboarding process.

As noted above with respect to state S1, re-onboarding is architecturally distinct from initial onboarding. ERG 610 retains full prior history, so all modules operate with the benefit of the relationship's complete record rather than starting from a blank slate.

T-HB—Hard Block Event (S2, S3, S4, S5→S6). The Hard Block Event transition moves a relationship to S6 (Suspended/Locked) from any active state (S2, S3, S4, or S5). In one embodiment, this transition is triggered when Screening & Controls Orchestrator 616 identifies an absolute bar—such as a new sanctions designation, a regulatory prohibition, or another condition that requires immediate and unconditional blocking of all transactions.

The Hard Block Event overrides all prior compliance posture, including earned trust in S5. This is by design: certain regulatory and legal obligations (e.g., sanctions compliance) are absolute and cannot be modulated by the relationship's prior history. CSM 625 executes this transition immediately upon receiving the screening result from SCO 616, and ARM 675 records the event, the screening basis, and the prior state from which the relationship was transitioned.

T-VT—Voluntary Termination (S2, S3, S4, S5→S7). The Voluntary Termination transition moves a relationship to S7 (Archived/Retired) from any active state (S2, S3, S4, or S5). In one embodiment, this transition is triggered by inactivity timeout (e.g., no transaction activity for a period of time defined by PCE 620) or by formal termination notice from the initiating party or the obligated party. CSM 625 transitions the relationship to S7, and ARM 675 records the termination event. All history is retained in ERG 610 and remains available for examination, audit, and potential future re-onboarding.

### Architectural Invariants

In one embodiment, state diagram 700 imposes several architectural invariants that constrain the permissible transitions and ensure the integrity of the compliance process.

First, S5 (Verified/Trusted) is reachable only from S2 (Active/Clear) via transition T4. No other state can transition directly to S5. A relationship that has been gated (S4), monitored (S3), suspended (S6), or archived (S7) must first return to S2 and demonstrate sustained clean operation before trust escalation is possible. This invariant ensures that earned trust reflects a genuine sustained track record, not a shortcut through remediation or reinstatement.

Second, S6 (Suspended/Locked) must be reinstated to S4 (Conditional/Held) via transition T12 before the relationship can re-enter normal states. A suspended relationship cannot transition directly to S2 or S3, and cannot re-onboard via T-RO. This invariant ensures that suspension conditions are formally addressed, and that the reinstated relationship must earn its way back through the state machine.

Third, successful remediation from S4 returns to S3 (Monitored) via transition T13, not to S2 (Active/Clear). This invariant ensures a staged recovery: the relationship must demonstrate sustained clean operation under enhanced monitoring before returning to normal operation.

Fourth, S7 (Archived/Retired) is not terminal. Relationships can re-enter the lifecycle via T-RO to S1, with full prior history preserved in ERG 610. This invariant ensures that dormancy does not destroy institutional knowledge about a relationship.

Fifth, transition T4 (Trust Escalation) is time-based, not event-based. Trust is earned through the sustained absence of adverse events, not through the occurrence of a favorable event. This invariant ensures that trust reflects genuine sustained compliance rather than a momentary positive signal. Nevertheless, in other embodiments, trust is earned in a conditions-based manner apart from time (e.g., successfully clearing a threshold number of clean transactions without detection of any significant deviation or risk decay).

These invariants are enforced by Compliance State Machine 625 in conjunction with the transition criteria defined by Policy & Compliance Engine 620. They are not procedural guidelines; they are structural constraints of the system's architecture (though individual structural constraints may vary across embodiments without departing from the spirit of the present invention). Audit Reporting Module 675 records every transition and every invariant-enforcement event, providing the obligated party with a contemporaneous record demonstrating that the state machine operated as designed.

Having described the static components and dynamic operations of key modules of system 500, the following specific scenarios will be explored in order to better illustrate key advantages of the present invention. While no such descriptions can feasibly be exhaustive, they will serve to illustrate the many instances in which the present invention alleviates existing overreliance on human judgment and intervention by deriving meaning from context in an automated fashion.

### Scenario 1 Anomaly—Quantity Mismatch Between POs and Invoices

This first scenario illustrates a common anomaly in which the quantities of items ordered from a supplier varies (or, in some cases, only appears to vary) from the quantity of items specified in one or more invoices. The “quantity” relationships between POs and invoices are but one example of DDRs in that they often occur in the context of many-to-many relationships—e.g., multiple POs reflected on a single invoice or a single PO reflected in multiple invoices.

As a result, it is often difficult (even for humans) to identify, much less reconcile, mismatches between the quantities of items ordered (across one or more POs) and those reflected in one or more invoices. Additional context (often reflected in other related documents) may be necessary to detect and resolve such anomalies.

In this scenario, a company (ACME Corp) orders personal computers (PCs) for its employees from a supplier (ACE Technologies). As shown in Table 1 below, two employees (Bob and Jane) request PCs from ACE for their business use. Per company policy, they typically order PCs via requests to Alice, ACME's procurement officer, who issues POs to Steve, an ACE salesperson. ACE typically sends advanced shipping notices (ASNs) to Frank in ACME tech support before shipping products. ACE typically sends invoices for shipped products to Sam in ACME's AP department.

The actions performed by ACE and ACME employees in this scenario are summarized in Table 2 below. Note that these actions are described in chronological order in this example. Each documented action is submitted to system 200 for processing as it occurs in one embodiment. In other embodiments, packages of one or more documents (not necessarily in chronological order) are submitted to system 200 for processing at various points in time.

In any event, system 200 captures relevant dates and times as part of its overall process, enabling it to receive and process documents regardless of the order in which they were submitted. It should be emphasized that the capability of system 200 to determine when to reinvoke TSAgents 210 automatically is of particular significance with respect to its ability to process documents successfully when they are submitted “out of order” to system 200.

The first action in this scenario involves Bob emailing Alice with a request to order a single PC. In one embodiment, this email is submitted promptly (and in some cases automatically) to system 200 for processing. Alice in turn generates a PO for that PC, which she sends to Steve at ACE. This PO is also submitted to system 200 for processing.

Note that system 200 captures the relevant data from this email and PO, as well as classifying these two documents accurately. While this aspect of the process appears to be relatively straightforward, it may require the use of CSD by Capture and Classification Engine 110 (as discussed above). For example, in one embodiment, the email and/or PO may have been manually printed and copied in a manner that accidentally created a mirror image of the actual document. Capture and Classification Engine 110 is trained to employ CSD to recognize common field locations and values, and thus properly capture and classify the email and PO (in an analogous manner to that of a human performing that Task).

At this point in time, it should be noted that system 200 iteratively performs other Document-Processing Tasks regarding these two documents, including (among other steps) updating Knowledge Graph 225 and invoking Anomaly Detector 235 to search for anomalies. As is usually the case, no anomalies are detected and system 200 proceeds to subsequent iterations looking for new Events 205. Note that, as mentioned above, the mere passage of time is an Event 205 which will result at least in the updating of Knowledge Graph 225 to reflect that passage of time.

Subsequently, Jane desires to request a single PC. But, in this case, Jane violates ACME company policy and does not submit her request to Alice. Instead, she submits her request directly by phone to Steve at ACE (e.g., because she knows Steve well from frequent prior business interactions). As a result, her phone call is not documented and no PO is generated.

Moreover, even though Jane's order is fulfilled, Sam receives the invoice from ACE for both PCs before receiving any other relevant documents (such as a 2nd ASN, a receipt notice for one or both PCs, etc.). The invoice includes a reference to Jane's order from Steve, but does not include any other identifying information, such as a PO number.

Upon processing this invoice, system 200 employs Capture and Classification Engine 110 to classify the invoice correctly and capture relevant data fields. Matching and Reconciliation Engine 120 matches the first PO to this invoice, as well as the unit price of each PC and other data fields.

However, the total price listed on the invoice is double the PC unit price, and the quantity of 2 PCs does not match the single quantity of 1 PC listed on the PO. In one embodiment, Matching and Reconciliation Engine 120 identifies these “potential errors” and updates Knowledge Graph 225 accordingly, but does not “resolve the mismatch” as being caused by Jane's “out of policy” order. In other embodiments, Matching and Reconciliation Engine 120 effectively detects and resolves this anomaly itself.

In the current scenario, Anomaly Detector 235 identifies an anomaly upon traversing updated Knowledge Graph 225. In other words, based upon its training/experience, it recognizes the “mismatch” between the quantity of two PCs on the invoice and one PC on the only PO it has processed. It also recognizes that the total price on the invoice is double that of the PC unit price, and that a text field contains a reference to a second order from Jane to Steve.

In one embodiment, Anomaly Detector 235 updates Knowledge Graph 225 with the detection of the anomaly, along with potentially relevant metadata regarding the pricing info and reference to Jane's order from Steve. In subsequent iterations, Scenario Controller 202 generates Anomaly Event 246 and invokes Anomaly Resolver 245 to address the anomaly.

Anomaly Resolver 245 traverses updated Knowledge Graph 225 and identifies a likely resolution, based upon its training/experience, by detecting the common pattern of a missing PO number coupled with an undocumented order (i.e., the order from Jane to Steve referenced in a text field of the invoice). It resolves the anomaly by generating a recommendation to Sam that the invoice be paid.

In one embodiment, it updates Knowledge Graph 225 accordingly, causing Narrative Generator 250 to generate a natural-language recommendation to Sam, which Decisioning Engine 275 delivers to Sam after being invoked on a subsequent iteration by Scenario Controller 202. At that point Sam may simply pay the invoice, or may require that additional conditions be met, which it conveys to system 200 via External Communicator 295.

In another embodiment, Anomaly Resolver 245 also updates Knowledge Graph 225 to reflect the matching of Jane's order with the invoice. For example, in this embodiment, system 200 generates a “virtual PO” with a PO number that is also “included” on the invoice. As a result, Knowledge Graph 225 now contains the “missing context” as if Jane had followed ACME policy and issued an actual PO.

In other embodiments, various other actions are performed automatically in a more direct fashion. For example, modules of system 200 automatically generate notifications with suggestions to human staff for approval and/or implementation. Or anomalies may be detected, but not fully resolved until additional information is obtained, such as receipt of a “missing” PO, ASN or other document.

By notifying relevant users of system 200 promptly upon detecting an anomaly (i.e., a potential problem), such anomalies are resolved far more quickly than would otherwise be the case. These and other implementation choices are determined in accordance with standard logistical and engineering tradeoffs, as well as scenario-specific workflow specifications.

TABLE 1

| | | Pro- | | Tech | Other |
|---|---|---|---|---|---|
| ENTITIES | Sales | curement | AP | Support | Employees |
| ACE Technologies - | Steve | | | | |
| SUPPLIER | | | | | |
| ACME Corp - | | Alice | Sam | Frank | Bob, Jane |
| COMPANY | | | | | |

TABLE 2

| HUMAN | DOCU- | |
|---|---|---|
| ACTIVITIES | MENT | COMMENTS |
| Bob requests 1 PC | Email | |
| via Alice | | |
| Alice issues PO to | PO | |
| Steve at ACE | | |
| Jane calls Steve at | *** N/A | No PO - “Out of Policy” |
| ACE | (Tel Call) | |
| ASN from Ace arrives to | ASN | Matches PO |
| Frank re 1 PC | | |
| Sam receives Invoice from | Invoice | Matches PO, PC Unit Price, etc. |
| Ace for 2 PCs | | *** ALSO mentions Jane |
| | | order via Steve |

This scenario illustrates some of the myriad of different situations that are currently handled by human intervention, in which personnel spend significant time and money making the contextual inferences that system 200 performs automatically. While human intervention will likely never be eliminated entirely, system 200 performs much of this groundwork automatically, particularly when context is available (from information within and across documents) from which meaning can be derived.

Additional scenarios described below will further illustrate different aspects and advantages of system 200. In addition to the wide variety of anomalies that system 200 can detect and resolve, it will become apparent that no rules-based pre-programmed system could feasibly “foresee” (employing humans as anomaly detectors and resolvers) the many different types and variations of anomalies whose “patterns” the trained models of system 200 can detect and address.

Moreover, as noted above, it will become apparent that the concepts illustrated by these scenarios with respect to financial business transactions apply equally to other types of personal, business, educational, governmental and other processes, including those outside the financial realm. What they share in common is the processing of tangible “documents” as broadly defined above (i.e., any metadata or attribute of information from which signal can be distinguished from noise to reveal meaning) that contain the context from which meaning can be derived (i.e., the relationships among data within and across such documents that are difficult to discern from the explicit information contained therein).

The continual Event-driven process of system 200 extracts such context from these documents on an iterative basis over time (by employing CSD within Document-Processing TSAgents 210) and derives meaning from such context by detecting and resolving anomalies, as well as interpreting and responding to natural-language requests and directives while implementing scenario-specific workflows. The following additional scenarios illustrate the versatility of these concepts in various different circumstances.

### Scenario 2 Anomaly—Pricing Discrepancy Between Contract and Invoice

This scenario involves the same personnel from ACME and ACE, but in the context of a pricing discrepancy. As described in Table 3 below, ACME and ACE enter into a contract including a section specifying that ACE quotes determine the pricing, and supercede any other contradictory document provisions.

Bob emails Steve at ACE requesting pricing for 1000 widgets. Steve emails a quote back to Bob indicating a unit price of $10. Bob contacts Alice, who issues a PO to Steve for 1000 units at $10 each. After some time passes, Frank receives an ASN from ACE indicating that 1000 units will be shipped at a price of $11 each (due to a recent price increase).

In this embodiment, system 200 processes these documents as they are submitted chronologically. While processing the ASN, Matching and Reconciliation Engine 120 detects the pricing discrepancy between the $11 unit price in the ASN and the $10 unit price in the quote and updates Knowledge Graph 225 accordingly.

Anomaly Detector 235 confirms detection of this pricing anomaly, and additionally detects the potential relevance of the contract section relating to pricing. It updates Knowledge Graph 225 accordingly. In a subsequent iteration, Anomaly Resolver 245 determines that the quoted price of $10 prevails, and addresses the anomaly by notifying Sam of this discrepancy. At this point, Sam elects to notify ACE of this error in an email.

Nevertheless, Sam eventually receives the invoice for $11K (unit price of $11), but does not immediately remember receiving the prior notification from system 200 of this pricing discrepancy, or his follow-up email to ACE. Fortunately, while processing the invoice, Matching and Reconciliation Engine 120 detects this same “mismatch” (unit pricing discrepancy) between the invoice and the PO, and updates Knowledge Graph 225 accordingly.

Once again, Anomaly Detector 235 confirms detection of this pricing anomaly as well as the relevance of the contract section relating to pricing. Note that the prior updating of Knowledge Graph 225 increases the confidence level of this result. Similarly, in a subsequent iteration, Anomaly Resolver 245 reconfirms that the quoted price of $10 prevails (again with greater confidence).

Recognizing that system 200 had already notified Sam, and that Sam had emailed ACE, Anomaly Resolver 245 now resolves the anomaly by making a dual recommendation—i.e., (i) that Sam be notified again of the pricing discrepancy with an updated narrative, but also (ii) that the invoice be disputed due to the $1K overpricing. Anomaly Resolver 245 also updates Knowledge Graph 225 accordingly.

As a result, Narrative Generator 250 is invoked to generate an updated narrative for Sam, which is delivered to Sam (during a subsequent iteration) by Scenario Controller 202 via External Communicator 295. In addition, Scenario Controller 202 issues a Decision Event 276 and invokes Decisioning Engine 275, which confirms the recommendation to Sam that the invoice be disputed (again employing Narrative Generator 250 to generate the updated narrative containing this recommendation). Sam then proceeds to dispute the invoice with ACE, resulting in a payment of $10K per the contract.

In other embodiments, depending upon the scenario-specific workflow, additional actions could be automated, lessening human intervention even further. For example, system 200 could automatically generate and send notifications to ACE, along with payments of undisputed amounts (optionally with Sam's advance approval).

TABLE 3

| HUMAN | DOCU- | |
|---|---|---|
| ACTIVITIES | MENT | COMMENTS |
| ACE and ACME | CON- | Specifies that QUOTE |
| execute Contract | TRACT | determines PRICE |
| Bob emails Steve | Email | Seeking Pricing for 1000 |
| requesting Pricing | | Widgets |
| Steve emails Bob | Email/ | $10K for 1000 Widgets at |
| with Quote | Quote | $10 each |
| Alice issues PO to | PO | ALSO $10K for 1000 |
| Steve at ACE | | Widgets at $10 each |
| ASN from ACE | ASN | *** 1000 Widgets at $11 |
| arrives to Frank | | each (price increase) |
| Sam email to ACE | Email | Error in ASN - Pricing |
| | | should be $10 |
| Sam receives | Invoice | $11K - 1000 Widgets at |
| Invoice | | $11 each |

Note that, in this scenario, system 200 not only automates many of the inferences that typically would require human intervention (such as the detection and resolution of the pricing anomaly), but also provides levels of redundancy that increase the likelihood that such anomalies will be detected. For example, by iteratively updating Knowledge Graph 225, Matching and Reconciliation Engine 120 employs CSD to detect the discrepancy, both while processing the ASN and later while processing the invoice with an updated Knowledge Graph 225.

Moreover, Anomaly Detector 235 and Anomaly Resolver 245 both have opportunities to apply a different type of training to detect and resolve anomalies (focused specifically on anomalies within and across documents, as opposed to common matching and reconciliation Tasks—also within and across documents). The integration with Narrative Generator 250 also affords system 200 with opportunities to generate and target specific notifications and recommendations (all based on an iteratively updated Knowledge Graph 225) to the appropriate users, in accordance with a scenario-specific workflow.

Finally, Decisioning Engine 275 affords yet another opportunity to “close the loop” of resolving an anomaly such as this pricing discrepancy, but targeted to the specific context of key decisions (e.g., paying an invoice). In this manner, the various modules of system 200 work together in an integrated fashion on an Event-driven asynchronous basis continually over time, controlled by Scenario Controller 202 in accordance with a scenario-specific workflow.

### Scenario 3 Anomaly—Volume Discount Discrepancies Between Contract and Invoice

This scenario involves the same personnel from ACME and ACE, but in the context of common discrepancies relating to volume discounts. In this scenario, described in Table 4 below, ACME and ACE enter into a contract, including a volume discount schedule, showing pricing of $30/unit for 1-10 units, $25/unit for 12-25 units and $20/unit for more than 25 units. This pricing is based on the total of orders under a single monthly invoice.

Alice issues a PO to Steve at ACE for 8 units at $30 each. Frank receives an ASN showing that same quantity of 8 units at $30 each. Shortly thereafter, Alice emails Steve with a modification to the PO, adding 4 more units for a total of 12 units. Her email references the volume discount schedule. Steve promptly confirms the modified PO in a return email to Alice.

Soon after, Frank receives an ASN from ACE showing the additional 4 units at $30 each. The ASN does not reference the emails between Alice and Steve.

In this embodiment, while processing the ASN, Matching and Reconciliation Engine 120 does not detect a pricing discrepancy with the $30 unit price in the ASN (as the PO also included a $30 unit price), but it does detect that the additional 4 units do not seem to be reflected in the original PO (and no modified PO has been processed). In other embodiments, Matching and Reconciliation Engine 120 would detect that the PO had been modified (in emails between Alice and Steve) and that pricing had also been modified.

Yet, in this embodiment, no anomaly is detected until the subsequent emails between Steve and Alice have been processed, and Knowledge Graph 225 has been updated accordingly. Upon traversing the updated Knowledge Graph 225, Anomaly Detector 235 detects the pricing discrepancy between the ASN (and original PO) and the updated PO.

Having been trained on interpreting and analyzing contractual provisions, and similar “patterns” of such provisions conflicting with emails, POs, invoices and other documents, Anomaly Detector 235 not only detects this pricing anomaly, but also detects the potential relevance of the key contractual provisions (i.e., the volume discount schedule) and the PO, ASN and emails modifying the PO. All of this information is reflected in its updates to Knowledge Graph 225.

In a subsequent iteration, Anomaly Resolver 245 determines that the volume discounted unit price of $25 prevails for all 12 units, and addresses the anomaly by notifying Sam of this discrepancy. At this point, Sam elects to notify ACE of this error in an email indicating that all 12 units should reflect the discounted $25 price.

Nevertheless, Sam eventually receives the invoice for $360 (12 units at $30 each), and again fails to remember receiving the prior notification from system 200 of this volume pricing discrepancy, or his follow-up email to ACE. Once again, in this embodiment, while processing the invoice, Matching and Reconciliation Engine 120 fails to detect this discrepancy between the $30 unit pricing and the volume discount pricing reflected in the emails between Alice and Steve and in the contract. Nevertheless, it updates Knowledge Graph 225 accordingly.

Fortunately, Anomaly Detector 235 confirms detection of this volume discount pricing anomaly as well as the relevance of the emails and the volume discount schedule in the contract. As was the case in the prior scenario, the prior updating of Knowledge Graph 225 increases the confidence level of this result. Similarly, in a subsequent iteration, Anomaly Resolver 245 reconfirms that the discounted unit price of $25 prevails for all 12 units (also with greater confidence).

Recognizing that system 200 had already notified Sam, and that Sam had emailed ACE, Anomaly Resolver 245 now resolves the anomaly by making a dual recommendation—i.e., (i) that Sam be notified again of the pricing discrepancy with an updated narrative, but also (ii) that the invoice be disputed due to the $60 overpricing. Anomaly Resolver 245 also updates Knowledge Graph 225 accordingly.

As a result, Narrative Generator 250 is invoked to generate an updated narrative for Sam, which is delivered to Sam (during a subsequent iteration) by Scenario Controller 202 via External Communicator 295. In addition, Scenario Controller 202 issues a Decision Event 276 and invokes Decisioning Engine 275, which confirms the recommendation to Sam that the invoice be disputed (again employing Narrative Generator 250 to generate the updated narrative containing this recommendation). Sam then proceeds to dispute the invoice with ACE, resulting in a payment of $300 per the volume discount schedule, as opposed to the erroneous $360 invoice (inflated due to an error in failing to implement the volume discount once the order had been modified from 8 to 12 units).

TABLE 4

| HUMAN | DOCU- | |
|---|---|---|
| ACTIVITIES | MENT | COMMENTS |
| ACE and ACME | CON- | Volume Discount Schedule - |
| execute Contract | TRACT | based on Invoice |
| | | $30/unit for 1-10 units |
| | | $25/unit for 12-25 units |
| | | $20/unit for more than 25 units |
| Alice issues PO to | PO | Quantity of 8 units at $30 each |
| Steve at ACE | | |
| ASN from ACE | ASN | Shows Quantity of 8 units at |
| arrives to Frank | | $30 each |
| Alice email to Steve | Email | Modifying PO - adds 4 more |
| | | units (12 total) |
| | | References Volume Discount |
| | | Schedule |
| Steve email to Alice | Email | Confirms Modified PO |
| ASN from ACE arrives | Email | Error in ASN - shows 4 units |
| to Frank | | at $30 each |
| Sam email to ACE | Email | Error in ASN - all 12 units |
| | | should be $25 each |
| Sam receives Invoice | Invoice | $360 (12 × $30) - no mention |
| | | of error |

Note that, in other circumstances, the orders for 8 units and 4 units could be considered distinct orders to be invoiced separately—both at the $30 non-discounted pricing in accordance with the volume discount schedule. In short, the result is dependent upon context, including the timing of the orders.

In this scenario, the emails between Alice and Steve provided the key context that enabled system 200 to infer that the discounted unit price of $25 applied (per the volume discount schedule in the contract). In other words, system 200 extracted this context and derived meaning from it in reaching the conclusion that the $30 unit pricing in the invoice was incorrect.

These relationships (between POs, ASNs and invoices on one hand, and the emails and discounted pricing schedule on the other hand) illustrate the concept of DDRs that are even more difficult to discern than those in the prior scenario, in which there was a more explicit discrepancy among the typical documents (i.e., the $10 unit price in the quote and PO, as compared with the $11 unit price in the ASN and invoice).

By making these inferences automatically, system 200 avoids the need for human intervention, which may or may not have resulted in detection of this anomaly, much less automatic correction of the anomaly via prompt natural-language notifications and recommendations to the relevant personnel. Moreover, this scenario further illustrates why it is not feasible for humans to identify the myriad of different types of anomalies and variations thereof and program “rules” to resolve them.

### Scenario 4 Interactive Document Processing

Turning to FIG. 4, screenshot 400 illustrates an embodiment of an interactive session of the present invention in which an AP clerk submits a recent invoice to system 200 for processing. In this scenario, system 200 not only processes the invoice in the manner illustrated above with respect to other scenarios, but also engages in an interactive natural-language conversation with the AP clerk regarding various aspects of the overall scenario (relying on Interrogation Engine 290, among other modules).

It should be noted that, prior to processing this invoice, system 200 has the benefit of an iteratively updated Knowledge Graph 225, which essentially contains the current state of previously processed documents and information from related transactions, such as other payables, bank account balances, etc. In short, this scenario illustrates an automated alternative to the AP clerk having to manually craft and interpret the results of multiple independent structured database queries, or engage in email or telephone conversations with other personnel. In other scenarios, employees throughout a company can engage in similar interactive communications with system 200, and thus avoid having to contact AP clerks or other staff members.

The AP clerk in this scenario simply submits the invoice to system 200 along with a natural-language request to process that invoice. As system 200 proceeds to capture and classify the invoice (displaying an animation illustrating that process), it provides almost immediate results, including the amount of the invoice and vendor name, as well as key summary information.

For example, it indicates (in the form of two checkboxes with checkmarks) that (1) the invoice total falls below the maximum approval limits, letting the AP clerk know that no additional approvals are required in accordance with the scenario-specific workflow; and (2) the risk and fraud scores both fall below predefined thresholds, letting the AP clerk know that no exception-processing is necessary in accordance with the scenario-specific workflow. It also asks the AP clerk whether it would like to see additional details beyond this key summary information, and whether it would like to continue the conversation.

In response, system 200 notes a “new” item description—i.e., one with which it is not familiar, perhaps because it did not see a matching description on a prior PO or other document. It includes the description itself (“AT&T 50 mB DIA circuit”), along with its line number, quantity, unit price and total price.

System 200 also asks whether this line item should be included in the “approver” report (presumably because it is unusual, and might be of interest to the person approving the invoice). The AP clerk responds “Yes” (to instruct system 200 to include that line item in the approver report), to which system 200 responds by noting that the other data in the invoice (taxes, total, payment, etc.) are consistent with prior invoices.

System 200 then proactively asks whether it should “reconcile” the invoice. While it might invoke Matching and Reconciliation Engine 120 in any event, it is essentially asking the AP clerk whether they want to see the results and continue the conversation. Upon getting an affirmative response, system 200 displays an animation of the reconciliation process and then promptly notes that the line-item reconciliation matches a particular PO (#1280), and that all items are account coded. This provides the AP clerk with an immediate indication that no unmatched line items or other anomalies were found. Otherwise, system 200 would have brought those to the attention of the AP clerk.

System 200 then proactively notes that this invoice is due in 30 days, but that another invoice is 45 days past due and asks whether it should be coded for “priority” payment. Upon getting an affirmative response, system 200 responds by indicating that the invoice has been forwarded for payment to the designated approver (again in accordance with the scenario-specific workflow) and that additional details are available in the approver's report.

Upon receiving a “Thanks” from the AP clerk, note that system 200 essentially pauses the conversation, as it has no additional questions or other information to add to the conversation at the present time. Yet, system 200 proceeds with its continual Event-driven process, tracking the passage of time and handling any other Events that may arise (even if not reflected in this particular conversation).

After 3 more minutes have elapsed, the AP clerk continues the conversation by requesting that system 200 generate a month-end report for all invoices approved for payment. Note that this request (like other communications from the AP clerk and others) is received (via External Communicator 195) by Scenario Controller 202, which generates a User Query Event 291 to invoke Interrogation Engine 290. Because Knowledge Graph 225 has been iteratively updated in the interim, the full transcript of the conversation appears as if nothing has changed, with the exception of a new timestamped entry including the natural-language text of the AP clerk's request.

In response, system 200 (with the assistance of Interrogation Engine 290 and Narrative Generator 250, among other modules) promptly indicates that the report is ready to be downloaded (in XL format) and asks whether the AP clerk would like to save the template. Upon receiving an affirmative response, the report is promptly downloaded.

But system 200 also proactively notes that there is an outstanding balance ($123) and that a designated amount (not shown) will be needed to satisfy next week's payable obligations. In response, the AP clerk requests that system 200 pay a designated vendor that amount (based upon the bank account information on record).

Note that the AP clerk need not remember the bank account information or other related information, as this information is known to system 200 via iteratively updated Knowledge Graph 225. As a result, system 200 has all of the information it needs to forward this request along with all relevant information to the relevant personnel who will implement the payment. This process (not shown) occurs promptly, but may require multiple iterations involving various modules, including Interrogation Engine 290, Narrative Generator 250 and Scenario Controller 202, each of which updates Knowledge Graph 225 over time.

In this scenario, the AP clerk also requests that system 200 pay a different vendor the amount due (per a specified invoice number) by issuing a one-time “virtual card.” The reason for this “real time” request is that system 200 just informed the AP clerk of the total amount of payables due next week. So, the AP clerk generated this request to avoid further draining the company's primary bank account given the amount of payables due next week.

System 200 promptly informs the AP clerk that payments are now scheduled for the two specified invoices on designated dates, and provides the AP clerk a link to see payment status for all invoices. In addition, system 200 offers to email the two vendors the company's standard advance payment notice (to their email addresses on record), to which the AP clerk responds affirmatively.

Finally, system 200 proactively notifies the AP clerk that, while $10,456 in payables is due next week, the default account only has a current balance of $9780. It therefore asks whether it should transfer funds, to which the AP clerk responds affirmatively. Note that this natural-language conversation leaves out many (i.e., unnecessary) details that are known to system 200 via Knowledge Graph 225 (e.g., the bank account from which it will transfer funds to refresh the balance of the default account).

In this manner, system 200 eliminates a great deal of human intervention that would otherwise be required to perform these various Tasks, including spending a significant amount of time and expense manually generating database queries and engaging in various email and telephone conversations with other personnel. Note also that system 200 not only detects and responds to Events, but also anticipates the occurrence of future Events and hypothesizes the potential occurrence of other Events.

It will be apparent to one skilled in the art from this and other scenarios that the integration of key components of system 200 enables a continual Event-driven system that detects and responds to new Events as new information is obtained (including the mere passage of time) by leveraging the iteratively updated Knowledge Graph 225 to perform lower-level Document-Processing Tasks (e.g., Capture, Classification, Matching, Reconciliation, Verification, Compliance and Coding) as well as Higher-Level Tasks such as Decisioning, Analytics and Interrogation. Without such integration, many of these Tasks could not be automated, which would result in even more frequent need for human judgment and intervention.

### Scenario 5 Inter-Document Analysis-Persistence and Confidence Values

This scenario illustrates practical advantages of various novel aspects of the present invention, including iteratively traversing and updating Knowledge Graph 525, as well as updating confidence values via Confidence Value Adjuster 510. It does so in the context of a common set of financial transactions among companies, including in this abbreviated example three documents relating to each transaction—a PO, an ASN and an invoice. As will be illustrated below, many of the same techniques employed for inter-document analysis are also employed within a single document due to the many inter-field dependencies and relationships even within a single document.

When many companies procure goods and services from one or more suppliers, they generate a PO, an example of which is shown below in Table 5. As alluded to above, the format or template of a given document may vary greatly across companies, and even among (and sometimes within) individual departments of the same company. Document layouts may differ; section or field labels may be missing, or may employ non-standard terminology; and date and currency formats may differ, among many other inconsistencies. In short, it is often difficult for humans, much less automated systems, to identify various attributes of fields, including their role or semantic meaning.

Even the relatively simple Task of matching individual documents to a particular transaction is often far from trivial. For example, a specified PO #may not always be referenced by other documents, requiring other more indirect indicia (e.g., dates, names, amounts, etc.) to be employed to perform an accurate match. While all systems (human and/or automated) may fall short of 100% accuracy with respect to any given Task, it is worth noting that relative accuracy becomes quite important in making decisions with confidence. In this regard, Confidence Value Adjuster 510 plays a significant role in determining when to end the process of identifying field roles and other attributes with respect to a given field (or a document, file, etc.), and when to continue seeking additional information, for example, by reinvoking Tasks based upon a recently updated Knowledge Graph 525.

Looking at Table 5, numerous fields within the PO (and attributes thereof) are identified by Object Segmenter 540, Inter-Object Analyzer 542 and Object Attribute Identifier 550. For example, the relatively organized spacing and layout of the PO enables distinct fields to be delineated by Object Segmenter 540. For example, the field label “PO #” is not only distinct from, but is also related to the value (“2024-1847”) of the PO #field next to it.

Moreover, distinct sections of the PO (such as the “Key Terms” section) are identified and designated as distinct from the individual terms themselves (i.e., individual sentences and sentence fragments separated by semicolons and other spacing, punctuation and other indicia of distinct fields. It should be noted that, even with respect to the delineation of fields of the PO, Object Segmenter 540 does not perform its Tasks in isolation.

For example, Object Segmenter 540 initially may not be confident of the individual terms that are not only distinct from, but essentially components of, the “Key Terms” section label. Depending upon the spacing, punctuation and other factors (including signal such as the use of boldface for certain field labels, identified by Signal Identifier 515), it may delineate the remaining text as a single field, or perhaps sets of multiple fields. Nevertheless, it reflects these tentative conclusions and relationships (e.g., with the individual terms being “part of” the Key Terms section), along with their associated confidence values, in Knowledge Graph 525.

While Inter-Object Analyzer 542 and Object Attribute Identifier 550 process these sections of the document (in parallel, or at least relatively simultaneously, in one embodiment), they benefit from prior processing that resulted in updates to Knowledge Graph 525. When they traverse current Knowledge Graph 525, they may determine that certain fields represent distinct individual terms, perhaps even despite punctuation arguing otherwise.

For example, employing CSD, Inter-Object Analyzer 542 determines that the term “Per RFQ-2024-0892” is semantically distinct from the term “no partial shipments without approval” in part due to fact that these are common terms that have very different meanings. The punctuation (e.g., semicolon separators) further enhances the confidence value of this interpretation. In an alternative scenario in which such punctuation was missing, a different conclusion still might not be warranted, though the relevant confidence values might be lower.

Similarly, many tentative conclusions are supported by contextual layout, despite missing column headers and other labels. For example, even if the title “Purchase Order” were missing from this document, File Content Classifier 530 likely would have classified this document as a PO, though perhaps not initially. Once the context is extracted by individual field analyses (e.g., recognizing an identifier that has a common PO #format, distinct Buyer and Vendor fields, a “Req by” date, product line items, etc.), and reflected in updates to Knowledge Graph 525 (along with associated confidence values), system 500 reinvokes File Content Classifier 530 to increase the confidence value of the document's classification as a PO (e.g., as opposed to a different conclusion, or merely low confidence values among potential conclusions).

Moreover, the “2024-1847” value is likely interpreted as the PO #(a common field) due to its location in the document and its proximity to a date (likely interpreted as the PO Date, another common field). The “$23,400” value by itself (i.e., not in proximity to other monetary values) may or may not initially be interpreted as the total value of the PO. Here too, once other values are interpreted (e.g., by summing quantities and unit prices), the confidence that $23,400 represents the PO Total increases significantly.

It should be noted that such interpretations are not trivial, as they also require iterative interpretations over time, each of which affects confidence values and relationships in updated versions of Knowledge Graph 525. For example, without column headers, it may not be evident initially that the prices at the end of each row are in fact Unit Prices, as opposed to Unit Subtotals for the specified quantity of a particular unit. Is $12.50 the price of a single “ST-450” bracket, or the total price of 500 such brackets?

Here too, as individual fields are interpreted with relatively higher confidence values (e.g., the unspecified “Quantity” column, or the unspecified “Unit of Measure” column), it becomes clearer that the “EA” reference indicates that the $12.50 price represents the price for each ST-450 bracket, as opposed to the price for 500 such brackets, or boxes or other units of measure. Common pricing amounts also provide further evidence supporting a higher confidence value for that conclusion. So, even if the relative confidence values did not clearly support designating the $12.50 price as a Unit Price, as opposed to a Unit Subtotal price, subsequent Quantity and Unit of Measure designations in Knowledge Graph 525 (with corresponding high confidence values) result in a reinvocation of the analysis of the $12.50 price designation (now more clearly a Unit Price), which in turn results in a modification of confidence values by Confidence Value Adjuster 510 and a further update to Knowledge Graph 525.

In short, the benefit of the iterative nature of the present invention (even within a single document, but moreso across documents) cannot be overstated. As one module traverses Knowledge Graph 525 to facilitate its analysis (e.g., of individual fields or other objects), it identifies field attributes and relationships, along with corresponding confidence values.

By updating Knowledge Graph 525 (as well as Confidence Value Adjuster 510, directly or indirectly) with these interim results, it provides the framework for the same or other modules to perform similar analyses, but with the benefit of this iteratively increasing base of knowledge. Tentative conclusions are iteratively reassessed and potentially modified, with their respective confidence values decreasing or increasing as warranted.

This “chain reaction” continues until sufficient confidence value thresholds 570 have been met (whether with respect to fields or other objects within a document, file contents within a file, or otherwise across documents, transactions and other Tiers of information). As a result, human intervention is reduced to a significant extent.

TABLE 5
Purchase Order

| | |
|---|---|
| Buyer | ACME Corp |
| | 1500 Industrial Pkwy, Bldg A, Austin, TX 78758 |
| | (512) 555-0100 |
| Vendor | ACE Corp Req By Dec. 15, 2024Terms Net 30 |
| | 2800 Manufacturing Dr, Phoenix, AZ 85034 (602)-555-0200 |
| Ship to | ACME Receiving, Dock 3, 1500 Industrial Pkwy, Austin, |
| | TX 78758 |

2024-1847
Nov. 18, 2024
$23,400

| | | | | |
|---|---|---|---|---|
| ST-450 | SS Mounting Bracket | 500 | EA | $12.50 |
| WDG-1000 | Control Widget Assembly | 1000 | EA | $8.75 |
| CBL-6-BLK | Cable Assembly 6 ft Black | 250 | EA | $15.00 |
| PSU-24V-5A | Power Supply 24 V 5A | 100 | EA | $42.00 |

Key Terms: Per RFQ-2024-0892; no partial shipments without approval; including packing slip with PO #; Warranty per MSA Mar. 15, 2024; taxes and shipping charges included in total

Having discussed this process so far only with respect to the PO in Table 5, this scenario becomes even more illustrative as additional documents are considered. It should be noted that system 500 may encounter documents in virtually any order over time. They could be part of the same or a different transaction, or the same or a different file, and may be provided as a batch of documents, or only as they occur in the normal (or delayed) timeline of various companies' transactions.

In this scenario, system 500 eventually encounters an ASN (Advance Shipping Notice), shown in Table 6 as a related document to the PO from Table 5—i.e., part of the same transaction. Upon encountering this ASN, system 500 performs much of the same analyses as described above with respect to the PO (which may or may not have been processed previously). For example, File Content Classifier 530 determines that this document is an ASN (whether initially, or after subsequent processing of its individual fields (i.e., Intra File Content Iteration 545) by, for example, Object Segmenter 540, Inter-Object Analyzer 542 and Object Attribute Identifier 550.

As noted above, multiple iterations of field analyses may be required to reach this conclusion with sufficient confidence. For example, modules trained on many similar financial document samples employ CSD to identify the particular types and combinations of fields most commonly found in ASNs, such as “Shipper,” “Customer” and “Ship To” field labels, as well as estimated delivery timeframes.

In any event, these modules identify other fields, such as “2024-5829” which is located next to an otherwise isolated date field (“Dec. 2, 2024”), leading to at least a tentative conclusion that these are the ASN #and ASN Date fields. The “EST Delivery” date of Dec. 5, 2024 adds further confidence to this tentative conclusion given that the date of the ASN routinely precedes the estimated date of delivery.

However, the “Pkgs/Wt” field label is next to the corresponding value of that field, which contains a text string (“8 Cartons|485 lbs.|BOL ACE 20241847”) that likely requires a more complex and iterative analysis. Ultimately, individual field values will likely be parsed, based in part upon the “|” separators and relative locations of objects. One such field represents the Total Cartons shipped (i.e., 8), a conclusion that is supported by the values in the “Pkg” column (confirmed by information that separate items were individually included in Cartons 1-2, 3-6 and 7 and 8). Moreover, the string “485 lbs.” is also identified as a distinct value for Shipment Weight.

Yet, the string “BOL ACE 20241847” represents a unique challenge, despite the relatively simple conclusion that it is an ACE bill of lading. The “20241847” value in this case represents not only the Bill of Lading Number, but also a reference to the corresponding PO. If system 500 encounters the ASN before the PO, it has no clear evidence of a matching PO. It does, however, know (from its training) that Bill of Lading Numbers often include PO #references. Moreover, it identifies other indirect indicia that could potentially be used for a future match (e.g., line-item IDs and descriptions, dates, etc.).

In this embodiment, it stores information regarding these actual and potential relationships in Knowledge Graph 525, but cannot with sufficient confidence link it to a PO, if one even exists. If and when system 500 encounters the PO, it traverses current Knowledge Graph 525 and finds a match between the PO #field of the PO and the Bill of Lading Number field of the ASN, thus confirming with high confidence that the PO and ASN belong to the same transaction.

Note that, if system 500 first encounters another PO, even with identical or very similar products and quantities, it may well find a mismatch with the PO #field of that PO (as well as dates suggesting different transactions), leading to a very low confidence of a match. Moreover, as discussed below, subsequent documents, particularly those belonging to the same transaction, may well bolster even a high confidence value as processing continues within or across files.

TABLE 6
Advance Shipping Notice

| | |
|---|---|
| Shipper | ACE Corp |
| Customer | ACME Corp |
| Est Delivery | Dec. 5, 2024 |
| Tracking | 7849 2847 3921 |
| Pkgs/Wt | 8 Cartons \| 485 lbs \| BOL ACE 20241847 |
| Ship To | ACME Receiving, Dock 3, 1500 Industrial Pkwy, Austin, |
| | TX 78758 |
| Bill To | ACME A/P, 1500 Industrial Pkwy, Bldg A, Austin, |
| | TX 78758 |

2024-5829
Dec. 2, 2024

| | | | Qty | |
|---|---|---|---|---|
| Part | Description Qty | Ord | Ship | Pkg |
| ST-450 | SS Mounting Bracket | 500 | 500 | |
| Cartons 1-2 | | | | |
| WDG-1000 | Control Widget Assembly | 1000 | 1000 | Cartons 3-6 |
| CBL-6-BLK | Cable Assembly 6 ft Black | 250 | 250 | Carton 7 |
| PSU-24V-5A | Power Supply 24V 5A | 100 | 100 | Carton 8 |

Note:
Inspect on receipt; report damage/discrepancies within 24 hrs.

As this scenario continues, consider yet another document encountered by system 500, an Invoice illustrated in Table 7. Here too, even without the “Invoice” document title, system 500 identifies many fields and field labels common to invoices, such as “Bill To” and “TOTAL” field label, and bank wire instructions, including an Acct Number and Routing Number. File Content Classifier 530 therefore classifies this document as an invoice with a fairly high confidence value.

Moreover, subsequent field analyses (e.g., by Object Segmenter 540, Inter-Object Analyzer 542 and Object Attribute Identifier 550) result in the identification of other amounts (for “Industrial Components . . . ” and “Shipping and Handling . . . ”) which together equal the TOTAL field, further bolstering the confidence value that this document is an invoice and that it matches the PO and ASN documents (assuming that they had previously been processed and integrated into Knowledge Graph 525).

Other evidence (Signal) in this Invoice increases the confidence value of these conclusions, such as matching item subtotals (though not without additional calculations of unit quantities and prices), closely matching Invoice #and ASN #fields, date timeframes, etc. As noted above, even if system 500 encountered this Invoice before the PO and ASN, these relationships (and some potential relationships) are still integrated into Knowledge Graph 525. When the same modules ultimately analyze the PO and/or ASN (after traversing current Knowledge Graph 525), the relevant relationships enabling matching of these documents will be identified, and confidence values for such relationships will be increased.

Thus, inter-document analyses further reveal such otherwise “hidden” context, enabling the identification of field attributes, including field labels, values, Tiers (e.g., distinguishing field-level, document-level and transaction-level fields) and, perhaps most importantly, field roles. Identifying the roles of particular fields facilitates the normalization of field labels across documents, transactions, files, etc. (e.g., where such labels are missing or utilize different terminology across companies or even departments of the same company). Such normalization facilitates the Tasks of matching fields semantically, as well as reconciling identified anomalies.

Moreover, whenever ambiguities arise (which is very common in the course of processing documents, and even fields within a document), many iterations may be required before sufficient confidence values reveal the appropriate solution with sufficient confidence. Knowledge Graph 525 and Confidence Value Adjuster 510 together facilitate the iterative attainment of an equilibrium that yields sufficiently confident conclusions.

It should be noted that identifying conflicting information and other anomalies, as well as ambiguities, involves essentially the same process as identifying, matching and verifying consistencies among fields and documents, which is by far the norm. Modules are trained to identify “normal” circumstances and conventions as well as various anomalies that result from human error (e.g., OCR and data entry) as well as intentional deception and fraud.

TABLE 7
Invoice

| | | | | | |
|---|---|---|---|---|---|
| Seller | ACE Corp | Invoice # | 5829-A | Date | Dec. 3, 2024 |
| Bill To | ACME Corp | Due | Jan. 2, 2025 | Terms | Net 30 |

| | | | |
|---|---|---|---|
| Account | ACME-847 | Ship to | ACME Corp, Austin, TX |

| | |
|---|---|
| Seller Addr | 2800 Manufacuring Dr, |
| | Phoenix, AZ 85034 \| (602) 555-0200 |
| Industrial Components - | $22,950 |
| November Order | |
| Shipping & Handling | $450 |
| (FedEx Priority, 8 cartons, | |
| 485 lbs) | |
| TOTAL | $23,400 |
| Payment: | Wire/ACH to Bank of America |
| Account Number: | 8472-9384-7293 |

Expanding upon this scenario, consider a common set of transactions (each involving, among other documents, a PO, ASN and Invoice, such as those shown in Tables 5, 6 and 7). Over time, such transactions often share many similarities, such as consistent unit IDs and quantities, and relatively consistent timelines from PO to ASN to Invoice, perhaps spread over multiple different suppliers.

One common type of fraud, highlighted in this scenario, involves the use of fraudulent bank Routing Numbers and Account Numbers. Imagine a rogue accounting employee of a supplier, such as Ace Corp, who desires to employ fraudulent Routing Numbers and Account Numbers on occasion to funnel money into accounts he controls.

In a simple case, Ace Corp may utilize the same Routing Numbers and Account Numbers for transactions with Acme Corp, and perhaps other companies as well. The employee may simply select one Invoice (over the course of many similar transactions) to modify these numbers to route payment to a Bank of America account in another city opened under the “Ace Corp” name. In more complicated cases, these numbers may routinely change, making the detection of a pattern more difficult to detect.

In any event, system 500 stores these relationships in Knowledge Graph 525, facilitating detection of anomalies (e.g., changes in a recurring pattern) in situations that humans and other automated systems often fail to detect. While automating the process of anomaly detection for a known type of anomaly may be feasible, it is practically impossible to foresee each type of fraud that clever criminals may employ. As noted above, programming “rules” for fraud detection (among other Tasks) is often a futile endeavor that may achieve some level of success, but is ultimately bound for failure as methods of fraud become more sophisticated and this “cat and mouse” game becomes a losing proposition.

System 500 employs an alternative (or at least a supplement) to any rules-based approach. It instead relies on its training of modules to detect common anomalies, even without awareness that any particular fraudulent method is being employed. Moreover, independent validation of conclusions (whether from data being processed, or from external data sources) is an inherent part of the process (e.g., via Verification and Compliance Engine 122). For example, a rogue Routing Number may (via a third-party data source) be revealed to be one not employed by a particular supplier, leading to identification of this particular anomaly.

### Scenario 6 Intra-Document Analysis in a Non-Financial Transaction Context

As noted above, scenarios involving a single document often present many of the same challenges as those involving multiple documents processed over time. For example, even a single-page form may include many inter-dependent fields that cannot be processed accurately in isolation. Assessing the role or semantic meaning of one field often requires accurate knowledge of relationships among various other fields, even on the same form.

Moreover, many forms are designed for ease of data entry, as opposed to semantic interpretation, which can be difficult for humans as well as automated systems. Even relatively standard templates do not necessarily employ consistent terminology, further exacerbating the problem of interpreting line-item fields within a form. Reliance on layout, spacing, punctuation and other Signal (e.g., the use of boldface font styles) becomes significant in accurately assessing field attributes.

Finally, as also noted above, these problems are not limited to the area of financial transactions. Virtually any field or industry spawns tangible information (i.e., documents) that present challenges to a system that endeavors to automate interpretations of such information with significant accuracy.

Consider, for example, a relatively common Patient Medical History & Medication Record Form, as illustrated in Table 8 below. A doctor, before seeing a patient for a routine medical examination, would analyze such a form to confirm that medication dosages are within safe ranges, and that the patient's medical history does not present any significant anomalies suggesting a dramatic change in treatment.

Yet, certain subtle discrepancies are often “buried in hidden context” in a form that might appear normal on the surface, but emerge only upon a more complex analysis of inter-field relationships. An automated process that could identify such subtle discrepancies would constitute an extremely valuable tool that a doctor could employ to supplement his in-person examination of patients.

On the surface, this form in Table 8 appears internally consistent, and does not raise any obvious red flags. For example, consider the patient's smoking history. The patient, Sarah Michelle Thompson, was born on Mar. 15, 1985, and is 39 years old at the time of her Dec. 10, 2024 appointment. She quit smoking in 2010 after smoking for 20 years (roughly ¾ of a pack daily to reach 15 pack-years), which seems believable.

But, closer examination reveals a subtle discrepancy. Sarah smoked for 20 years prior to quitting in 2010 (when she turned 25), and therefore must have started smoking at age 5. While this is possible, it is highly unlikely. Upon processing this form, system 500 identifies individual field relationships (e.g., year of birth, year of quitting smoking, duration of smoking) and represents such relationships in Knowledge Graph 525. However, based upon its training, it may well employ CSD to deduce an implicit fact (within the “hidden context” of the explicit information in the form itself) and recognize that a 5-year-old smoker is highly unusual. At the very least, system 500 would notify the doctor of this fact to facilitate the doctor's in-person examination of Sarah.

As also noted above, system 500, even in an intra-doc scenario, may not be able to identify a subtle discrepancy in a “single pass.” In other words, multiple iterations may well be required before it concludes that this single form has been processed with sufficient confidence. For example, while analyzing individual fields, Inter-Object Analyzer 542 and Object Attribute Identifier 550 may identify relationships such as date of birth (matching the “DOB” field label with its neighboring date value (03/15/1985), from which an implicit year of birth (i.e., 1985) may be inferred. Similarly, they may also identify other explicit and implicit relationships, such as year of quitting smoking (2010) and duration of smoking (20 years).

But, they may not identify the anomaly itself (e.g., starting smoking at age 5) until they traverse the current Knowledge Graph 525 having already processed sufficient information from which the year Sarah started smoking can be deduced). Although the “raw data” is present, there is no absolute guarantee that they will infer this fact, much less recognize it as an anomaly. Moreover, it is also possible that Anomaly Detector 135 (a module trained to detect anomalies from many similar documents and other training samples) may be the first to detect this anomaly.

In short, even with respect to intra-document scenarios such as the one presented by this single-page medical form, system 500 employs the same iterative approach to derive meaning from context as it employs in inter-document and other scenarios. The persistent nature of Knowledge Graph 525, coupled with the gradually increasing base of knowledge afforded by Confidence Value Adjuster 510 (including invoking and re-invoking modules as warranted to reassess confidence values until they meet predefined thresholds), facilitates the derivation of meaning from context by system 500.

Another subtle discrepancy in this medical form involves Sarah's Obstetric History. System 500 identifies various facts, including 2 living children (ages 8 and 5), 3 pregnancies (the first in 2018) and complications (miscarriage in 2018 and C-sections in 2016 and 2019). Most of these facts are internally consistent and do not on the surface appear to raise any concern.

However, upon closer examination (e.g., by Inter-Object Analyzer 542 or Anomaly Detector 135), a subtle discrepancy is identified. While it is consistent for Sarah to have had three pregnancies (one of which ended in a miscarriage, and two of which ended successfully via C-section), her first pregnancy could not have occurred in 2018. This purported fact is contradicted by an earlier pregnancy in 2016 which produced her now 8-year-old child.

Only after sufficient processing by system 500 (of this “raw data”) could it identify the presence of this anomaly in the “hidden context” of the medical form. Whether the derived meaning is an inconsistency (suggesting with reasonable certainty that a particular field value on the form is incorrect) or another type of anomaly, or even a conclusion that no anomaly is present among entirely consistent information, system 500 proceeds with its iterative simultaneous analyses of files, documents and fields (and other objects) until sufficient predefined thresholds of confidence values are met.

Yet another subtle discrepancy in this medical form involves Sarah's Surgical History and a finding of “possible appendicitis” from a physical examination. Buried in the hidden context of this form is the fact that Sarah's appendix was removed 9 years ago in 2015. While this discrepancy might appear less subtle on the surface, it should be noted that Sarah's current symptoms and physical examination appeared to suggest appendicitis, and that her doctor recommended imaging.

Here too, the persistent nature of Knowledge Graph 525 facilitates detection of this inconsistency. In one embodiment, system 500 notifies the doctor that appendicitis can be ruled out, potentially preventing an unnecessary imaging procedure.

Finally, another subtle discrepancy in this medical form relates to Sarah's Current Medications, one of which is Amoxicillin. Sarah is currently being treated for a skin rash, and was previously found to be allergic to Penicillin. From her medical history, it is unclear when she was prescribed Amoxicillin and when it was discovered that she is allergic to Penicillin.

Yet again, the persistent nature of Knowledge Graph 500, and the unknown cause of her current rash (e.g., leading to a relatively low confidence value regarding her current diagnosis), leads system 500 to continue processing this medical form until this subtle discrepancy is identified (with learned knowledge that Amoxicillin is a form of Penicillin). Depending on the relative timing of Sarah's prescription for Amoxicillin and the discovery of her rash-related Penicillin allergy, it is not surprising that this inconsistency remained undetected by her doctors, even as her current rash symptoms were being investigated.

Whether Sarah's doctors or any existing automated system eventually would have detected these anomalies, accelerated detection of these problems by system 500 demonstrates significant value. Moreover, even apart from increased accuracy, the saving of time and expense due to the significant reduction of human intervention is also of great value.

By identifying the anomaly of Sarah starting smoking at age 5, system 500 provides additional questions for Sarah's doctor to ask, which at the very least results in corrections to her medical record. The same is true of her pregnancy history, correcting the year of her first pregnancy from 2018 to 2016. In one embodiment, system 500 makes this correction automatically (e.g., in the case of an extremely high confidence value), and then subsequently notifies doctors and other relevant medical personnel.

Similarly, the detection by system 500 of inconsistencies (between Sarah's current imaging recommendation for possible appendicitis and her prior appendectomy, and between her rash-related allergy to Penicillin and her current prescription for Amoxicillin—a form of Penicillin) may well have prevented a costly and unnecessary imaging procedure and significantly reduced the danger to Sarah of continuing to take a medication to which she is allergic.

TABLE 8
PATIENT MEDICAL HISTORY & MEDICATION RECORD

PATIENT INFORMATION
Name: Sarah Michelle Thompson DOB: Mar. 15, 1985 Age: 39 Gender: Female
Phone: (916) 555-2847 Date: Dec. 10, 2024 Reason for Visit: Follow-up for sinus
infection
CURRENT MEDICATIONS

| Medication Name | Dosage | Frequency | Started | Prescriber |
|---|---|---|---|---|
| Lisinopril | 10 mg | Once daily | 2020 | Dr. Chen |
| Metformin | 500 mg | Twice daily | 2022 | Dr. Chen |
| Amoxicillin | 500 mg | Three times daily | Nov. 28, 2024 | Dr. Williams |
| Atorvastatin | 20 mg | Once daily | 2021 | Dr. Chen |

ALLERGIES
Drug Allergies: Penicillin (severe rash), Sulfa drugs (hives)
Other Allergies: Latex (contact dermatitis)
MEDICAL HISTORY

| [symbol] Hypertension (2018) | [symbol] Type 2 Diabetes (2022) | [symbol] High Cholesterol (2020) | |
|---|---|---|---|
| □ Heart Disease | □ Asthma | □ Cancer | |
| □ Stroke | □ Kidney Disease | □ Liver Disease | □ Thyroid Disease |

SURGICAL HISTORY

| Procedure | Year | Surgeon/Hospital | Complications |
|---|---|---|---|
| Appendectomy | 2015 | Dr. Williams, Memorial Hospital | None |
| C-Section | 2016 | Dr. Martinez, Women's Hospital | None |
| C-Section | 2019 | Dr. Martinez, Women's Hospital | None |

SOCIAL HISTORY
Smoking Status: Former smoker, quit 2010 Years Smoked: 20 years Pack-Years: 15
Alcohol Use: Occasional (1-2 drinks/week) Exercise: Walking Walking 3×/week
FAMILY HISTORY

| | | | | |
|---|---|---|---|---|
| [symbol] Diabetes (Mother) | [symbol] Heart Disease (Father) | □ Cancer | □ Stroke | □ Mental Illness |

OBSTETRIC HISTORY
Number of Pregnancies: 3 Living Children: 2 Ages of Children: 8 and 5
Year of First Pregnancy: 2018 Pregnancy Complications: Miscarriage 2018,
C-sections 2016 & 2019
CURRENT SYMPTOMS & PHYSICAL EXAM
Chief Complaint: Persistent sinus congestion, skin rash on arms and chest, itching
Duration: Sinus symptoms 3 weeks, rash 1 week
Other Symptoms: Occasional abdominal pain, lower right side
Physical Exam Findings: Erythematous rash on arms/chest. Sinus tenderness. RLQ
tenderness on palpation, possible appendicitis-recommend imaging
MEDICATION DOSAGE VERIFICATION REFERENCE

| Medication | Safe Dosage Range (Adults) | Within Range? |
|---|---|---|
| Lisinopril | 5-40 mg daily | □ Check if patient dosage is safe |
| Metformin | 500-2000 mg daily (divided doses) | □ Check if patient dosage is safe |
| Amoxicillin | 250-500 mg three times daily | □ Check if patient dosage is safe |
| Atorvastatin | 10-80 mg daily | □ Check if patient dosage is safe |

The following scenarios illustrate the operation of system 600 (FIG. 6) and state diagram 700 (FIG. 7) across various different domains, including financial payment compliance, healthcare claims compliance, and returned correspondence management. Each scenario demonstrates the integrated operation of Continual CSD, Relationship Persistence, Structural Gating and Post-Decision Feedback-four key functional elements that distinguish the present invention from existing rules-based and other automated approaches.

While the entities, document types and compliance obligations differ across these scenarios, the underlying architectural embodiment of the present invention—the modules of system 600 and the states and transitions of state diagram 700—remains the same. The scenario-specific differences are expressed through the policies encoded in Policy & Compliance Engine 620, the screening operations orchestrated by Screening & Controls Orchestrator 616, the evidence requirements managed by Document Evidence Manager 626, and the document types processed by Document Ingestion & Extraction Engine 606.

### Scenario 7 ACH Payment Compliance—Gradual Risk Accumulation and Structural Gating

This scenario illustrates the operation of system 600 in the context of ACH payments, demonstrating how the system detects gradual risk accumulation over time, structurally gates a payment pending evidence collection and validation, and feeds post-settlement outcomes back into future risk assessments. It involves the following entities.

MidState Commercial Bank is the Originating Depository Financial Institution (ODFI)—the obligated party responsible for compliance with Nacha operating rules and applicable BSA/AML regulations with respect to the ACH payments it originates on behalf of its customers. Greenleaf Property Management LLC (the Originator) is a MidState customer that manages approximately 40 residential rental properties and initiates ACH payments to its vendors. Apex Restoration Services Inc. (the Receiver) is a water damage remediation vendor that provides services to Greenleaf.

Onboarding (S1). When MidState first establishes the Greenleaf-Apex payment relationship, Transaction Ingestion Gateway 605 receives Greenleaf's initial ACH payment instruction. Transaction Intake Adapter 605a parses the Nacha-formatted batch file and extracts the individual payment instruction. Originator Context Adapter 605b enriches the instruction with MidState's own data about Greenleaf-account status, entitlements, transaction history, and risk tier. External Signals Adapter 605c fetches current OFAC/SDN screening data, and Screening & Controls Orchestrator 616 performs initial screening against sanctions lists and MidState's internal risk policies.

Document Ingestion & Extraction Engine 606 processes the initial supporting documents—in this case, an itemized invoice from Apex for $6,200 listing specific property addresses, detailed descriptions of water damage remediation work, and individual line items for labor, materials and equipment. DIEE 606 extracts these line items and populates Entity & Relationship Graph 610 with the initial relationship structure: Greenleaf (entity node)→Apex (entity node)→invoice (document node)→individual line items (line-item nodes).

Baseline & Drift Analytics Module 612 operates in baseline-establishment mode, recording the initial behavioral profile: approximately $6,200/month in payment volume, itemized invoices with specific property addresses, detailed line-item descriptions of remediation services, and a single receiving bank account. Structural Risk Weighting Engine 614 computes an initial risk weight based on these data points. Because screening is clear, the risk weight is below threshold, and initial documentation has been processed, Compliance State Machine 625 executes transition T1 (Initial Clearance) and the relationship enters state S2 (Active/Clear). The payment proceeds to Transaction Execution Bridge 650 for submission to the ACH network. Audit Reporting Module 675 records the onboarding, the initial baseline, the screening results, the risk weight, and the state transition.

Active/Clear Operation and Baseline Accumulation (S2, Months 1-4). Over the next several months, Greenleaf submits monthly ACH payments to Apex averaging $6,200. Each payment is processed through the full pipeline: TIG 605 contextualizes the instruction, DIEE 606 extracts line-item data from accompanying invoices, BDAM 612 measures each transaction and document against the established baseline, and SRWE 614 updates the risk weight. Because the transactions are consistent with baseline-similar amounts, itemized invoices with specific property addresses from Greenleaf's known portfolio, detailed remediation descriptions-no deviation is detected. PCE 620 finds no unsatisfied preconditions, and CSM 625 allows each payment to proceed to TEB 650.

This illustrates Continual CSD in operation: DIEE 606 is not merely processing each invoice in isolation, but extracting line-item data that accumulates in ERG 610, building an increasingly detailed picture of what the Greenleaf-Apex relationship looks like when it is operating normally. This is the Relationship Persistence that enables BDAM 612 to measure future transactions against a meaningful baseline.

Meanwhile, Post-Initiation Monitoring & Returns Manager 660 monitors settlement outcomes. Each payment settles successfully with no returns or notices of change. PIMRM 660 feeds these clean outcomes back to SRWE 614, contributing to gradual risk weight decay. This is the Post-Decision Feedback loop operating during normal operation—the system is accumulating evidence of sustained clean operation that will eventually support trust escalation.

Drift Detection (S2→S3, Months 5-8). Beginning in month 5, the Greenleaf-Apex relationship begins to change. Payment amounts increase to approximately $14,000/month. Invoices shift from detailed itemizations to broader descriptions such as “ongoing mold remediation” and “preventive maintenance contracts.” Property addresses become less specific. DIEE 606 extracts these changes at the line-item level, and ERG 610 accumulates the new data alongside the established baseline.

BDAM 612 detects deviation across multiple dimensions: transaction amount deviation (a more than twofold increase), document characteristic deviation (shift from itemized to summary-level invoicing), and line-item commodity profile deviation (shift from specific remediation descriptions to vague categories). The multi-dimensional deviation profile is fed to SRWE 614, which elevates the composite risk weight above the monitoring threshold but below the gating threshold. CSM 625 executes transition T5 (Drift Detection) and the relationship enters state S3 (Monitored).

In S3, payments continue to proceed—the deviation is notable but not yet severe enough to warrant gating. However, ARM 675 activates enhanced logging, recording the specific dimensions of deviation detected. DEM 626 may initiate proactive evidence requests through TIG 605—for example, requesting itemized invoices for the recent months to understand the nature of the increased volume. PCE 620 flags the relationship for periodic review by CMM 628.

It should be noted that no individual transaction in months 5-8 is facially alarming. A $14,000 monthly payment from a property management company to a restoration vendor is not inherently suspicious. What the system detects is the trajectory—the shift from the established baseline—which is visible only because ERG 610 has accumulated the line-item history necessary for BDAM 612 to measure against. This is the value of Continual CSD and Relationship Persistence operating together.

Risk Escalation (S3→S4, Months 9-12). The deviation compounds. Payment amounts increase to approximately $31,000/month. Invoices are now lump-sum statements with no line-item detail. Two payments reference property addresses that do not appear in Greenleaf's known portfolio (as reflected in ERG 610). Most significantly, Apex's receiving bank account changes—and ESA 605c reports that the new RDFI has appeared in recent FinCEN advisories.

BDAM 612 reports compounding deviation across multiple dimensions. SRWE 614 elevates the composite risk weight above the gating threshold, incorporating both the deviation profiles from BDAM 612 and the external signal from ESA 605c. CSM 625 executes transition T8 (Risk Escalation) and the relationship enters state S4 (Conditional/Held).

Structural Gating in Operation (S4, Month 14). In month 14, Greenleaf submits a new ACH payment of $23,500 to Apex. The accompanying document is a single-page PDF with a lump-sum description: “Q4 Remediation Services—Balance Due.” No property address, no itemization, and no work order references.

Because the Greenleaf-Apex relationship is in state S4, this payment cannot proceed to TEB 650. This is Structural Gating: the gating is not a procedural review that can be overridden or bypassed; it is an architectural constraint enforced by CSM 625. The payment is held.

PCE 620 produces a precondition set specific to the compliance concerns that triggered S4: (1) itemized invoices covering months 9-14, with property addresses and line-item descriptions; (2) explanation of the shift from specific remediation work to lump-sum billing; (3) documentation regarding the two payments referencing off-portfolio property addresses; (4) explanation of the change in Apex's receiving bank account. DEM 626 generates a structured evidence request checklist reflecting these preconditions and issues the request through TIG 605.

Evidence Collection and Remediation. Greenleaf responds with additional documentation. DIEE 606 extracts line-item data from the submitted documents. DEM 626 validates sufficiency at the line-item level—not merely that documents have been received, but that the line items explain the drift detected by BDAM 612. For example, if Greenleaf provides itemized invoices showing that the volume increase corresponds to a legitimate expansion of Greenleaf's property portfolio (confirmed by cross-referencing the new property addresses against public records fetched by ESA 605c), and that the bank account change reflects Apex's merger with another firm (confirmed by corporate registry data), DEM 626 validates the evidence package and CSM 625 executes transition T13 (Successful Remediation) to state S3 (Monitored).

It should be noted that successful remediation transitions to S3, not to S2. The relationship has demonstrated that it can satisfy compliance requirements when gated, but it has not yet demonstrated sustained clean operation in the absence of gating. Enhanced monitoring continues in S3. If subsequent transactions return to consistency with an updated baseline, and clean settlements accumulate via PIMRM 660, the relationship may eventually return to S2 (Active/Clear) via transition T6.

Conversely, if Greenleaf fails to provide satisfactory documentation—or provides documents whose line items do not adequately explain the drift—DEM 626 reports the evidence package as Rejected/Insufficient or Expired, and CSM 625 executes transition T11 (Remediation Failure) to state S6 (Suspended/Locked), blocking all future payments.

Post-Decision Feedback. Regardless of the remediation outcome, PIMRM 660 continues to monitor settlement outcomes for all payments that were executed prior to the gating hold. If a return arrives on a payment from month 12—for example, an R10 (Customer Advises Unauthorized) or R29 (Corporate Customer Advises Not Authorized) return-PIMRM 660 feeds this outcome back through the pipeline: ERG 610 is updated, SRWE 614 recalculates the risk weight, and CSM 625 re-evaluates the relationship's compliance state. This asynchronous feedback operates independently of the main transaction pipeline—the return arriving on Tuesday affects the compliance assessment on Wednesday, without waiting for Greenleaf to submit a new payment.

Throughout this scenario, ARM 675 has produced a complete, contemporaneous, relationship-level compliance record. If a bank examiner asks MidState to demonstrate its compliance process for the Greenleaf-Apex relationship, the record shows every transaction processed, every document extracted, every baseline measurement, every risk weight computation, every state transition, every evidence request issued and every response validated—all indexed as a single coherent narrative for a single counterparty relationship over 14 months. This is the contemporaneous compliance record that existing systems cannot produce because they lack the architectural integration of the four functional elements demonstrated by this scenario.

It is important to note that the Greenleaf-Apex relationship is not necessarily fraudulent. Greenleaf may have legitimately expanded its operations. Apex may have legitimately changed banks. The invoicing shift may reflect a transition from project-based to contract-based billing. System 600 does not determine guilt or innocence; it enforces a structured, risk-proportionate compliance process and produces the contemporaneous record demonstrating that the process was followed. The determination of whether the relationship is problematic may, on some embodiments, be a matter for human judgment—but it is human judgment exercised with the full context assembled by the automated pipeline, rather than human judgment reconstructing that context after the fact.

### Scenario 8 Healthcare Claims Compliance—Provider Billing Pattern Drift and Evidence-Driven Gating

This scenario illustrates the operation of system 600 in the context of healthcare claims, demonstrating how the same architecture that manages financial payment compliance applies to a healthcare payer monitoring provider billing patterns over time. It involves the following entities.

Meridian Health Partners (the obligated party) is a regional health insurance carrier that processes claims from contracted providers and is responsible for compliance with federal and state healthcare regulations (including anti-fraud and abuse statutes), as well as its own contractual obligations to plan members and provider networks. Lakeview Orthopedics & Sports Medicine (the initiating party/provider) is a contracted orthopedic practice that submits claims to Meridian for reimbursement. Dr. Renata Solano is a physician at Lakeview whose billing patterns are central to this scenario.

Onboarding (S1). When Lakeview first contracts with Meridian, Transaction Ingestion Gateway 605 receives the initial provider enrollment and credentialing submission. Transaction Intake Adapter 605a processes the enrollment documents. Originator Context Adapter 605b assembles Meridian's own data regarding Lakeview—credentialing status, panel assignments, contracted fee schedules, historical claims volume (if Lakeview was previously contracted), and any prior compliance history. External Signals Adapter 605c checks the OIG List of Excluded Individuals and Entities, the National Practitioner Data Bank, the National Provider Identifier (NPI) registry, and relevant state licensing boards for each provider at the practice.

Document Ingestion & Extraction Engine 606 processes supporting documentation: credentialing applications, DEA certificates, malpractice insurance documentation, board certifications, and the executed provider agreement specifying fee schedules, covered procedures, prior authorization requirements, and compliance obligations. DIEE 606 extracts structured data and populates ERG 610 with the initial relationship structure: Meridian (entity)→Lakeview (entity)→Dr. Solano (sub-entity)→contract terms (document node)→covered procedure codes, fee schedules, and authorization requirements (line-item nodes).

Screening is clear, initial risk is below threshold, and BDAM 612 establishes initial baselines. CSM 625 executes transition T1 and the relationship enters S2 (Active/Clear).

Active/Clear Operation and Baseline Accumulation (S2, Months 1-8). Over eight months, Lakeview submits claims for Dr. Solano's orthopedic services. Each claim is processed through the pipeline: TIG 605 receives X12 837 Professional claim submissions via TIA 605a, and IEE 606 extracts procedure codes (CPT), diagnosis codes (ICD-10), modifier codes, units of service, and billed amounts. ERG 610 accumulates the claim data at the line-item level.

BDAM 612 establishes a behavioral baseline for Dr. Solano's practice: primarily CPT 29881 (arthroscopic meniscectomy), 27447 (total knee arthroplasty), and related evaluation and management codes. Average billed amount per claim, frequency of procedures per patient, ratio of surgical to E&M codes, and distribution across diagnosis codes are all baselined. SRWE 614 maintains a low risk weight. Clean claims adjudication outcomes accumulate via PIMRM 660.

Drift Detection (S2→S3, Months 9-14). Beginning in month 9, DIEE 606 extracts changes in Dr. Solano's billing patterns at the line-item level. Claims increasingly include CPT 20611 (aspiration and/or injection of major joints) billed alongside the primary surgical procedure—a combination that was rarely present in the first eight months. The frequency of modifier 59 (distinct procedural service) increases significantly, often used to unbundle procedures that Meridian's contracted fee schedule covers as a single bundled service. Units of service per claim increase: physical therapy evaluations billed at 4 units where the baseline was 2.

BDAM 612 detects multi-dimensional deviation: procedure code mix deviation (introduction of unbundled codes), modifier usage deviation (frequency of modifier 59 exceeds baseline by a factor of three), and units-of-service deviation. SRWE 614 elevates the risk weight above the monitoring threshold. CSM 625 executes transition T5 (Drift Detection) and the relationship enters S3 (Monitored).

In S3, claims continue to be processed and paid, but enhanced logging is activated in ARM 675, and PCE 620 flags the relationship for periodic review. DEM 626 may initiate proactive requests for medical records for a sample of the flagged claims.

Risk Escalation (S3→S4, Months 15-18). The deviation compounds. DIEE 606 extracts claims showing Dr. Solano billing for procedures at an ambulatory surgery center (ASC) that was not listed as a practice location in the original credentialing—a new facility node in ERG 610 that was not present during onboarding. Multiple patients receive the same sequence of procedures within days (meniscectomy followed by joint injection followed by physical therapy evaluation at 4 units), suggesting a templated billing pattern. The ratio of total billed amount to patient count diverges sharply from both Lakeview's own baseline and peer benchmarks available through ESA 605c.

BDAM 612 reports compounding deviation. SRWE 614 elevates the risk weight above the gating threshold, and CSM 625 executes transition T8 (Risk Escalation). The relationship enters S4 (Conditional/Held).

Structural Gating in Operation (S4). In state S4, new claims from Lakeview for Dr. Solano's services are held—they cannot be adjudicated and paid until PCE 620's preconditions are satisfied. This is Structural Gating: the hold is not a discretionary review flag that an adjudicator can override; it is an architectural constraint enforced by CSM 625.

PCE 620 produces a precondition set: (1) medical records for a specified sample of claims involving modifier 59 unbundling, sufficient to demonstrate that the procedures were in fact distinct services; (2) documentation of Dr. Solano's credentialing and privileges at the ASC facility; and (3) clinical justification for the increased units of physical therapy billed. DEM 626 generates structured evidence requests and issues them through TIG 605.

If Lakeview provides medical records that DEM 626 validates at the line-item level-demonstrating that the modifier 59 usage reflects genuinely distinct procedures documented in the operative notes, that the ASC is properly credentialed, and that the physical therapy units are clinically justified—CSM 625 executes transition T13 (Successful Remediation) to S3 (Monitored). If the evidence is insufficient or expired, CSM 625 executes transition T11 (Remediation Failure) to S6 (Suspended/Locked), and all claims from Lakeview for Dr. Solano's services are blocked pending formal reinstatement.

Post-Decision Feedback. PIMRM 660 monitors claims adjudication outcomes. If claims that were paid before the gating hold result in downstream recoupment requests, denied appeals, or regulatory referrals, these outcomes feed back through the pipeline: ERG 610 is updated, SRWE 614 recalculates the risk weight, and CSM 625 re-evaluates the compliance state. If a previously paid claim is subsequently identified as part of a government investigation (e.g., via an ESA 605c signal from the OIG), the Hard Block Event transition moves the relationship immediately to S6 (Suspended/Locked), regardless of its current state.

This scenario illustrates several properties of the architecture. First, the deviation detected by BDAM 612 is not detectable from any single claim in isolation—it requires the accumulated line-item history in ERG 610 (Relationship Persistence) and the continual extraction and comparison performed by DIEE 606 and BDAM 612 (Continual CSD). Second, the gating in S4 is structural and cannot be bypassed (Structural Gating). Third, the evidence validation performed by DEM 626 operates at the line-item level—it validates whether operative notes support specific modifier 59 claims, not merely whether “medical records” have been received. Fourth, PIMRM 660 closes the feedback loop by feeding adjudication and post-adjudication outcomes back into the system (Post-Decision Feedback).

As with Scenario 7, it is important to note that the system does not necessarily determine whether Dr. Solano's billing practices are fraudulent or abusive, or merely reflect a legitimate change in practice patterns. The system enforces a structured, evidence-driven compliance process and produces the contemporaneous record that Meridian needs when responding to regulatory inquiries, plan audits, or member complaints.

### Scenario 9 Returned Correspondence Management—Pattern Detection and Contextual Response

This scenario illustrates the operation of system 600 in the context of returned correspondence management at a large financial institution, demonstrating how the same architecture applies to an operational process in which context reveals meaning and appropriate response to individual events. This scenario, in particular, illustrates the broad variety of scenarios covered by the present invention. It involves the following entities:

Commonwealth National Bank (the obligated party) is a large regional bank that generates hundreds of thousands of pieces of outbound correspondence annually-statements, tax documents, regulatory notices, checks, and other communications to customers, vendors, and counterparties. A significant volume of this correspondence is returned by the postal service as undeliverable, and Commonwealth is obligated to manage this process in compliance with its internal policies, regulatory requirements (including obligations to deliver certain communications within specified timeframes), and contractual obligations to customers.

Pinehurst Development Group (a commercial customer) is a regional real estate developer with multiple business accounts at Commonwealth. Atlas Construction LLC (a vendor payee) is a general contractor that receives payments from Pinehurst via checks issued through Commonwealth. Margaret Chen is a retail banking customer.

This scenario illustrates three distinct returned mail events involving different entities, each of which requires a different response- and demonstrates how system 600 uses context accumulated in ERG 610 to distinguish among them.

Event 1: Returned Statement for Margaret Chen. Commonwealth's monthly statement to Margaret Chen is returned by the postal service with a “Temporary Away” endorsement. Transaction Intake Adapter 605a processes the returned envelope, extracting the return reason code and the identifying information on the correspondence. Originator Context Adapter 605b assembles Commonwealth's own data regarding Margaret Chen: a retail banking customer for 12 years, no prior returned mail history, all accounts in good standing, and no recent changes to her profile.

BDAM 612 compares this event against Margaret Chen's baseline: zero prior returns over 12 years. Any return is therefore a deviation, but a single return with a “Temporary Away” endorsement, in the context of an otherwise stable 12-year relationship, is mild. SRWE 614 registers a minimal risk weight elevation. PCE 620 produces an automated action: re-send the statement after 30 days and monitor for successful delivery. CSM 625 does not transition the relationship out of S2 (Active/Clear).

PIMRM 660 monitors the outcome: if the re-sent statement is delivered successfully (as reported by delivery confirmation or the absence of a second return within a predetermined period of time), the event is closed and the risk weight decays. If the re-sent statement is also returned, BDAM 612 reports a second deviation, SRWE 614 elevates the risk weight, and CSM 625 may transition the relationship to S3 (Monitored), triggering a proactive address verification request through DEM 626 and TIG 605.

Event 2: Returned Check to Atlas Construction. A vendor payment check issued by Pinehurst through Commonwealth to Atlas Construction is returned as “No Such Number.” TIA 605a processes the returned item. OCA 605b assembles Commonwealth's data regarding the Pinehurst-Atlas relationship: this is the third returned piece of correspondence involving Atlas in the past six months (a statement was returned four months ago, and a tax document was returned two months ago). ERG 610 contains this history because the prior returns were processed through the same pipeline.

BDAM 612 detects a pattern: three returns in six months for an entity that had zero returns in its first two years of relationship. Moreover, DIEE 606 processes the returned items and notes that the return reason has changed across the three events: the first was “Insufficient Address,” the second was “Addressee Unknown,” and the current one is “No Such Number.” The escalating severity of return reasons is itself a Signal extracted by Continual CSD—it suggests not merely a data entry error but a potentially fictitious or abandoned address.

SRWE 614 elevates the risk weight, incorporating both the return frequency and the return reason severity pattern. ESA 605c fetches current address verification data for Atlas, which indicates that the address on file does not correspond to any known commercial entity. CSM 625 executes transition T8 or T9 (depending on the severity thresholds defined by PCE 620) and the Pinehurst-Atlas relationship enters S4 (Conditional/Held).

In S4, the returned check cannot simply be re-sent. More importantly, any future payments from Pinehurst to Atlas are held-including pending ACH payments that might otherwise have been processed without connection to the returned mail event. This is a critical illustration of the value of ERG 610: because the Pinehurst-Atlas relationship is a single persistent object in the graph, a returned mail event affecting that relationship triggers gating consequences that reach across transaction types and processing channels. Without Relationship Persistence, the returned check would be processed as an isolated postal event, and the pending ACH payment would proceed through a completely separate pipeline with no awareness of the return.

PCE 620 produces preconditions: (1) verified current physical address for Atlas, confirmed via independent source (not Pinehurst-supplied); (2) confirmation of Atlas's active corporate registration status; and (3) explanation from Pinehurst regarding the relationship with Atlas. DEM 626 issues these requests through TIG 605.

Event 3: Cluster Detection Across Entities. Independently of the Atlas situation, BDAM 612 detects a broader pattern: within the past 90 days, returned correspondence has increased for four different entities that share a common characteristic in ERG 610—all list addresses within the same commercial office park, and all were onboarded within a six-month window two years ago. Individually, each entity's return history might appear unremarkable. But the cluster pattern—multiple entities, same geographic concentration, similar onboarding timeframe, coincident return timing—is a Signal that emerges only from the graph-level analysis enabled by ERG 610.

SRWE 614 applies a correlation-based risk weight adjustment to all four entity relationships. CSM 625 transitions each of the four relationships to S3 (Monitored) or S4 (Conditional/Held) depending on the individual risk weight of each. DEM 626 issues evidence requests for address verification, corporate registration status, and beneficial ownership information for all four entities. CMM 628 assembles a consolidated case file presenting the cluster pattern to an analyst, who can evaluate whether the cluster reflects a legitimate circumstance (e.g., a commercial office park that was demolished or rezoned) or a potential concern warranting further investigation.

Post-Decision Feedback. PIMRM 660 monitors outcomes across all three events. If Margaret Chen's re-sent statement is delivered successfully, the event closes and risk decays. If Atlas fails to provide a verified address, CSM 625 executes transition T11 (Remediation Failure) and the Pinehurst-Atlas relationship enters S6 (Suspended/Locked). If the cluster investigation reveals that two of the four entities are legitimate (the office park was under renovation) but two are not (no current physical presence at the listed address), the system processes each relationship independently based on its own evidence—one returns to S2 via T13 and T6, while the other proceeds to S6 via T11.

Throughout all three events, ARM 675 produces contemporaneous records: each returned item processed, each context enrichment from OCA 605b, each pattern detected by BDAM 612, each risk weight computation by SRWE 614, each state transition by CSM 625, each evidence request by DEM 626, and each outcome monitored by PIMRM 660. The record demonstrates not only what was done for each individual event, but how the system connected events across entities through the persistent relationship graph.

This scenario illustrates a property of the architecture that is particularly important in the returned mail context: the meaning of a returned piece of correspondence depends entirely on context. A single returned statement for a 12-year customer with no prior returns means something fundamentally different from a third returned item for a vendor with an escalating pattern of return reasons. And a cluster of returns across entities sharing geographic and temporal characteristics means something that no individual return reveals. Existing rules-based approaches to returned mail management—e.g., “flag all returns” or “re-send after 30 days”—treat all returns identically because they lack the contextual substrate (ERG 610), the baseline measurement (BDAM 612), the risk accumulation (SRWE 614), and the state management (CSM 625) necessary to distinguish among them. System 600 distinguishes itself from existing systems because it has accumulated the context necessary to do so.

### Miscellaneous Concepts Across Scenarios

As noted above, the concept of the passage of time as an Event is a significant aspect of the present invention in virtually any scenario. For example, system 200 captures the “due date” of an invoice directly from the document, or perhaps indirectly from other information in that or another document (such as a standard term in a contract or PO stating that invoices are due 30 days from issuance). By tracking time while performing other Event-driven Tasks, system 200 detects when the due date of the invoice is approaching (e.g., 5 days in advance per a predefined configuration or scenario-specific workflow) and notifies appropriate personnel if that invoice remains unpaid.

Moreover, in the event the value of a date (and/or time) field of an invoice was the result of a capture, data entry or other error, such error may go undetected for a period of time—e.g., preventing the invoice from being properly matched to its corresponding PO. Yet, as more documents are processed, system 200 gathers greater evidence that the value of this date field is an anomaly that can be corrected—perhaps by reinvoking Matching and Reconciliation Engine 120. The correction of this error will then enable system 200 to determine when the due date of the invoice is approaching (or, in some cases, that the due date has already passed).

In other scenarios, as alluded to above, a “document” may include an audio recording or other file reflecting a phone conversation between multiple people, such as representatives of a company and one of its suppliers regarding an overdue invoice. As noted above, the processing of that document by a TSAgent 210 may result in the capture of metadata or other Signal relating to the tone of voice of the supplier's representative, which may (in conjunction with other factors relating, for example, to the relative importance of the supplier) escalate the need to pay the invoice promptly.

The importance of context cannot be overemphasized with respect to the present invention. As a simple example, a heavy coffee stain on a paper receipt may prevent many fields of the receipt from being captured properly (e.g., by OCR), and may even prevent proper classification of the receipt (as it may be difficult to distinguish from other documents). As a result, an employee's subsequent submission of a reimbursement form might raise an issue due to the lack of proper receipts. Identifying this often overlooked signal, and making it available to TSAgents and other modules of system 200 (e.g., via Knowledge Graph 225), facilitates the derivation of meaning from context by the present invention.

Because system 200 performs its Tasks in an integrated manner across documents over time, it may initially capture the date and other fields of the “unknown” receipt, but only later process the reimbursement form, and match sufficient fields to warrant reinvocation of Matching and Reconciliation Engine 120, ultimately resulting in a proper Classification of the receipt which allows the employee to be reimbursed without delay.

Still other scenarios involve audits for fraud detection, the calculation of rebates and other processes that are typically performed only after relevant transactions have been completed, and which often require significant manual labor at great cost of both time and money. System 200 facilitates the performance of such Tasks on a continual basis over time, which facilitates the detection and resolution of relevant anomalies as they occur.

For example, an audit for fraud detection may be performed as each document is submitted for processing. The results will be negative for many iterations unless and until a particular pattern is detected, suggesting possible fraud. Even if that anomaly cannot be resolved at the time it is first detected, relevant personnel will be notified, enabling them to implement additional safeguards to prevent any potential problem from being exacerbated.

Moreover, consider a rebate scenario in which a supplier may owe rebates to a company, but such rebates can only be calculated at the end of a calendar quarter after all relevant transactions have been completed. By implementing this rebate calculation on a continual basis over time, system 200 is able to provide advance notification to relevant personnel. For example, weeks before the end of the calendar quarter, system 200 may determine that rebates are beginning to accumulate. Upon receiving this early notification from system 200, the relevant company personnel may decide to alter its purchasing practices (e.g., to maximize rebates from a supplier). From a supplier's perspective, the obligation of paying rebates will at least not be a last-minute surprise (e.g., months later when the supplier receives a notification from the company that a large rebate is due).

As alluded to above, even within the financial realm, a vast array of scenarios are accommodated by the present invention. For example, the wholesale or retail lockbox scenarios are prime candidates for the enhanced automation offered by system 200. The sheer number of errors in these scenarios is enormous. The text on invoices, checks, envelopes, remittance and other documents is prone to handwriting as well as data entry errors, and the need to match documents across thousands or millions of distinct transactions is significant.

Reconciling, matching and verifying data across ACH ledgers and addenda records (e.g., regarding payors and payees, dates, amounts and miscellaneous notes) requires a significant reliance on context across documents to reach accurate conclusions. System 200 avoids much of the significant manual labor currently required to perform the Tasks of detecting and correcting these errors by automatically identifying and extracting relevant relationships over time (stored in iteratively updated Knowledge Graph 225), and reinvoking Document-Processing TSAgents 210 as new documents and other information are obtained (often out of chronological order).

Apart from these scenarios, system 200 is applicable to auto purchases, loans, construction and many other fields. A vast array of common types of anomalies detected and resolved by system 200 include pricing anomalies (errors and changes in amounts, overpricing, unauthorized discounts and surcharges, etc.), quantity anomalies (unauthorized over/under ordering, mismatches between ordered and received items, etc.), fraud (ghost vendors and other forms of vendor fraud, unauthorized vendor preferences affecting pricing and quality of goods and services, employee collusion with vendors to inflate prices and generate fraudulent POs, etc.), contractual terms (re delivery, payment terms, discounts, service levels, etc.), invoice and payment discrepancies (duplicate invoices, misallocation of payments, delays, etc.), approvals (missing approvals, unauthorized purchases beyond approved limits, etc.), compliance and regulation (violating legal and internal rules, inadequate audit trail documentation, etc.), data entry and system errors (re price, quantity, vendor details, inconsistencies across systems, etc.), market conditions (unexpected changes such as sudden price increases, shortages, etc.) and supply chain issues (e.g., due to natural disasters, political instability, transportation disruptions, etc.).

Even discrepancies in invoices alone are too numerous to address via preprogrammed rules. Invoice-related discrepancies affect vendor info, pricing, quantities, shipping charges, taxes, currency, delivery dates, volume and other discounts, damaged goods, contractual SLAs, etc.

In short, there is simply no human substitute for training models on the myriad of “patterns” of common discrepancies and other errors that occur across a wide range of scenarios, both within and outside the financial realm. Simply employing machine-learning models is helpful, but insufficient without a highly integrated continual Event-driven system that iteratively derives meaning from context.

As noted above, a vast array of other scenarios (in which the combination of TSAgents 210 with an iteratively traversed and updated Knowledge Graph 225 enables a significant reduction in the need for human judgment and intervention) will become apparent without departing from the principles of the present invention.

The present invention has been described herein with reference to specific embodiments as illustrated in the accompanying drawings. It should be understood that, in light of the present disclosure, additional embodiments of the concepts disclosed herein may be envisioned and implemented within the scope of the present invention by those skilled in the art.

1. A computer-implemented method for deriving meaning from the context of data within and across a plurality of documents to automate the performance of one or more tasks, the method comprising the following steps:
(a) receiving information over time, the information including one or more documents;
(b) employing contextual semantic derivation (CSD) on a continual basis to derive from the information a plurality of data relationships, including one or more difficult-to-derive relationships (DDRs), among data within and across the one or more documents;
(c) maintaining the plurality of data relationships in one or more knowledge graphs that persist over time;
(d) obtaining a current context for an action or a decision within a scenario-specific workflow, prior to implementing the action or decision, by traversing the one or more knowledge graphs;
(e) implementing the action or decision based at least in part on the current context; and
(f) updating the one or more knowledge graphs to reflect the implementation of the action or decision, such that the updated one or more knowledge graphs provide context for a subsequent action or decision.

2. The method of claim 1, wherein the information comprises a plurality of documents, each document including a plurality of fields, and wherein the plurality of data relationships includes relationships among the plurality of fields within and across the plurality of documents.

3. The method of claim 1, wherein steps (b) through (f) are performed in response to a plurality of events, the plurality of events including the receipt of new information, the passage of time, and the absence of an expected document over time.

4. The method of claim 1, further comprising reinvoking a previously-performed task in response to context revealed by an update to the one or more knowledge graphs.

5. A computer-implemented method for deriving meaning from the context of data within and across a plurality of documents to condition the performance of one or more tasks, the method comprising the following steps:
(a) receiving information over time, the information including one or more documents;
(b) employing contextual semantic derivation (CSD) on a continual basis to derive from the information a plurality of data relationships, including one or more difficult-to-derive relationships (DDRs), among data within and across the one or more documents;
(c) maintaining the plurality of data relationships in one or more knowledge graphs that persist over time;
(d) determining, by traversing the one or more knowledge graphs, whether one or more conditions applicable to an action or a decision within a scenario-specific workflow are satisfied, the one or more conditions being reflected in a current state of the one or more knowledge graphs;
(e) implementing the action or decision only upon determining that the one or more conditions are satisfied; and
(f) updating the one or more knowledge graphs to reflect the implementation of the action or decision, such that the updated one or more knowledge graphs provide context for a subsequent action or decision,
wherein the one or more conditions are a function of the plurality of data relationships derived and maintained in the one or more knowledge graphs over time, and thus are not determined solely by static predetermined rules.

6. The method of claim 5, wherein satisfaction of at least one of the one or more conditions cannot be determined without additional information, and implementation of the action or decision is deferred until such information is reflected in the one or more knowledge graphs.

7. The method of claim 5, wherein at least one of the one or more conditions is a function of data relationships derived at a line-item level within and across the one or more documents.

8. The method of claim 5, wherein the action or decision comprises one of an authorization, an approval and a payment.
